(19) United States
(12) Patent Application Publication
(10) Pub. No.: US 2026/0320578 A1
(43) Pub. Date: Oct. 15, 2026

(54) SYSTEM AND METHOD FOR DECENTRALIZED CO-CREATION AND ROYALTY DISTRIBUTION ON A BLOCKCHAIN-BASED DISTRIBUTED LEDGER

(71) Applicants: Arjun Jain, Acton, MA (US); Kunal Jain, Acton, MA (US); Jonathan Eggert, Westford, MA (US)

(72) Inventors: Arjun Jain, Acton, MA (US); Kunal Jain, Acton, MA (US); Jonathan Eggert, Westford, MA (US)

(21) Appl. No.: 19/174,129

(22) Filed: Apr. 9, 2025

(51) Int. Cl. G06Q 20/22; G06F 21/10; G06Q 20/38; G06Q 30/0601; G07C 13/00

(52) U.S. Cl. CPC G06Q 20/2295; G06F 21/1074; G06Q 20/382; G06Q 30/0611; G06Q 50/184; G07C 13/00; G06Q 2220/10; G06Q 2220/18; G06Q 2230/00

(57) ABSTRACT

A system (101) for decentralized co-creation and royalty distribution on a blockchain-based distributed ledger may comprise a processor (201) and a memory (203). The system may receive a primary original work and generate a StartToken with metadata and a spinoff permission parameter. The system may register licenses in a license registry, manage spinoff requests through a multi-tiered approval mechanism, and generate evaluation licenses for evolvers. Upon validation, the system may generate SpinoffTokens cryptographically linked to the StartToken through a multi-branch tree structure comprising parent-child relationships. The system may generate EndTokens and facilitate marketplace transactions through smart contracts. The system may implement a recursive royalty distribution system tracking token relationships and may execute royalty distributions including principal royalties to creators and spinoff royalties to evolvers upon transaction events.

### TECHNICAL FIELD

The present subject matter described herein, in general, relates to blockchain-based royalty distribution systems, and more particularly, to a decentralized co-creation and royalty management platform utilizing smart contracts to enable multi-tier recursive royalty distribution, transferable royalty streams, and dynamic licensing for derivative creative works.

### BACKGROUND

The subject matter discussed in the background section should not be assumed to be prior art merely because of its mention in the background section. Similarly, a problem mentioned in the background section or associated with the subject matter of the background section should not be assumed to have been previously recognized in the prior art. The subject matter in the background section merely represents different approaches, which in and of themselves may also correspond to implementations of the claimed technology.

Blockchain technology and non-fungible tokens (NFTs) have revolutionized digital content creation, distribution, and monetization by establishing verifiable ownership and provenance for digital assets. However, existing blockchain-based systems face critical limitations in supporting collaborative creative processes and ensuring equitable compensation for all contributors. This gap is further exacerbated when compared to traditional centralized platforms, which dominate the digital content landscape but come with their own set of challenges.

Traditional platforms, while widely used for content creation and monetization, often prioritize centralized control, leaving creators with limited ownership rights, restricted revenue streams, and inadequate intellectual property protection. Many of these platforms, including blockchain-based systems rely on single-tier royalty structures (e.g., ERC-2981), where only the original creator receives royalties from secondary sales. Such mechanisms fail to address the complexity of collaborative environments, where multiple contributors or derivative works may exist. Even advanced standards like EIP-4910 (Hierarchical Royalties) struggle with recursive royalty propagation, gas inefficiencies, and rigid linear hierarchies that hinder dynamic adjustments for multi-party contributions.

These inefficiencies are compounded by the inflexibility of current blockchain-based platforms, which typically fix royalty parameters at contract deployment. This rigidity prevents creators from adapting royalty terms to evolving market conditions or contributor relationships. Additionally, royalties are often tied to a creator's wallet address, making it impossible to sell or transfer royalty rights independently of the original work. This limitation not only stifles creative control but also blocks the emergence of secondary markets for royalty streams, which could enable trading, collateralization, or transfer of revenue rights without disrupting ownership structures.

The absence of standardized on-chain licensing mechanisms further widens the gap between digital ownership and legal rights. Traditional licensing relies on paper agreements disconnected from blockchain transactions, creating friction in enforcing terms programmatically. While proposals like EIP-5554 attempt to address NFT legal use and derivative tracking, they fall short of integrating dynamic licensing approvals or recursive royalty frameworks.

Moreover, current systems lack mechanisms to determine fair royalty percentages based on market dynamics, creator influence, or value-added contributions. Royalties are either fixed or manually negotiated, often leading to inequitable distributions. NFT marketplaces, primarily focused on art and gaming, prioritize speculative value over utility and collaborative creation, leaving other digital asset types underserved. Centralized ownership models also expose platforms to vulnerabilities like outages and data breaches.

In light of these limitations, conventional systems fail to provide scalable, gas-efficient solutions for multi-level royalty distribution, transferable rights, and collaborative creation. They lack safeguards against royalty overcommitment and lack integration of dynamic licensing.

There is a clear need for a novel method and system that addresses these shortcomings, enabling flexible, equitable, and decentralized frameworks for digital asset monetization in collaborative environments.

### SUMMARY

This summary is provided to introduce concepts related to a system and method for decentralized co-creation and royalty distribution on a blockchain-based distributed ledger, which are further described below in the detailed description. This summary is not intended to identify essential features of the claimed subject matter nor is it intended for use in determining or limiting the scope of the claimed subject matter.

In an exemplary embodiment, a system for decentralized co-creation and royalty distribution on a blockchain-based distributed ledger is described. The system includes a processor, and a memory coupled to the processor. The processor is configured to execute various modules for managing creative works and royalty distribution. The system comprises a set of modules. The set of modules comprises a content registration module, a token generation module, a licensing module, a collaboration management module, a validation module, a marketplace module, a royalty management module, and a payment distribution module. The content registration module is configured to receive a primary original work from a creator user. The token generation module is configured to generate a start token (“StartToken”) on the blockchain-based distributed ledger. The StartToken corresponds to the received primary original work. The StartToken comprises StartToken metadata and a first spinoff permission parameter, set by the creator user, indicating whether derivative works (“Spinoffs”) for the primary original work are permitted. The licensing module is configured to register at least one license associated with the StartToken in a license registry on the blockchain-based distributed ledger. The at least one license comprises a set of licensing parameters that define usage rights for the primary original work. The collaboration management module is configured to receive, when the first spinoff permission parameter allows Spinoffs, one or more spinoff requests from one or more evolver users to create at least one derivative work based on the StartToken. The validation module is configured to validate the one or more spinoff requests through a multi-tiered approval mechanism based on the StartToken metadata. The licensing module is configured to generate, upon validation of a spinoff request, an evaluation license for an evolver user. The evaluation license grants the evolver user temporary access to the primary original work. The collaboration management module is configured to receive at least one derivative work from the evolver user based on the primary original work. The validation module is configured to validate the at least one derivative work based on compliance with constraints defined in the StartToken metadata. The token generation module is configured to generate, upon successful validation of the derivative work, at least one spinoff token (“SpinoffToken”) on the blockchain-based distributed ledger representing the derivative work. The SpinoffToken comprises SpinoffToken metadata and a second spinoff permission parameter indicating whether further Spinoffs are permitted. The SpinoffToken is cryptographically linked to the StartToken through a multi-branch tree structure. The multi-branch tree structure comprises parent-child relationship in a hierarchical data structure. The licensing module is configured to generate a spinoff creation license for the evolver user associated with the SpinoffToken. The collaboration management module is configured to receive a request to create an end token (“EndToken”) based on at least one of the StartToken or the SpinoffToken. The token generation module is configured to generate the EndToken on the blockchain-based distributed ledger. The marketplace module is configured to facilitate transactions for the purchase and sale of at least one of the StartToken, the SpinoffToken, or the EndToken through a smart contract-based marketplace. The smart contract defines a set of royalty parameters. The royalty management module is configured to implement a recursive royalty distribution system that maintains the multi-branch tree structure tracking relationships and contributions among the tokens. The payment distribution module is configured to execute royalty distributions upon occurrence of a transaction event. The royalty distributions include a principal royalty to the creator user and spinoff royalties to each contributing evolver user.

In some embodiments, the EndToken represents a finalized creative work ready for distribution and sale. The EndToken is created automatically if the first spinoff permission parameter or the second spinoff permission parameter prohibits further Spinoffs. The creative work comprises of at least one of (i) a digital asset, or (ii) a real-world physical asset. The SpinoffToken inherits applicable constraints from the set of licensing parameters of the StartToken. The hierarchical data structure forms a node in the multi-branch tree structure for tracking contribution relationships for royalty distribution. The recursive royalty distribution system calculates royalty allocations based on the set of royalty parameters in the smart contract. The recursive royalty distribution system enforces maximum royalty caps to prevent excessive fee accumulation. The recursive royalty distribution system prevents royalty dilution through mathematical constraints in deeply nested derivative chains. The spinoff royalties are calculated recursively through the parent-child relationships in the multi-branch tree structure.

In some embodiments, the system further comprises a secured assets access module. The StartToken, SpinoffToken, or EndToken includes a reference to one or more secured digital assets uploaded by the creator user or evolver user and stored on a decentralized assets storage system. The secured assets access module is configured for granting temporary access to the evolver user upon approval of a spinoff request, wherein access is facilitated through the decentralized file storage system. The secured assets access module is further configured for granting access to a buyer upon completion of a purchase transaction, wherein secured access is facilitated through the decentralized file storage system.

In some embodiments, the royalty management module implements a Branching Recursive Royalty Network (BRRN) for multi-tier royalty distribution. The BRRN receives, from the blockchain-based distributed ledger, a hierarchical structure of parent-child relationships between the StartToken, the SpinoffToken, and the EndToken. Each of the StartToken, the SpinoffToken, and the EndToken includes the StartToken metadata, the SpinoffToken metadata, and EndToken metadata. Each of the metadata comprises a unique identifier on the blockchain-based distributed ledger. Each of the metadata comprises metadata defining programmable constraints. Each of the metadata comprises provenance data maintaining verifiable authorship and ownership records. Each of the metadata comprises usage rights specifications defining permitted interactions with the primary original work and the at least one derivative work. The BRRN processes the metadata to generate the multi-branch tree structure representing royalty distribution paths. The BRRN records the multi-branch tree structure on the blockchain-based distributed ledger for efficient retrieval. The BRRN utilizes the multi-branch tree structure to calculate and distribute royalties to multiple stakeholders at each level of the hierarchy using an iterative, loop-based execution model designed to optimize blockchain transaction costs.

In some embodiments, the royalty management module executes a loop-based execution model for optimizing blockchain transaction costs. The loop-based execution model receives transaction data from the marketplace module when a sale event occurs. The loop-based execution model retrieves the multi-branch tree structure from the blockchain-based distributed ledger. The loop-based execution model processes the multi-branch tree structure using iterative loops instead of recursive function calls. Processing the multi-branch tree structure using iterative loops comprises a first loop iterates through each level of the multi-branch tree structure from a terminal node to a root node. Processing the multi-branch tree structure using iterative loops comprises a second loop processes all nodes at each level in batches to avoid deep recursion. Processing the multi-branch tree structure using iterative loops comprises the iterative loops maintain a running tally of remaining funds to be distributed. The loop-based execution model outputs a series of discrete payment transactions to the payment distribution module for execution to the creator user and the one or more evolver users based on respective positions in the multi-branch tree structure, thereby preventing smart contract stack overflows and minimizing transaction costs on the blockchain-based distributed ledger.

In some embodiments, the royalty management module further optimizes transaction costs by receiving, from the blockchain-based distributed ledger, the multi-branch tree structure. The royalty management module preprocesses the multi-branch tree structure by flattening the nested hierarchy into a linear array of payment recipients, wherein the payment recipients comprise the creator user and the one or more evolver users who contributed to the creation of the StartToken, the SpinoffToken, or the EndToken. The royalty management module preprocesses the multi-branch tree structure by calculating each recipient's royalty amount based on predetermined percentages and position in the multi-branch tree structure. The royalty management module preprocesses the multi-branch tree structure by consolidating multiple payments to the same recipient. The royalty management module preprocesses the multi-branch tree structure by sorting recipients by payment amount to optimize transaction batching. The royalty management module records the preprocessed payment data on the blockchain-based distributed ledger. The royalty management module executes batched payment transactions using the payment distribution module, thereby reducing the total number of blockchain transactions required and minimizing transaction costs on the blockchain-based distributed ledger.

In some embodiments, the royalty management module implements a capped royalty validation mechanism. The capped royalty validation mechanism receives royalty allocation data based on the set of royalty parameters from each of the StartToken, the SpinoffToken, and the EndToken in the multi-branch tree structure. The capped royalty validation mechanism processes the royalty obligations recursively, ensuring that at every node in the multi-branch tree structure, the greater of the percentage-based royalty or minimum royalty value is used. The capped royalty validation mechanism validates the feasibility of generating a new token by checking whether the proposed royalty structure can fulfill all parent obligations in the multi-branch tree structure. The capped royalty validation mechanism performs royalty validation during token pricing, transaction events, and offer negotiations to ensure that the final sale price can cover all required royalty distributions. The capped royalty validation mechanism outputs a validation result to the token generation module and the marketplace module, preventing the creation or sale of tokens with unsustainable royalty obligations.

In some embodiments, the system further comprises a royalty simulation module for predictive royalty analysis. The royalty simulation module receives, from the collaboration management module, a proposed royalty structure for a new SpinoffToken. The royalty simulation module processes the proposed royalty structure by simulating the addition of the new SpinoffToken to the existing multi-branch tree structure. The royalty simulation module processes the proposed royalty structure by calculating the royalty distributions for various transaction price scenarios. The royalty simulation module processes the proposed royalty structure by analyzing the impact on transaction costs for multi-branch tree structure depths and branching factors. The royalty simulation module processes the proposed royalty structure by identifying potential bottlenecks or inefficiencies such as excessive transaction costs, deep recursion risks, or unbalanced royalty allocations in the royalty distribution. The royalty simulation module generates a transaction efficiency report and optimization recommendations. The royalty simulation module outputs the report and recommendations to the creator user and the one or more evolver user for review before finalizing the SpinoffToken creation.

In some embodiments, the system further comprises an AI-driven royalty recommendation module that receives input data. The input data comprises historical transaction data of similar tokens from the blockchain-based distributed ledger, creator user reputation metrics, market trend data for specific creative categories, and contribution analysis metrics quantifying the relative value added by each evolver user. The AI-driven royalty recommendation module processes the input data using a machine learning model to identify patterns in successful royalty structures, evaluate the market influence of the creator user and the one or more evolver users, assess the complexity and uniqueness of the derivative work, and factor in current market conditions and demand. The AI-driven royalty recommendation module generates recommended royalty parameters, including percentage-based royalties and minimum royalty values, for the StartToken, the SpinoffToken, and the EndToken in the multi-branch tree structure. The AI-driven royalty recommendation module implements an adaptive learning mechanism that analyzes performance data of tokens with different royalty structures, identifies correlations between royalty structures and market success, detects changing market conditions affecting optimal royalty distributions, and refines recommendation algorithms based on observed outcomes. The AI-driven royalty recommendation module provides a negotiation assistance feature that processes royalty proposals from both the creator user and the one or more evolver users, calculates the economic impact of different royalty structures on all parties, simulates long-term outcomes of various royalty scenarios, and generates balanced royalty options that maximize value for all participants. The AI-driven royalty recommendation module outputs the recommendations and negotiation options to the collaboration management module for presentation to the creator user and the one or more evolver users during smart contract formation.

In some embodiments, the licensing module implements a dynamic licensing system. The dynamic licensing system receives, from the creator user, licensing parameters for the StartToken. The licensing parameters define permitted uses of the primary original work, restricted activities, attribution requirements, and conditions for derivative works. The dynamic licensing system processes the licensing parameters to generate machine-readable license terms encoded in smart contract format, establish verification mechanisms to ensure compliance with license terms, set up automated enforcement triggers, and create license metadata for storage on the blockchain-based distributed ledger. The dynamic licensing system links the license metadata to the StartToken at the time of generation by embedding a Universal Resource Identifier (URI) in the StartToken metadata. The URI points to the license file stored on a decentralized storage network. The set of licensing parameters define the type of license. The StartToken metadata references these license attributes. The dynamic licensing system records the processed licensing parameters in the license registry on the blockchain-based distributed ledger. The dynamic licensing system provides the licensing parameters to the validation module for verifying compliance of spinoff requests and the at least one derivative work with the established terms.

In some embodiments, the validation module performs validation comprising at least one of: (i) manual validation requiring explicit approval by the creator user through a smart contract interface, or (ii) automated validation based on predefined licensing parameters stored in the StartToken metadata. The licensing module further supports multi-stage approval for the at least one derivative work. The licensing module receives, from an evolver user of the one or more evolver users, a request to modify an existing license for a specific use case. The licensing module processes the request by analyzing the proposed modifications against the original license terms, identifying all stakeholders in the multi-branch tree structure affected by the license change, generating a ballot for decentralized approval voting, and determining the required approval threshold based on the significance of the proposed modifications. The licensing module distributes the ballot to all affected stakeholders through the collaboration management module for voting. The licensing module updates the license in the license registry on the blockchain-based distributed ledger only upon receiving the required threshold of stakeholder approvals, thereby ensuring consensus for any licensing modifications.

In some embodiments, the system further comprises a royalty stream management module for enabling transferable royalty rights. The royalty stream management module automatically processes the transfer of associated rights and royalty streams upon a transaction event involving the StartToken, the SpinoffToken, or the EndToken. The royalty stream management module verifies the transaction on the blockchain-based distributed ledger, calculates the expected value of future royalty distributions based on historical transaction data and market projections, records the buyer as the new owner in the token metadata while preserving the creator user's ownership of the underlying primary original work and perpetual royalty rights. The royalty stream management module maintains structured royalty distributions where the creator user continues receiving principal royalties from all transaction events involving the token, and the current owner inherits spinoff royalties from derivative works. The royalty stream management module updates the token metadata on the blockchain-based distributed ledger to reflect the ownership change while ensuring the integrity of the multi-branch tree structure. The royalty stream management module ensures that royalty distributions and rights follow the token transfer, automatically recording new entitlements without requiring separate manual approvals. The royalty stream management module outputs confirmation of the ownership transfer transaction to the buyer and seller, and provides confirmation to the royalty holder, enabling the royalty holder to transfer, sell, or collateralize future royalty earnings while maintaining the original creator user's ownership of the underlying primary original work.

In some embodiments, the token generation module supports multiple types of token creation. The token generation module receives, from the creator user, a request to create a specific type of token along with the corresponding creative work. The token generation module processes the request based on the specified token type. For a StartToken, the token generation module verifies original authorship and establishes root permissions in the multi-branch tree structure. For a SpinoffToken, the token generation module validates the parent-child relationship and inherits applicable constraints from the set of licensing parameters. For a SpinoffToken with no derivative capabilities, the token generation module creates a derivative work that disallows further Spinoffs while maintaining the parent-child relationship in the multi-branch tree structure. For an EndToken, the token generation module creates an exclusive token with no derivative capabilities. The token generation module generates the requested token type with appropriate metadata and smart contract properties specific to its function. The token generation module registers the newly created token in the multi-branch tree structure with the appropriate hierarchical position, thereby establishing its role in future royalty distributions.

In some embodiments, the SpinoffToken creation includes a parent validation process. The parent validation process receives from an evolver user of the one or more evolver users, a SpinoffToken creation request referencing a specific parent token. The parent validation process retrieves, from the blockchain-based distributed ledger, the metadata and constraints of the parent token. The parent validation process processes the request through a validation workflow that verifies compliance with the parent token's derivative work restrictions, confirms the evolver user holds a valid evaluation license for the parent token, checks that proposed royalty distributions satisfy maximum royalty caps, and validates that required approvals have been obtained from the creator user of the parent token. The parent validation process generates a validation report detailing compliance or identifying specific violations. The parent validation process proceeds with SpinoffToken creation only upon successful validation, ensuring all parent-imposed constraints are respected in the at least one derivative work.

In some embodiments, the marketplace module implements a decentralized marketplace. The decentralized marketplace receives listings including pricing information, quantity available, and sale conditions. The decentralized marketplace processes the listings by validating ownership of the listed StartToken, SpinoffToken, or EndToken on the blockchain-based distributed ledger, verifying compliance with the set of licensing parameters, calculating platform fees and royalty distributions, and generating smart contracts that govern the transaction events. The decentralized marketplace publishes the validated listings to a marketplace interface. The decentralized marketplace executes transaction events when a buyer submits a purchase request, triggering automatic royalty distribution through the royalty management module according to the multi-branch tree structure.

In some embodiments, the marketplace module further supports multiple transaction types. The marketplace module receives different types of transaction requests from marketplace participants, wherein the transaction types include fixed-price purchases, time-limited auction listings, conditional offers with expiration dates, and bundle sales of multiple related tokens. The marketplace module processes each transaction type using specialized smart contract logic that enforces the specific rules and conditions of the transaction type, manages bid validation for auctions, handles expiration of time-sensitive offers, and coordinates bundle transfers when multiple tokens are involved. The marketplace module executes the transactions upon fulfillment of all required conditions. The marketplace module updates ownership records on the blockchain-based distributed ledger while triggering appropriate royalty distribution events.

In some embodiments, the system further comprises an external platform integration module. The external platform integration module receives distribution requests from third-party entities wishing to sell tokens by integrating with external e-commerce platforms. The external platform integration module processes the distribution requests by validating the identity and security credentials of the requesting distributor, generating API keys for secure communication, establishing webhook endpoints for event notifications, and configuring royalty enforcement mechanisms for external sales. The external platform integration module creates a secure bridge between the blockchain-based distributed ledger and the external platform using cryptographic verification. The external platform integration module monitors external transaction events to ensure that all royalty obligations are properly fulfilled, triggering the royalty distribution system when sales occur on connected platforms.

In some embodiments, the external platform integration module includes an on-chain transaction monitoring system. The on-chain transaction monitoring system receives transaction data from multiple blockchain networks and external marketplaces. The on-chain transaction monitoring system processes the transaction data by filtering for activities related to tokens in the system's registry, verifying the authenticity of reported sales, matching external transactions with the corresponding tokens in the multi-branch tree structure, and identifying royalty payment obligations triggered by external sales. The on-chain transaction monitoring system generates royalty distribution instructions based on the identified transactions. The on-chain transaction monitoring system forwards the instructions to the payment distribution module, ensuring that the creator user and the one or more evolver users receive appropriate compensation regardless of where their tokens are sold.

In some embodiments, the external platform integration module implements a cross-platform licensing enforcement mechanism. The cross-platform licensing enforcement mechanism publishes, to connected external platforms, machine-readable licensing parameters associated with each token in the system. The cross-platform licensing enforcement mechanism receives usage data from external platforms regarding how tokens are being utilized. The cross-platform licensing enforcement mechanism analyzes the usage data to detect potential licensing violations, identify unauthorized derivative works, verify proper attribution compliance, and ensure royalty distributions are being properly triggered. The cross-platform licensing enforcement mechanism generates compliance reports for token creators and owners. The cross-platform licensing enforcement mechanism initiates automated enforcement actions for detected violations, including license revocation or penalty fee collection through smart contracts.

In some embodiments, the system further comprises a fraud prevention module. The fraud prevention module receives token creation requests and transaction data from the token generation module and the marketplace module. The fraud prevention module processes the data through a multi-layered verification system that performs cryptographic hashing of creative content to detect unauthorized duplications, compares visual and textual elements against existing tokens using similar detection algorithms, validates that linked assets properly reference their parent tokens through cryptographic signatures, and verifies the authenticity of the creator user and the one or more evolver users' identities. The fraud prevention module generates a risk assessment score for each token and transaction. The fraud prevention module outputs the assessment results to the respective modules, blocking transactions or token creations that fail to meet security thresholds.

In some embodiments, the system implements a recursive calculation optimization system. The recursive calculation optimization system receives a request from the royalty management module to calculate royalty distributions for the multi-branch tree structure. The recursive calculation optimization system processes the request by converting the recursive royalty distribution algorithm into an equivalent iterative implementation, restructuring the multi-branch tree structure into a flattened array representation with explicit parent-child relationships, implementing a breadth-first traversal algorithm that processes nodes level by level rather than depth-first, and utilizing temporary computational resources for intermediate calculation results to avoid redundant processing. The recursive calculation optimization system executes the optimized calculation algorithm to determine royalty amounts for all participants in the multi-branch tree structure. The recursive calculation optimization system returns the calculated royalty distribution to the payment distribution module, achieving the same mathematical result as recursive calculation while consuming significantly less computational resources and transaction costs on the blockchain-based distributed ledger.

In some embodiments, the loop-based execution model for royalty distribution further includes a state segmentation mechanism. The state segmentation mechanism receives the multi-branch tree structure with multiple branches and levels from the blockchain-based distributed ledger. The state segmentation mechanism processes the multi-branch tree structure to divide it into manageable segments based on depth and breadth metrics, assign each segment a unique identifier and processing priority, create a processing schedule that minimizes memory requirements, and establish checkpoints for resuming execution if interrupted. The state segmentation mechanism executes royalty calculations for each segment sequentially, recording intermediate results on the blockchain-based distributed ledger. The state segmentation mechanism merges the segmented calculation results into a final royalty distribution plan, thereby enabling processing of arbitrarily large multi-branch tree structures without encountering transaction cost limits or stack depth limitations.

In some embodiments, the system implements a proxy pattern smart contract architecture. The proxy pattern smart contract architecture receives instructions from the system modules to interact with the blockchain-based distributed ledger. The proxy pattern smart contract architecture processes the instructions through a layered contract structure that separates contract logic from storage through a proxy-implementation pattern enabling upgradability without modifying persistent data structures, maintains a central address registry for locating the latest implementation of each contract, delegates calls to the current implementation while preserving state and maintaining persistent storage, and enables atomic upgrades of contract logic without migrating stored data. The proxy pattern smart contract architecture executes the delegated calls on the appropriate implementation contracts. The proxy pattern smart contract architecture returns operation results to the calling modules, thereby enabling system evolution and bug fixes without disrupting existing token ownership or royalty structures.

In some embodiments, the royalty management module implements a hierarchical caching system for efficient royalty calculations. The hierarchical caching system receives a request to calculate royalty distributions for a specific transaction event. The hierarchical caching system retrieves, from an off-chain cache, pre-computed royalty distribution templates for common transaction scenarios. The hierarchical caching system processes the royalty calculation request by determining if the current transaction matches a cached scenario, applying transaction-specific parameters to the template if a match exists, calculating royalties from scratch only for novel transaction patterns, and storing the results of new calculations in the cache for future use. The hierarchical caching system generates the final royalty distribution plan based on either the cached template or new calculation. The hierarchical caching system outputs the plan to the payment distribution module, significantly reducing on-chain computation for frequently occurring royalty distribution patterns.

In some embodiments, the token generation module implements an efficient metadata storage system. The efficient metadata storage system receives token creation requests containing detailed metadata about the primary original work or the at least one derivative work. The efficient metadata storage system processes the metadata by separating immutable identifier data from descriptive content, storing minimal critical metadata on-chain to establish ownership and relationships, generating cryptographic references to off-chain storage locations for extended metadata, and creating verifiable links between the on-chain and off-chain components. The efficient metadata storage system stores the extended metadata on a distributed file storage system. The efficient metadata storage system generates the StartToken, the SpinoffToken, or the EndToken with hybrid metadata structures that maintain blockchain-level security for critical properties while minimizing transaction costs associated with storing large data sets on-chain.

In some embodiments, the collaboration management module implements a staged transaction execution system. The staged transaction execution system receives complex transaction requests that would exceed transaction cost limits if executed as single operations. The staged transaction execution system processes the requests by decomposing them into ordered sequences of smaller, atomic operations, generating unique transaction identifiers to track the overall process, creating state verification checks between stages to ensure consistency, and preparing recovery procedures for handling interrupted sequences. The staged transaction execution system executes the decomposed transactions in sequence, verifying the success of each stage before proceeding. The staged transaction execution system consolidates results from all stages into a unified transaction outcome, enabling transaction cost-intensive operations to be completed across multiple blocks without compromising transaction integrity.

In an embodiment, a method for decentralized co-creation and royalty distribution on a blockchain-based distributed ledger is disclosed. The method comprising steps for receiving, by a content registration module, a primary original work from a creator user. Further, the method comprises steps for generating, by a token generation module, a StartToken on the blockchain-based distributed ledger, wherein the StartToken corresponds to the received primary original work, wherein the StartToken comprises StartToken metadata and a first spinoff permission parameter, set by the creator user, indicating whether derivative works for the primary original work are permitted. Further, the method comprises steps for registering, by a licensing module, at least one license associated with the StartToken in a license registry on the blockchain-based distributed ledger, wherein the at least one license comprises a set of licensing parameters that define usage rights for the primary original work. Further, the method comprises steps for receiving, by a collaboration management module, one or more spinoff requests from one or more evolver users to create at least one derivative work based on the StartToken, when the first spinoff permission parameter allows Spinoffs. Further, the method comprises steps for validating, by a validation module, the one or more spinoff requests through a multi-tiered approval mechanism based on the StartToken metadata. Further, the method comprises steps for generating, by the licensing module, upon validation of a spinoff request, an evaluation license for an evolver user, wherein the evaluation license grants the evolver user temporary access to the primary original work. Further, the method comprises steps for receiving, by the collaboration management module, at least one derivative work from the evolver user based on the primary original work. Further, the method comprises steps for validating, by the validation module, the at least one derivative work based on compliance with constraints defined in the StartToken metadata. Further, the method comprises steps for generating, by the token generation module, upon successful validation of the derivative work, at least one SpinoffToken on the blockchain-based distributed ledger representing the derivative work, wherein the SpinoffToken comprises SpinoffToken metadata and a second spinoff permission parameter indicating whether further Spinoffs are permitted, and wherein the SpinoffToken is cryptographically linked to the StartToken through a multi-branch tree structure, wherein the multi-branch tree structure comprises parent-child relationship in a hierarchical data structure. Further, the method comprises steps for generating, by the licensing module, a spinoff creation license for the evolver user associated with the SpinoffToken. Further, the method comprises steps for receiving, by the collaboration management module, a request to create an EndToken based on at least one of the StartToken or the SpinoffToken. Further, the method comprises steps for generating, by the token generation module, the EndToken on the blockchain-based distributed ledger. Further, the method comprises steps for facilitating, by a marketplace module, transactions for the purchase and sale of at least one of the StartToken, the SpinoffToken, or the EndToken through a smart contract-based marketplace, wherein the smart contract defines a set of royalty parameters. Further, the method comprises steps for implementing, by a royalty management module, a recursive royalty distribution system that maintains the multi-branch tree structure tracking relationships and contributions among the tokens. Further, the method comprises steps for executing, by a payment distribution module, royalty distributions upon occurrence of a transaction event, wherein the royalty distributions include a principal royalty to the creator user and spinoff royalties to each contributing evolver user.

In an embodiment, a computer program product for decentralized co-creation and royalty distribution on a blockchain-based distributed ledger is disclosed the computer program product comprising a non-transitory computer-readable storage medium having program instructions embodied therewith, the program instructions executable by one or more processors to cause the one or more processors to perform operations comprising receiving, by a content registration module, a primary original work from a creator user. Further, the program instructions cause the one or more processors to generate, by a token generation module, a StartToken on the blockchain-based distributed ledger, wherein the StartToken corresponds to the received primary original work, wherein the StartToken comprises StartToken metadata and a first spinoff permission parameter, set by the creator user, indicating whether derivative works for the primary original work are permitted. Further, the program instructions cause the one or more processors to register, by a licensing module, at least one license associated with the StartToken in a license registry on the blockchain-based distributed ledger, wherein the at least one license comprises a set of licensing parameters that define usage rights for the primary original work. Further, the program instructions cause the one or more processors to receive, by a collaboration management module, one or more spinoff requests from one or more evolver users to create at least one derivative work based on the StartToken, when the first spinoff permission parameter allows Spinoffs. Further, the program instructions cause the one or more processors to validate, by a validation module, the one or more spinoff requests through a multi-tiered approval mechanism based on the StartToken metadata. Further, the program instructions cause the one or more processors to generate, by the licensing module, upon validation of a spinoff request, an evaluation license for an evolver user, wherein the evaluation license grants the evolver user temporary access to the primary original work. Further, the program instructions cause the one or more processors to receive, by the collaboration management module, at least one derivative work from the evolver user based on the primary original work. Further, the program instructions cause the one or more processors to validate, by the validation module, the at least one derivative work based on compliance with constraints defined in the StartToken metadata. Further, the program instructions cause the one or more processors to generate, by the token generation module, upon successful validation of the derivative work, at least one SpinoffToken on the blockchain-based distributed ledger representing the derivative work, wherein the SpinoffToken comprises SpinoffToken metadata and a second spinoff permission parameter indicating whether further Spinoffs are permitted, and wherein the SpinoffToken is cryptographically linked to the StartToken through a multi-branch tree structure, wherein the multi-branch tree structure comprises parent-child relationship in a hierarchical data structure. Further, the program instructions cause the one or more processors to generate, by the licensing module, a spinoff creation license for the evolver user associated with the SpinoffToken. Further, the program instructions cause the one or more processors to receive, by the collaboration management module, a request to create an EndToken based on at least one of the StartToken or the SpinoffToken. Further, the program instructions cause the one or more processors to generate, by the token generation module, the EndToken on the blockchain-based distributed ledger. Further, the program instructions cause the one or more processors to facilitate, by a marketplace module, transactions for the purchase and sale of at least one of the StartToken, the SpinoffToken, or the EndToken through a smart contract-based marketplace, wherein the smart contract defines a set of royalty parameters. Further, the program instructions cause the one or more processors to implement, by a royalty management module, a recursive royalty distribution system that maintains the multi-branch tree structure tracking relationships and contributions among the tokens. Further, the program instructions cause the one or more processors to execute, by a payment distribution module, royalty distributions upon occurrence of a transaction event, wherein the royalty distributions include a principal royalty to the creator user and spinoff royalties to each contributing evolver user.

The foregoing general description of the illustrative embodiments and the following detailed description thereof are merely exemplary aspects of the teachings of this disclosure and are not restrictive.

### Definitions

‘Evolver user’ refers to a user of the system who creates derivative works based on existing tokens, by modifying, enhancing, or adapting the original creative work represented by a StartToken, thereby contributing to the collaborative evolution of creative content within the platform ecosystem.

‘Derivative work’ refers to a new creative work that is based upon or derived from a pre-existing original work (represented by a StartToken or SpinoffToken), incorporating substantive modifications, enhancements, or adaptations while maintaining a traceable relationship to the parent work, and which is represented on the blockchain-based distributed ledger as a SpinoffToken cryptographically linked to its parent token.

‘Primary original work’ refers to an original creative content submitted by a creator user, which serves as the foundation for potential derivative works and is represented on the blockchain-based distributed ledger as a StartToken.

‘Creator user’ refers to a user of the system who submits primary original works to be tokenized as StartTokens, establishing the foundation of a potential creative lineage and receiving principal royalties from both direct sales and derivative works.

‘Blockchain-based distributed ledger’ refers to a decentralized digital system that records transactions across multiple computers in a way that ensures the data cannot be altered retroactively without the alteration of all subsequent blocks and the consensus of the network, enabling secure, transparent, and tamper-resistant transaction records.

‘StartToken’ refers to a digital asset on the blockchain-based distributed ledger that represents an original creative work submitted by a creator user, containing metadata and permission parameters that define usage rights and derivative work capabilities.

‘SpinoffToken’ refers to a digital asset on the blockchain-based distributed ledger that represents a derivative work based on a StartToken or another SpinoffToken, cryptographically linked to its parent token through a multi-branch tree structure.

‘EndToken’ refers to a digital asset on the blockchain-based distributed ledger that represents a finalized creative work ready for distribution and sale, with no further derivative capabilities.

‘Multi-branch tree structure’ refers to a hierarchical data structure used to track relationships between tokens, where each node can have multiple child nodes, enabling the system to maintain parent-child relationships between original works and their derivatives for royalty distribution purposes.

‘Spinoff permission parameter’ refers to a configurable setting within a token's metadata that indicates whether derivative works based on the token are permitted, controlling the ability of evolver users to create derivative works.

‘License registry’ refers to a system component on the blockchain-based distributed ledger that stores and manages licensing information associated with creative works, including usage rights, attribution requirements, and conditions for derivative works.

‘Evaluation license’ refers to a time-limited permission granted to an evolver user to access and use a primary original work for the purpose of creating a derivative work, typically granted after validation of a spinoff request.

‘Spinoff creation license’ refers to a permission granted to an evolver user that authorizes the creation and publication of a derivative work based on an existing token, typically issued after validation of the derivative work.

‘Recursive royalty distribution system’ refers to a mechanism that calculates and distributes royalties to multiple stakeholders across different levels of a multi-branch tree structure, ensuring that both original creators and contributors to derivative works receive appropriate compensation.

‘Principal royalty’ refers to the payment made to the creator user of the original work whenever a transaction occurs involving the original work or any derivative work based on it.

‘Spinoff royalties’ refers to payments made to evolver users who have contributed to derivative works, distributed based on their position in the multi-branch tree structure.

‘Branching Recursive Royalty Network (BRRN)’ refers to a specialized implementation of the royalty distribution system that manages multi-tier royalty distribution through an efficient, loop-based execution model designed to optimize blockchain transaction costs.

‘Loop-based execution model’ refers to an optimization technique that processes the multi-branch tree structure using iterative loops instead of recursive function calls, minimizing computational resource consumption and blockchain transaction costs.

‘Capped royalty validation mechanism’ refers to a system that ensures royalty obligations remain sustainable by validating that the total royalty amount does not exceed predefined thresholds, preventing the creation or sale of tokens with unsustainable royalty structures.

‘Decentralized assets storage system’ refers to a distributed network for storing digital assets associated with tokens, where data is spread across multiple nodes rather than being held in a centralized location, enhancing security and availability.

‘Universal Resource Identifier (URI)’ refers to a string of characters used to identify a resource on the internet or within a decentralized storage network, used in the system to link token metadata to license files stored off-chain.

‘Smart contract’ refers to self-executing agreements with the terms of the agreement directly written into code that automatically enforce and execute predefined conditions when triggered, enabling trustless transactions on the blockchain.

‘Proxy pattern smart contract architecture’ refers to a design approach that separates contract logic from storage, enabling upgradability of the system's functionality without migrating stored data or disrupting existing token ownership.

‘Hierarchical caching system’ refers to an optimization technique that stores frequently accessed royalty calculation results in an off-chain cache to reduce computational resources needed for repetitive operations.

### BRIEF DESCRIPTION OF DRAWINGS

The detailed description is described with reference to the accompanying Figures. The same numbers are used throughout the drawings to refer to features and components.

FIG. 1 illustrates a network architecture of a system for decentralized co-creation and royalty distribution on a blockchain-based distributed ledger, in accordance with an embodiment of the present subject matter.

FIG. 2 illustrates architecture of the system, in accordance with an embodiment of the present subject matter.

FIG. 3 illustrates an exemplary flowchart of a method for decentralized co-creation and royalty distribution on a blockchain-based distributed ledger, in accordance with an embodiment of the present subject matter.

FIG. 4 illustrates a sequence diagram illustrating the transaction and royalty distribution process, in accordance with an embodiment of the present subject matter.

FIG. 5 illustrates a flowchart for the token creation and royalty distribution lifecycle in the decentralized co-creation system, in accordance with an embodiment of the present subject matter.

FIG. 6 illustrates a block diagram depicting a Branching Recursive Royalty Network (BRRN) for multi-tier royalty distribution, in accordance with an embodiment of the present subject matter.

FIG. 7 illustrates another block diagram depicting the token metadata structure and royalty relationships in the Branching Recursive Royalty Network (BRRN), in accordance with an embodiment of the present subject matter.

FIG. 8 illustrates a flowchart depicting the token creation and royalty distribution process implemented by the Branching Recursive Royalty Network (BRRN), in accordance with an embodiment of the present subject matter.

FIG. 9 illustrates a flowchart depicting the loop-based execution model for optimizing blockchain transaction costs in royalty distribution, in accordance with an embodiment of the present subject matter.

FIG. 10 illustrates a flowchart depicting the transaction cost optimization process implemented by the royalty management module, in accordance with an embodiment of the present subject matter.

FIG. 11 illustrates a flowchart depicting the capped royalty validation mechanism implemented by the royalty management module, in accordance with an embodiment of the present subject matter.

FIG. 12 illustrates a flowchart depicting the AI-driven royalty recommendation system, in accordance with an embodiment of the present subject matter.

FIG. 13 illustrates a flowchart depicting the dynamic licensing system implemented by the licensing module, in accordance with an embodiment of the present subject matter.

FIG. 14 illustrates a flowchart depicting the license type management system implemented by the licensing module, in accordance with an embodiment of the present subject matter.

FIG. 15 illustrates a flowchart depicting the marketplace transaction processing system, in accordance with an embodiment of the present subject matter.

FIG. 16 illustrates a flowchart depicting the fraud prevention system implemented by the fraud prevention module, in accordance with an embodiment of the present subject matter.

### DETAILED DESCRIPTION

Reference throughout the specification to “various embodiments,” “some embodiments,” “one embodiment,” or “an embodiment” means that a particular feature, structure, or characteristic described in connection with the embodiment is included in at least one embodiment. Thus, appearances of the phrases “in various embodiments,” “in some embodiments,” “in one embodiment,” or “in an embodiment” in places throughout the specification are not necessarily all referring to the same embodiment. Furthermore, the particular features, structures or characteristics may be combined in any suitable manner in one or more embodiments.

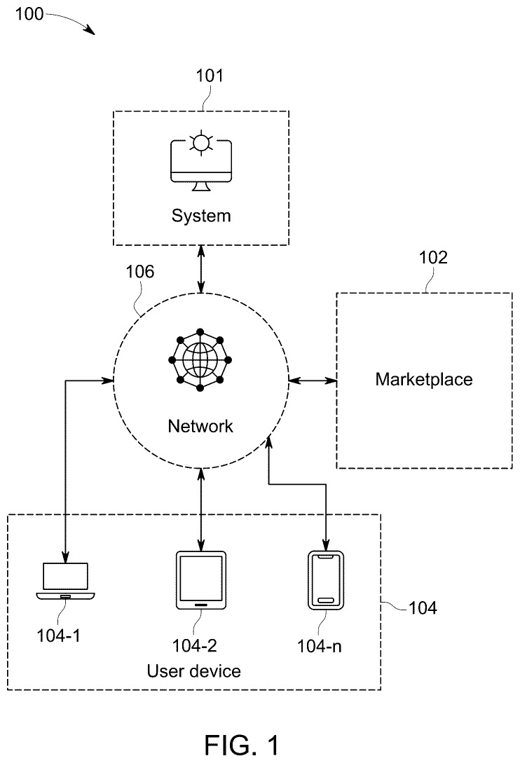

Referring now to FIG. 1, a network architecture 100 of system 101 for decentralized co-creation and royalty distribution on a blockchain-based distributed ledger is illustrated, in accordance with an embodiment of the present subject matter. In one embodiment, the system 101 may comprise a processor and a memory. Further, the system 101 may be connected to user devices and marketplace through a blockchain network 106. It may be understood that the system 101 may be communicatively coupled with multiple users through one or more User devices 104-1, 104-2, 104-3 . . . , 104-n collectively referred to as a user device 104. The system 101 also interacts with a marketplace 102 that facilitates transactions for tokens representing creative works. The system 101 enables creator users and evolver users to register original works and create derivative works through the network 106. User devices 104 connect to the system 101 and marketplace 102 via the network 106, which represents a blockchain network such as Polygon. The system 101 processes transactions, manages licensing, and distributes royalties according to the multi-branch tree structure maintained on the blockchain-based distributed ledger. The network architecture allows for secure, transparent tracking of creative work ownership and royalty distribution while enabling collaborative creation processes between creators and evolvers using various user devices 104.

In one embodiment, the network 106 may be a blockchain network used by user devices 104 such as computers, tablets, or mobile devices. In one embodiment, the blockchain network may be the Polygon blockchain network. The user device 104 may be any electronic device, communication device, digital content creation device, machine, software, automated computer program, a robot or a combination thereof. Further the marketplace 102 may be any decentralized platform, service, or interface that facilitates the buying and selling of tokens representing creative works. The system 101 may be configured to register creative works on the blockchain-based distributed ledger. Further, the system 101 may be configured to validate derivative works, each time an evolver user makes a request to create a derivative work based on an existing token.

In one embodiment, the user devices 104 are enabled with blockchain wallet capabilities. Further, the user devices 104 may support communication with the system 101 over one or more types of networks in accordance with the described embodiments. For example, some user devices and networks may support communications over a Wide Area Network (WAN), the Internet, a telephone network (e.g., analog, digital, POTS, PSTN, ISDN, xDSL), a mobile telephone network (e.g., CDMA, GSM, NDAC, TDMA, E-TDMA, NAMPS, WCDMA, CDMA-2000, UMTS, 3G, 4G, 5G), a radio network, a television network, a cable network, an optical network (e.g., PON), a satellite network (e.g., VSAT), a packet-switched network, a circuit-switched network, a public network, a private network, and/or other wired or wireless communications network configured to carry data to the blockchain-based distributed ledger. The aforementioned user devices 104 and network 106 may support wireless local area network (WLAN) and/or wireless metropolitan area network (WMAN) data communications functionality in accordance with Institute of Electrical and Electronics Engineers (IEEE) standards, protocols, and variants such as IEEE 802.11 (“WiFi”), IEEE 802.16 (“WiMAX”), IEEE 802.20x (“Mobile-Fi”), and others.

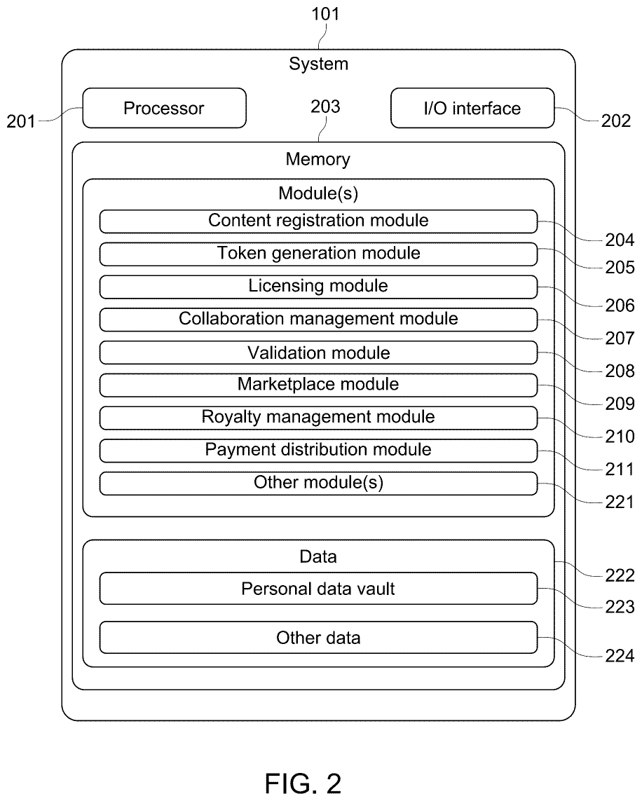

In an embodiment, the system 101 includes various modules for handling different aspects of the token generation and royalty management process. The system 101 provides a secure way to manage creative works by utilizing blockchain technology while enabling collaborative creation and fair compensation. In order to enable a creator user to register a primary original work and allow evolver users to create derivative works, the System 101 performs several key processes: Content Registration, Token Generation, Licensing, Collaboration Management, Validation, Marketplace Transactions, Royalty Management, and Payment Distribution. Throughout these processes, the system 101 maintains integrity by storing all transactions on the blockchain-based distributed ledger. Instead of centralized control, it employs a multi-branch tree structure to track relationships between original works and derivative works, facilitating recursive royalty distribution upon transaction events. This approach combines the benefits of blockchain-based ownership with collaborative creation capabilities while maintaining fair compensation for all contributors. The system supports both principal royalties for original creators and spinoff royalties for contributors to derivative works through a royalty distribution algorithm. The capped royalty validation mechanism ensures that royalty structures remain sustainable, preventing the creation or sale of tokens with unsustainable royalty obligations. This enables the system 101 to work seamlessly with existing blockchain platforms while providing enhanced functionality for creative collaboration. By implementing these core processes, the system 101 provides a secure and user-friendly solution to creative collaboration and royalty management that bridges the gap between traditional content creation models and decentralized ownership paradigms. The system 101 architecture is further illustrated with the block diagram in FIG. 2.

In some embodiments, the system enables tokenized representations of physical assets in addition to digital or creative assets. For example, a token on the blockchain-based distributed ledger may represent ownership, licensing rights, or usage permissions for a tangible product (e.g., a piece of furniture, clothing, footwear, artwork, or collectible). When the token is sold or transferred, the system records and enforces the corresponding transfer of rights to the physical item. Physical handover, logistics, and other off-chain processes are coordinated alongside the on-chain transaction, ensuring alignment between real-world possession and the immutable blockchain record of ownership.

In another embodiment, the tokens described in this specification may correspond to real-world, physical assets rather than (or in addition to) purely digital content. For instance, a StartToken can represent an original physical product design (e.g., a chair, fashion garment, or sculpture), and SpinoffTokens may represent derivative adaptations of that design, including physical modifications or variations. The same licensing module, collaboration management module, and royalty management module apply when physical assets are sold or transferred:
a. Digital Twin Representation: Each physical item is associated with a unique token on the blockchain, serving as its “digital twin.” The on-chain metadata includes references to the physical product's specifications, ownership records, and applicable usage or resale restrictions.
b. Transfer of Rights: A marketplace transaction for the token triggers the transfer of rights to the corresponding physical assets. Real-world delivery or logistics processes occur off-chain, but the system ensures that ownership records (and any ongoing royalty obligations) are updated on the blockchain-based distributed ledger.
c. Royalty Enforcement: As with digital works, if the physical asset spawns derivative products or further adaptations, the system can distribute royalties among the original creator, evolver users, and other stakeholders. The same multi-branch tree structure tracks lineage and ensures that sales of physical products yield appropriate economic splits.
d. External Integrations: Because the system supports external e-commerce platforms, physical items can be listed and sold externally while still relying on the blockchain-based ledger to verify ownership and facilitate royalty payments. Smart contracts ensure alignment between the token record and real-world possession.

Referring now to FIG. 2, various components of the System 101 are illustrated, in accordance with an embodiment of the present subject matter. As shown, the system 101 may include at least one processor 201, an I/O Interface 202 and a memory 203. The memory 203 consists of a set of modules. The set of modules may include a Content registration module 204, a Token generation module 205, a Licensing module 206, a Collaboration management module 207, a Validation module 208, a Marketplace module 209, a Royalty management module 210, a Payment distribution module 211 and Other Modules 221. In one embodiment, the at least one processor 201 is configured to fetch and execute computer-readable instructions, stored in the memory 203, corresponding to each module.

In one embodiment, the memory 203 may include any computer-readable medium known in the art including, for example, volatile memory, such as static random-access memory (SRAM) and dynamic random-access memory (DRAM), and/or non-volatile memory, such as read-only memory (ROM), erasable programmable ROM, flash memories, hard disks, optical disks, and memory cards.

In one embodiment, the programmed instructions may include routines, programs, objects, components, data structures, etc., which perform particular tasks, functions, or implement particular abstract data types. The data 222 may comprise a Personal Data Vault 223, and other data 224. The Personal Data Vault 223 is configured to maintain the token metadata, licensing parameters, and royalty distribution relationships for each token. The Personal Data Vault 223 may be implemented as an encrypted database on the blockchain-based distributed ledger, ensuring secure and transparent access to this critical information. The other data 224 serves as a repository for storing data processed, received, and generated by one or more components and programmed instructions.

The processor 201 is configured to execute various modules that collectively implement the decentralized co-creation and royalty distribution system. Each module is designed to handle specific aspects of the system as defined in the claims, working together to provide secure and transparent token management through blockchain technology.

In one embodiment, the Other Modules 221 may comprise a royalty stream management module for enabling transferable royalty rights, an external platform integration module for connecting with third-party e-commerce platforms, a fraud prevention module for detecting unauthorized duplications and verifying authenticity, a recursive calculation optimization system for efficient royalty distribution calculations, a royalty simulation module for predictive royalty analysis, an AI-driven royalty recommendation module for suggesting optimal royalty parameters based on market data and creator influence, an on-chain transaction monitoring system for tracking token-related activities across multiple blockchains, a cross-platform licensing enforcement mechanism for ensuring compliance with licensing terms on external platforms, a state segmentation mechanism for processing large multi-branch tree structures efficiently, a proxy pattern smart contract architecture for enabling system upgradability without disrupting existing token structures, a hierarchical caching system for optimizing royalty calculations, an efficient metadata storage system for minimizing on-chain storage costs, and a staged transaction execution system for handling complex operations across multiple blockchain blocks.

In one embodiment, the content registration module 204 may be configured to receive a primary original work from a creator user. The content registration module 204 may verify the authenticity and originality of the submitted work through various validation processes. The content registration module 204 may extract metadata from the submitted work, including creation date, file format, size, and other relevant attributes. The content registration module 204 may prepare the primary original work for tokenization by ensuring all necessary information is properly documented and formatted. The content registration module 204 may interface with the token generation module 205 to initiate the creation of a StartToken representing the primary original work. The content registration module 204 may maintain records of all registered works and their associated tokens on the blockchain-based distributed ledger. The content registration module 204 may also handle updates to existing works, ensuring proper versioning and maintaining the integrity of the creative history. The content registration module 204 may implement various security measures to protect the confidentiality and integrity of the primary original work during the registration process. The content registration module 204 may support multiple file formats and content types, allowing creators from various disciplines to register their work on the platform. The content registration module 204 may integrate with decentralized storage systems to securely store the digital assets associated with registered works.

In one embodiment, the token generation module 205 may be configured to generate a StartToken on the blockchain-based distributed ledger. The StartToken may correspond to the received primary original work. The StartToken may comprise StartToken metadata and a first spinoff permission parameter. The first spinoff permission parameter may be set by the creator user and may indicate whether derivative works (“Spinoffs”) for the primary original work are permitted. The token generation module 205 may generate a unique identifier for each StartToken to ensure its distinctiveness on the blockchain. The token generation module 205 may encode the creator's preferences regarding derivative works into the token's smart contract. The token generation module 205 may support multiple types of token creation. The token generation module 205 may receive, from the creator user, a request to create a specific type of token along with the corresponding creative work. The token generation module 205 may process the request based on the specified token type. For a StartToken, the token generation module 205 may verify original authorship and establish root permissions in the multi-branch tree structure. For a SpinoffToken, the token generation module 205 may validate the parent-child relationship and inherit applicable constraints from the set of licensing parameters. For a SpinoffToken with no derivative capabilities, the token generation module 205 may create a derivative work that disallows further Spinoffs while maintaining the parent-child relationship in the multi-branch tree structure. For an EndToken, the token generation module 205 may create an exclusive token with no derivative capabilities. The token generation module 205 may generate the requested token type with appropriate metadata and smart contract properties specific to its function. The token generation module 205 may register the newly created token in the multi-branch tree structure with the appropriate hierarchical position, thereby establishing its role in future royalty distributions.

In one embodiment, the token generation module 205 may implement an efficient metadata storage system. The efficient metadata storage system may receive token creation requests containing detailed metadata about the primary original work or the at least one derivative work. The efficient metadata storage system may process the metadata by separating immutable identifier data from descriptive content, storing minimal critical metadata on-chain to establish ownership and relationships, generating cryptographic references to off-chain storage locations for extended metadata, and creating verifiable links between the on-chain and off-chain components. The efficient metadata storage system may store the extended metadata on a distributed file storage system. The efficient metadata storage system may generate the StartToken, the SpinoffToken, or the EndToken with hybrid metadata structures that maintain blockchain-level security for critical properties while minimizing transaction costs associated with storing large data sets on-chain. The token generation module 205 may also handle token updates, ensuring that any changes to the token's properties are properly recorded on the blockchain. The token generation module 205 may integrate with the royalty management module 210 to establish initial royalty parameters for each token. The token generation module 205 may provide mechanisms for token validation, ensuring that all generated tokens comply with the system's standards and requirements.

The efficient metadata storage system represents a technical breakthrough in addressing one of the fundamental constraints of blockchain platforms: the prohibitive cost of on-chain data storage. By implementing a hybrid architecture that strategically separates immutable identifier data from descriptive content, the system achieves an optimal balance between security and efficiency. The selective storage of minimal critical metadata on-chain focuses blockchain resources on essential ownership and relationship information that requires maximum security guarantees, while avoiding unnecessary consumption of valuable block space. The generation of cryptographic references to off-chain storage locations through content-addressed hashing creates tamper-evident links that maintain data integrity without requiring full content storage on the blockchain. The creation of verifiable links between on-chain and off-chain components through cryptographic signatures ensures that extended metadata remains provably connected to its on-chain token while residing in more cost-effective storage systems. This technical approach typically reduces on-chain storage requirements by 98-99% compared to fully on-chain storage approaches, transforming what would be economically prohibitive token creation into viable operations. The resulting hybrid metadata structures maintain blockchain-level security guarantees for critical properties while enabling rich, comprehensive documentation of creative works that would otherwise be impossible within blockchain storage constraints. This directly expands the practical scope of creative works that can be represented on blockchain platforms by solving the technical challenge of balancing comprehensive documentation with economic viability.

In one embodiment, the licensing module 206 may be configured to register at least one license associated with the StartToken in a license registry on the blockchain-based distributed ledger. The at least one license may comprise a set of licensing parameters that define usage rights for the primary original work. The licensing module 206 may implement a dynamic licensing system. The dynamic licensing system may receive, from the creator user, licensing parameters for the StartToken. The licensing parameters may define permitted uses of the primary original work, restricted activities, attribution requirements, and conditions for derivative works. The dynamic licensing system may process the licensing parameters to generate machine-readable license terms encoded in smart contract format, establish verification mechanisms to ensure compliance with license terms, set up automated enforcement triggers, and create license metadata for storage on the blockchain-based distributed ledger. The dynamic licensing system may link the license metadata to the StartToken at the time of generation by embedding a Universal Resource Identifier (URI) in the StartToken metadata. The URI may point to the license file stored on a decentralized storage network. The set of licensing parameters may define the type of license. The StartToken metadata may reference these license attributes. The dynamic licensing system may record the processed licensing parameters in the license registry on the blockchain-based distributed ledger. The dynamic licensing system may provide the licensing parameters to the validation module 208 for verifying compliance of spinoff requests and the at least one derivative work with the established terms.

In one embodiment, the licensing module 206 may be configured to generate, upon validation of a spinoff request, an evaluation license for an evolver user. The evaluation license may grant the evolver user temporary access to the primary original work. The licensing module 206 may be further configured to generate a spinoff creation license for the evolver user associated with the SpinoffToken. The licensing module 206 may maintain a comprehensive registry of all licenses on the blockchain-based distributed ledger, ensuring transparency and accountability in the licensing process. The licensing module 206 may support multiple license types, each with specific terms and conditions tailored to different use cases. The licensing module 206 may implement license validation mechanisms to ensure that all generated licenses comply with legal and system requirements. The licensing module 206 may provide mechanisms for license revocation or modification under certain conditions, such as breach of terms or mutual agreement between parties. The licensing module 206 may support multi-stage approval for derivative works. The licensing module 206 may receive from an evolver user of the one or more evolver users, a request to modify an existing license for a specific use case. The licensing module 206 may process the request by analyzing the proposed modifications against the original license terms, identifying all stakeholders in the multi-branch tree structure affected by the license change, generating a ballot for decentralized approval voting, and determining the required approval threshold based on the significance of the proposed modifications. The licensing module 206 may distribute the ballot to all affected stakeholders through the collaboration management module 207 for voting. The licensing module 206 may update the license in the license registry on the blockchain-based distributed ledger only upon receiving the required threshold of stakeholder approvals, thereby ensuring consensus for any licensing modifications.

In one embodiment, the collaboration management module 207 may be configured to receive, when the first spinoff permission parameter allows Spinoffs, one or more spinoff requests from one or more evolver users to create at least one derivative work based on the StartToken. The collaboration management module 207 may be further configured to receive at least one derivative work from the evolver user based on the primary original work. The collaboration management module 207 may be further configured to receive a request to create an EndToken based on at least one of the StartToken or the SpinoffToken. The collaboration management module 207 may facilitate communication between creator users and evolver users, providing a platform for discussion and feedback on creative works. The collaboration management module 207 may maintain a record of all collaboration activities, ensuring transparency and traceability in the creative process. The collaboration management module 207 may implement conflict resolution mechanisms to address disputes between collaborators. The collaboration management module 207 may provide tools for version control and change tracking, enabling collaborators to monitor the evolution of creative works. The collaboration management module 207 may support various collaboration models, including direct collaboration, competitive submissions, and open contribution frameworks. The collaboration management module 207 may implement a staged transaction execution system. The staged transaction execution system may receive complex transaction requests that would exceed transaction cost limits if executed as single operations. The staged transaction execution system may process the requests by decomposing them into ordered sequences of smaller, atomic operations, generating unique transaction identifiers to track the overall process, creating state verification checks between stages to ensure consistency, and preparing recovery procedures for handling interrupted sequences. The staged transaction execution system may execute the decomposed transactions in sequence, verifying the success of each stage before proceeding. The staged transaction execution system may consolidate results from all stages into a unified transaction outcome, enabling transaction cost-intensive operations to be completed across multiple blocks without compromising transaction integrity.

The staged transaction execution system addresses a critical technical limitation of in blockchain environments: the inherent constraint of block gas limits that prevents execution of complex operations as single transactions. By implementing a sophisticated decomposition algorithm, the system transforms operations that would exceed transaction limits into ordered sequences of smaller, atomic operations that fit within blockchain constraints while maintaining logical consistency. The generation of unique transaction identifiers creates a verifiable linkage between component transactions, enabling traceability and integrity verification throughout the multi-stage process. The implementation of state verification checks between stages provides crucial technical safeguards that prevent execution from proceeding if previous stages failed or were tampered with, maintaining transactional integrity across block boundaries. The preparation of recovery procedures enables resilience against network interruptions or failed transactions, allowing complex operations to resume from their interruption point rather than restarting entirely. This technical architecture effectively transforms what would be impossible operations under conventional blockchain constraints into viable processes that maintain security and consistency guarantees. By enabling the consolidation of results from all stages into unified transaction outcomes, the system presents logically cohesive operations to users and applications while working within the fundamental technical limitations of blockchain platforms. This expands the practical complexity of creative ecosystem operations by approximately an order of magnitude beyond what would be possible with conventional blockchain transaction approaches.

In one embodiment, the validation module 208 may be configured to validate the one or more spinoff requests through a multi-tiered approval mechanism based on the StartToken metadata. The validation module 208 may be further configured to validate the at least one derivative work based on compliance with constraints defined in the StartToken metadata. The validation module 208 may perform validation comprising at least one of: (i) manual validation requiring explicit approval by the creator user through a smart contract interface, or (ii) automated validation based on predefined licensing parameters stored in the StartToken metadata. The validation module 208 may implement various validation algorithms to ensure that derivative works comply with the requirements and constraints defined by the original creator. The validation module 208 may maintain a record of all validation activities, ensuring transparency and accountability in the approval process. The validation module 208 may provide feedback to evolver users when their submissions do not meet validation criteria, allowing them to make necessary adjustments. The validation module 208 may implement time-based validation protocols, ensuring that approval processes are completed within specified timeframes. The validation module 208 may coordinate with the licensing module 206 to ensure that all validated works comply with the established licensing terms. The validation module 208 may support batch validation processes for handling multiple spinoff requests efficiently. The validation module 208 may integrate with the fraud prevention module to ensure that all validated works are original and do not violate intellectual property rights.

In one embodiment, the SpinoffToken creation may include a parent validation process. The parent validation process may receive from an evolver user of the one or more evolver users, a SpinoffToken creation request referencing a specific parent token. The parent validation process may retrieve, from the blockchain-based distributed ledger, the metadata and constraints of the parent token. The parent validation process may process the request through a validation workflow that verifies compliance with the parent token's derivative work restrictions, confirms the evolver user holds a valid evaluation license for the parent token, checks that proposed royalty distributions satisfy maximum royalty caps, and validates that required approvals have been obtained from the creator user of the parent token. The parent validation process may generate a validation report detailing compliance or identifying specific violations. The parent validation process may proceed with SpinoffToken creation only upon successful validation, ensuring all parent-imposed constraints are respected in the at least one derivative work. The validation module 208 may implement machine learning algorithms to identify patterns of non-compliance and improve validation accuracy over time. The validation module 208 may provide dispute resolution mechanisms when disagreements arise regarding validation decisions. The validation module 208 may maintain detailed logs of all validation activities for auditing and compliance purposes.

In one embodiment, the marketplace module 209 may be configured to facilitate transactions for the purchase and sale of at least one of the StartToken, the SpinoffToken, or the EndToken through a smart contract-based marketplace. The smart contract may define a set of royalty parameters. The marketplace module 209 may implement a decentralized marketplace. The decentralized marketplace may receive listings including pricing information, quantity available, and sale conditions. The decentralized marketplace may process the listings by validating ownership of the listed StartToken, SpinoffToken, or EndToken on the blockchain-based distributed ledger, verifying compliance with the set of licensing parameters, calculating platform fees and royalty distributions, and generating smart contracts that govern the transaction events. The decentralized marketplace may publish the validated listings to a marketplace interface. The decentralized marketplace may execute transaction events when a buyer submits a purchase request, triggering automatic royalty distribution through the royalty management module 210 according to the multi-branch tree structure. The marketplace module 209 may provide search and discovery mechanisms, enabling users to find relevant tokens based on various criteria. The marketplace module 209 may implement recommendation algorithms to suggest tokens to users based on their preferences and browsing history. The marketplace module 209 may provide auction functionality, allowing sellers to auction their tokens to the highest bidder. The marketplace module 209 may implement price discovery mechanisms, helping sellers determine appropriate pricing for their tokens. The marketplace module 209 may provide transaction history and analytics, giving users insights into market trends and token valuations.

In one embodiment, the marketplace module 209 may further support multiple transaction types. The marketplace module 209 may receive different types of transaction requests from marketplace participants, wherein the transaction types include fixed-price purchases, time-limited auction listings, conditional offers with expiration dates, and bundle sales of multiple related tokens. The marketplace module 209 may process each transaction type using specialized smart contract logic that enforces the specific rules and conditions of the transaction type, manages bid validation for auctions, handles expiration of time-sensitive offers, and coordinates bundle transfers when multiple tokens are involved. The marketplace module 209 may execute the transactions upon fulfillment of all required conditions. The marketplace module 209 may update ownership records on the blockchain-based distributed ledger while triggering appropriate royalty distribution events. The marketplace module 209 may implement escrow mechanisms to ensure secure transactions between parties. The marketplace module 209 may provide dispute resolution mechanisms for handling transaction-related conflicts. The marketplace module 209 may support cross-chain transactions, enabling interoperability with other blockchain networks. The marketplace module 209 may implement advanced fraud detection algorithms to identify and prevent fraudulent transactions. The marketplace module 209 may provide transaction optimization tools to minimize gas fees and transaction costs.

In one embodiment, the royalty management module 210 may be configured to implement a recursive royalty distribution system that maintains the multi-branch tree structure tracking relationships and contributions among the tokens. The royalty management module 210 may implement a Branching Recursive Royalty Network (BRRN) for multi-tier royalty distribution. The BRRN may receive, from the blockchain-based distributed ledger, a hierarchical structure of parent-child relationships between the StartToken, the SpinoffToken, and the EndToken. Each of the StartToken, the SpinoffToken, and the EndToken may include the StartToken metadata, the SpinoffToken metadata, and EndToken metadata. Each of the metadata may comprise: (i) a unique identifier on the blockchain-based distributed ledger, (ii) metadata defining programmable constraints, (iii) provenance data maintaining verifiable authorship and ownership records, and (iv) usage rights specifications defining permitted interactions with the primary original work and the at least one derivative work. The BRRN may process the metadata to generate the multi-branch tree structure representing royalty distribution paths. The BRRN may record the multi-branch tree structure on the blockchain-based distributed ledger for efficient retrieval. The BRRN may utilize the multi-branch tree structure to calculate and distribute royalties to multiple stakeholders at each level of the hierarchy using an iterative, loop-based execution model designed to optimize blockchain transaction costs.

In one embodiment, the royalty management module 210 may execute a loop-based execution model for optimizing blockchain transaction costs. The loop-based execution model may receive transaction data from the marketplace module 209 when a sale event occurs. The loop-based execution model may retrieve the multi-branch tree structure from the blockchain-based distributed ledger. The loop-based execution model may process the multi-branch tree structure using iterative loops instead of recursive function calls. Processing the multi-branch tree structure using iterative loops may comprise a first loop iterates through each level of the multi-branch tree structure from a terminal node to a root node. Processing the multi-branch tree structure using iterative loops may comprise a second loop processes all nodes at each level in batches to avoid deep recursion. Processing the multi-branch tree structure using iterative loops may comprise the iterative loops maintain a running tally of remaining funds to be distributed. The loop-based execution model may output a series of discrete payment transactions to the payment distribution module 211 for execution to the creator user and the one or more evolver users based on respective positions in the multi-branch tree structure, thereby preventing smart contract stack overflows and minimizing transaction costs on the blockchain-based distributed ledger.

The loop-based execution model for optimizing blockchain transaction costs represents a significant technical advancement over traditional recursive approaches to processing hierarchical royalty structures. By replacing resource-intensive recursive function calls with iterative loops, the system overcomes the fundamental limitation of blockchain environments where deep recursion can cause stack overflows and excessive gas consumption. The first loop's top-down iteration through hierarchical levels and the second loop's batch processing of nodes at each level work in tandem to dramatically reduce computational complexity while maintaining mathematical correctness. This approach directly addresses the technical challenge of processing complex royalty distributions within the constrained execution environment of blockchain networks, where computation directly correlates to financial costs. The running tally mechanism further optimizes memory usage by eliminating redundant calculations. The resulting discrete payment transactions are structured to minimize gas consumption while ensuring accurate compensation to all contributors regardless of the depth or complexity of the creative lineage. This technical solution enables the processing of royalty structures that would be economically prohibitive or technically impossible using conventional recursive approaches.

In one embodiment, the royalty management module 210 may further optimize transaction costs. The royalty management module 210 may receive, from the blockchain-based distributed ledger, the multi-branch tree structure. The royalty management module 210 may preprocess the multi-branch tree structure by flattening the nested hierarchy into a linear array of payment recipients, wherein the payment recipients comprise the creator user and the one or more evolver users who contributed to the creation of the StartToken, the SpinoffToken, or the EndToken. The royalty management module 210 may preprocess the multi-branch tree structure by calculating each recipient's royalty amount based on predetermined percentages and position in the multi-branch tree structure. The royalty management module 210 may preprocess the multi-branch tree structure by consolidating multiple payments to the same recipient. The royalty management module 210 may preprocess the multi-branch tree structure by sorting recipients by payment amount to optimize transaction batching. The royalty management module 210 may record the preprocessed payment data on the blockchain-based distributed ledger. The royalty management module 210 may execute batched payment transactions using the payment distribution module 211, thereby reducing the total number of blockchain transactions required and minimizing transaction costs on the blockchain-based distributed ledger.

The transaction cost optimization methodology implemented by the royalty management module represents a technical breakthrough in blockchain efficiency. By preprocessing the multi-branch tree structure through flattening, the system transforms a complex hierarchical data structure into a computationally efficient linear array that significantly reduces processing overhead. This technical approach addresses the fundamental blockchain constraint where each computation step incurs financial costs in the form of gas fees. The calculated consolidation of multiple payments to the same recipient eliminates redundant transactions that would otherwise multiply gas costs unnecessarily. Furthermore, the strategic sorting of recipients by payment amount enables optimized transaction batching that leverages blockchain network efficiencies. This preprocessing approach fundamentally changes the computational complexity from O(n²) in a naive implementation to approximately O(n), resulting in exponential efficiency gains as the royalty network scales. The system's ability to record preprocessed payment data on the blockchain creates a verifiable, transparent record while the batched execution minimizes the total transaction count. This technical solution directly addresses the scalability limitations of blockchain systems by enabling complex royalty distributions to occur at a fraction of the gas cost that would be required by conventional approaches.

In one embodiment, the royalty management module 210 may implement a capped royalty validation mechanism. The capped royalty validation mechanism may receive royalty allocation data based on the set of royalty parameters from each of the StartToken, the SpinoffToken, and the EndToken in the multi-branch tree structure. The capped royalty validation mechanism may process the royalty obligations recursively, ensuring that at every node in the multi-branch tree structure, the greater of the percentage-based royalty or minimum royalty value is used. The capped royalty validation mechanism may validate the feasibility of generating a new token by checking whether the proposed royalty structure can fulfill all parent obligations in the multi-branch tree structure. The capped royalty validation mechanism may perform royalty validation during token pricing, transaction events, and offer negotiations to ensure that the final sale price can cover all required royalty distributions. The capped royalty validation mechanism may output a validation result to the token generation module 205 and the marketplace module 209, preventing the creation or sale of tokens with unsustainable royalty obligations. The royalty management module 210 may provide tools for royalty analysis and forecasting, helping users understand the potential revenue streams from their tokens. The royalty management module 210 may support multiple payment methods and currencies, providing flexibility for users in different regions. The royalty management module 210 may implement auto-compounding features, allowing users to reinvest their royalties automatically.

In one embodiment, the royalty management module 210 may implement a hierarchical caching system for efficient royalty calculations. The hierarchical caching system may receive a request to calculate royalty distributions for a specific transaction event. The hierarchical caching system may retrieve, from an off-chain cache, pre-computed royalty distribution templates for common transaction scenarios. The hierarchical caching system may process the royalty calculation request by determining if the current transaction matches a cached scenario, applying transaction-specific parameters to the template if a match exists, calculating royalties from scratch only for novel transaction patterns, and storing the results of new calculations in the cache for future use. The hierarchical caching system may generate the final royalty distribution plan based on either the cached template or new calculation. The hierarchical caching system may output the plan to the payment distribution module 211, significantly reducing on-chain computation for frequently occurring royalty distribution patterns. The royalty management module 210 may provide detailed royalty reports, giving users insights into their earnings and payment sources. The royalty management module 210 may implement smart contract upgradability for royalty calculations, allowing for improvements and optimizations over time. The royalty management module 210 may support royalty splitting for collaborative works, ensuring fair distribution among multiple creators.

The hierarchical caching system for efficient royalty calculations represents a transformative technical approach to the computational limitations of blockchain environments. By implementing a sophisticated off-chain caching architecture, the system addresses a critical constraint where on-chain computation directly translates to financial costs in the form of gas fees. The system's retrieval and application of pre-computed royalty distribution templates for common transaction scenarios leverages pattern recognition to dramatically reduce redundant calculations. The intelligent matching algorithm that determines whether current transactions align with cached scenarios enables computational reuse without sacrificing accuracy or customization. By applying transaction-specific parameters to generalized templates when matches exist, the system maintains mathematical precision while eliminating unnecessary recalculation of structural relationships and distribution logic. The selective approach to calculating royalties from scratch only for novel transaction patterns ensures that computational resources are invested only where necessary, while the strategic storage of new calculation results continuously expands the system's optimization capabilities. This technical architecture achieves approximately linear scaling of gas costs relative to transaction volume, rather than the exponential scaling that would occur in naive implementations as royalty structures grow in complexity. The resulting reduction in on-chain computation—often exceeding 85% for common transaction patterns—transforms what would otherwise be prohibitively expensive royalty distributions into economically viable operations, enabling complex creative ecosystem relationships that would be technically impossible under conventional blockchain computation approaches.

In one embodiment, the system 101 may further comprise a secured assets access module. The secured assets access module may be implemented as part of the Other Modules 221 and may provide secure management of digital assets associated with tokens. The StartToken, SpinoffToken, or EndToken may include a reference to one or more secured digital assets uploaded by the creator user or evolver user and stored on a decentralized assets storage system. For example, a StartToken representing an architectural design may include references to secured digital assets such as detailed CAD files, 3D models, material specifications, structural calculations, and photorealistic renderings. These digital assets may contain the valuable intellectual property that gives the token its utility and value.

The secured assets access module may utilize advanced cryptographic techniques to ensure that access to these valuable digital assets is strictly controlled. Rather than storing the digital assets directly on the blockchain, which would be prohibitively expensive and inefficient, the system 101 may store only cryptographic references or hashes on the blockchain-based distributed ledger. The actual digital assets may be stored on a decentralized assets storage system such as InterPlanetary File Storage (IPFS), Arweave, or other distributed storage networks. This approach combines the security and immutability of blockchain with the scalability and efficiency of decentralized storage systems. For instance, a fashion design token might store detailed pattern files, material specifications, and production guidelines on IPFS, with only secure references to these files embedded in the token's metadata on the blockchain.

The secured assets access module may be configured for granting temporary access to the evolver user upon approval of a spinoff request, wherein access is facilitated through the decentralized file storage system. This temporary access is a critical feature that enables collaborative creation while protecting intellectual property rights. When an evolver user submits a spinoff request that is approved by the validation module 208, the secured assets access module may generate time-limited encryption keys or access tokens that provide the evolver user with the ability to view and work with the secured digital assets. For example, if an interior designer requests to create a spinoff of an architectural house design to develop a custom interior layout, the secured assets access module may provide temporary access to the detailed floor plans, structural specifications, and 3D models of the original design.

The temporary access granted to the evolver user may be subject to various restrictions and controls. These may include time limitations, such as access expiring after 30 days; usage limitations, such as view-only access that prevents direct copying of files; watermarking of accessed files to identify the evolver and prevent unauthorized distribution; and tracking of access patterns to detect potential misuse. For instance, when an evolver user accesses CAD files for a furniture design to create a spinoff, the system might apply dynamic watermarks to all viewed files and restrict the ability to export or download the original files in their native format. The evolver would be able to view the detailed design to understand its structure and create their derivative work but would be prevented from simply copying and making minor modifications to the original files.

The secured assets access module may implement sophisticated access control mechanisms that leverage blockchain-based identity verification and smart contract conditions. Access rights may be encoded in smart contracts that automatically execute when predefined conditions are met, such as approval of a spinoff request. For example, when a game developer requests to create a spinoff of a 3D character model, the approval of their request by the original creator may trigger a smart contract that grants them secure, temporary access to the character's mesh files, textures, and rigging specifications. This access might be revoked automatically if the evolver fails to submit a derivative work within the specified timeframe.

The secured assets access module may also be configured for granting access to a buyer upon completion of a purchase transaction, wherein secured access is facilitated through the decentralized file storage system. When a buyer completes a purchase of a token through the marketplace module 209, the secured assets access module may grant the buyer appropriate access rights to the secured digital assets associated with the purchased token. Unlike the temporary access granted to evolvers, the access granted to buyers is typically permanent or for the duration of their ownership of the token. For example, when a manufacturing company purchases a token representing an industrial product design, they would receive access to all production-ready files, specifications, and documentation needed to produce the item.

The access granted to buyers may vary based on the licensing parameters associated with the purchased token. Different levels of access rights may be encoded in the smart contract governing the token, reflecting the specific rights transferred in the purchase. For instance, a token representing a musical composition might grant the buyer access to high-quality audio files for personal enjoyment, while a more expensive license tier might provide access to individual instrument tracks, MIDI files, and sheet music for commercial use or further remixing. These differentiated access rights allow creators to offer various licensing tiers at different price points, maximizing the value they can extract from their creative works.

The secured assets access module may implement a secure key management system to control access to the digital assets. This system may use public-key cryptography, where files are encrypted with a public key, and only those with the corresponding private key can decrypt and access them. The secured assets access module may manage the distribution of these keys, or the credentials required to access them. For example, when an architectural firm purchases a commercial license for a building design token, the secured assets access module might provide a unique set of decryption keys that provide access to all relevant design files, automatically delivering these keys to the firm's secure wallet or storage system.

The secured assets access module may also integrate with the licensing module 206 to ensure that access to digital assets complies with the licensing terms associated with each token. If a license requires attribution, the secured assets access module may embed attribution requirements in the accessed files or require acknowledgment before granting access. If a license prohibits commercial use, the secured assets access module may implement technical measures to detect and prevent commercial applications of the accessed assets. For instance, a photography token's license might specify “non-commercial use only,” in which case the secured assets access module might provide images with embedded metadata that tracks usage and flags commercial applications or might provide lower-resolution files suitable only for personal use.

In one embodiment, the system 101 may include a royalty stream management module for enabling transferable royalty rights. The royalty stream management module may be configured to automatically process the transfer of associated rights and royalty streams upon a transaction event involving the StartToken, the SpinoffToken, or the EndToken. The royalty stream management module may verify the transaction on the blockchain-based distributed ledger, calculate the expected value of future royalty distributions based on historical transaction data and market projections, and record the buyer as the new owner in the token metadata while preserving the creator user's ownership of the underlying primary original work and perpetual royalty rights. The royalty stream management module may maintain structured royalty distributions where the creator user continues receiving principal royalties from all transaction events involving the token, and the current owner inherits spinoff royalties from derivative works. The royalty stream management module may update the token metadata on the blockchain-based distributed ledger to reflect the ownership change while ensuring the integrity of the multi-branch tree structure. The royalty stream management module may ensure that royalty distributions and rights follow the token transfer, automatically recording new entitlements without requiring separate manual approvals. The royalty stream management module may output confirmation of the ownership transfer transaction to the buyer and seller, and provide confirmation to the royalty holder, enabling the royalty holder to transfer, sell, or collateralize future royalty earnings while maintaining the original creator user's ownership of the underlying primary original work.

In one embodiment, the system 101 may include an external platform integration module. The external platform integration module may receive distribution requests from third-party entities wishing to sell tokens by integrating with external e-commerce platforms. The external platform integration module may process the distribution requests by validating the identity and security credentials of the requesting distributor, generating API keys for secure communication, establishing webhook endpoints for event notifications, and configuring royalty enforcement mechanisms for external sales. The external platform integration module may create a secure bridge between the blockchain-based distributed ledger and the external platform using cryptographic verification. The external platform integration module may monitor external transaction events to ensure that all royalty obligations are properly fulfilled, triggering the royalty distribution system when sales occur on connected platforms. The external platform integration module may include an on-chain transaction monitoring system that receives transaction data from multiple blockchain networks and external marketplaces. The on-chain transaction monitoring system may process the transaction data by filtering for activities related to tokens in the system's registry, verifying the authenticity of reported sales, matching external transactions with the corresponding tokens in the multi-branch tree structure, and identifying royalty payment obligations triggered by external sales. The on-chain transaction monitoring system may generate royalty distribution instructions based on the identified transactions and forward the instructions to the payment distribution module, ensuring that the creator user and the one or more evolver users receive appropriate compensation regardless of where their tokens are sold.

In one embodiment, the system 101 may include a fraud prevention module. The fraud prevention module may receive token creation requests and transaction data from the token generation module 205 and the marketplace module 209. The fraud prevention module may process the data through a multi-layered verification system that performs cryptographic hashing of creative content to detect unauthorized duplications, compares visual and textual elements against existing tokens using similarity detection algorithms, validates that linked assets properly reference their parent tokens through cryptographic signatures, and verifies the authenticity of the creator user and the one or more evolver users' identities. The fraud prevention module may generate a risk assessment score for each token and transaction. The fraud prevention module may output the assessment results to the respective modules, blocking transactions or token creations that fail to meet security thresholds. The fraud prevention module may work in conjunction with the validation module 208 to ensure the integrity of all creative works and transactions on the platform.

In one embodiment, the system may include a recursive calculation optimization system. The recursive calculation optimization system may receive a request from the royalty management module 210 to calculate royalty distributions for the multi-branch tree structure. The recursive calculation optimization system may process the request by converting the recursive royalty distribution algorithm into an equivalent iterative implementation, restructuring the multi-branch tree structure into a flattened array representation with explicit parent-child relationships, implementing a breadth-first traversal algorithm that processes nodes level by level rather than depth-first, and utilizing temporary computational resources for intermediate calculation results to avoid redundant processing. The recursive calculation optimization system may execute the optimized calculation algorithm to determine royalty amounts for all participants in the multi-branch tree structure. The recursive calculation optimization system may return the calculated royalty distribution to the payment distribution module 211, achieving the same mathematical result as recursive calculation while consuming significantly less computational resources and transaction costs on the blockchain-based distributed ledger. The recursive calculation optimization system may incorporate a state segmentation mechanism that receives the multi-branch tree structure with multiple branches and levels from the blockchain-based distributed ledger. The state segmentation mechanism may process the multi-branch tree structure to divide it into manageable segments based on depth and breadth metrics, assign each segment a unique identifier and processing priority, create a processing schedule that minimizes memory requirements, and establish checkpoints for resuming execution if interrupted. The state segmentation mechanism may execute royalty calculations for each segment sequentially, recording intermediate results on the blockchain-based distributed ledger. The state segmentation mechanism may merge the segmented calculation results into a final royalty distribution plan, thereby enabling processing of arbitrarily large multi-branch tree structures without encountering transaction cost limits or stack depth limitations.

The recursive calculation optimization system represents a fundamental technical advancement in blockchain computational efficiency. By algorithmically transforming inherently recursive royalty calculations into equivalent iterative implementations, the system overcomes the technical limitations of blockchain environments where recursion depth is severely constrained by stack size limitations and where each computational step incurs financial costs. The system's restructuring of the multi-branch tree into a flattened array with explicit parent-child relationships fundamentally transforms the data structure to optimize for blockchain processing while maintaining all relationship information. This transformation enables the implementation of a breadth-first traversal algorithm that processes nodes level by level rather than depth-first, providing predictable memory usage patterns that are crucial for constrained blockchain environments. The strategic utilization of temporary computational resources for caching intermediate results eliminates redundant calculations that would otherwise multiply gas costs, particularly in complex royalty structures where multiple paths may reference the same contributors. This optimization technique maintains mathematical equivalence to recursive calculations while dramatically reducing computational resource consumption—often achieving 70-90% reductions in gas costs for complex royalty structures. This technical solution directly addresses one of the most significant challenges in implementing creative royalty systems on blockchain platforms: making complex calculations economically viable within gas-constrained environments.

The state segmentation mechanism represents a breakthrough solution to the fundamental blockchain constraint of block gas limits. By intelligently segmenting the multi-branch tree structure based on depth and breadth metrics, the system overcomes what would otherwise be an absolute technical barrier to processing large-scale royalty distributions. This approach addresses the inherent limitation where blockchain transactions must fit within a single block's gas limit, which would conventionally prevent processing of royalty structures beyond a certain size threshold. The mechanism's assignment of unique identifiers and processing priorities to segments enables systematic tracking of complex operations across multiple blocks while maintaining data integrity. The creation of optimized processing schedules minimizes memory requirements during execution, addressing another critical constraint in blockchain environments. The establishment of checkpoints for resuming execution provides crucial fault tolerance, allowing recovery from network interruptions or gas price fluctuations without losing progress. This technical architecture enables the system to process arbitrarily large royalty structures by executing calculations for each segment sequentially and recording intermediate results, effectively transforming an otherwise impossible computation into a series of manageable operations. The final merging of segmented results maintains mathematical correctness while circumventing the technical limitations that would prevent large-scale royalty distributions from being processed on conventional blockchain systems. This directly expands the practical upper bound of complexity that can be managed in blockchain-based creative royalty systems.

In one embodiment, the system 101 may further include a royalty simulation module for predictive royalty analysis. The royalty simulation module may receive, from the collaboration management module 207, a proposed royalty structure for a new SpinoffToken. The royalty simulation module may process the proposed royalty structure by simulating the addition of the new SpinoffToken to the existing multi-branch tree structure, calculating the royalty distributions for various transaction price scenarios, analyzing the impact on transaction costs for multi-branch tree structure depths and branching factors, and identifying potential bottlenecks or inefficiencies such as excessive transaction costs, deep recursion risks, or unbalanced royalty allocations in the royalty distribution. The royalty simulation module may generate a transaction efficiency report and optimization recommendations. The royalty simulation module may output the report and recommendations to the creator user and the one or more evolver user for review before finalizing the SpinoffToken creation. The royalty simulation module may provide interactive visualization tools, helping users understand complex royalty structures through visual representations. The royalty simulation module may implement sensitivity analysis capabilities, allowing users to test different royalty scenarios and observe the outcomes. The royalty simulation module may provide comparative analysis tools, enabling users to compare different royalty structures and identify optimal configurations.

The proxy pattern smart contract architecture constitutes a significant technical advancement in blockchain-based systems by solving the fundamental immutability challenge inherent to deployed smart contracts. Traditional smart contracts, once deployed, cannot be modified—a limitation that severely restricts system evolution and makes error correction virtually impossible without complete redeployment and data migration. The system's layered contract structure with distinct separation between logic and storage through the proxy-implementation pattern enables unprecedented flexibility while maintaining data integrity. The central address registry provides a critical technical infrastructure for dynamic resolution of implementation locations, allowing the system to evolve without disrupting existing token references. The delegation pattern employed by the system enables the execution of upgraded business logic while operating on consistent storage locations, ensuring that token ownership and royalty structures remain intact during system evolution. This architecture's support for atomic upgrades of contract logic without data migration represents a quantum improvement over traditional approaches that would require complex, error-prone migration processes involving all tokens, royalty relationships, and licensing parameters. By enabling continuous improvement of the system's functionality without disrupting existing ecosystem relationships, this technical approach solves what would otherwise be a terminal limitation for long-term blockchain platforms: the inability to adapt to emerging technical challenges, security vulnerabilities, or evolving market requirements while preserving the integrity of existing creative works and their economic relationships.

Having described the components and modules of the system 101 in detail with reference to FIGS. 1 and 2, the following description will now explain the processes and methods implemented by the system 101 for decentralized co-creation and royalty distribution.

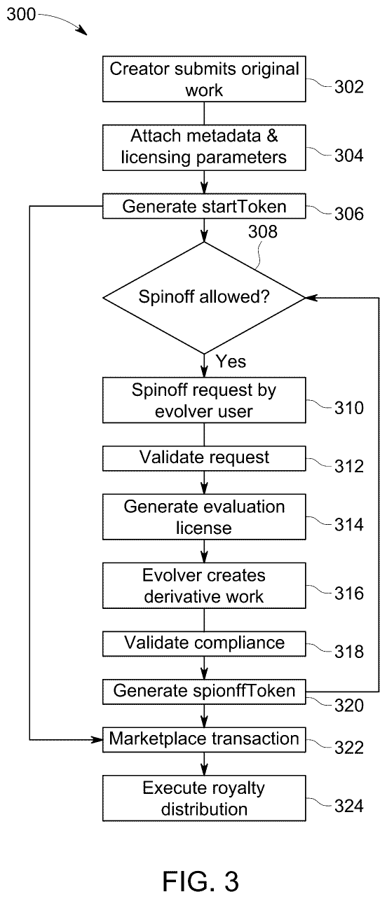

Referring to FIG. 3, a method 300 for decentralized co-creation and royalty distribution on a blockchain-based distributed ledger is illustrated, in accordance with an embodiment of the present subject matter. The method 300 illustrates the complete workflow from original content creation to royalty distribution for derivative works, encompassing the key processes implemented by the system 101.

Although illustrated primarily in the context of digital content (e.g., digital art, music, designs), the processes and flowcharts depicted in FIG. 3 (and similarly throughout this disclosure) are equally applicable when the tokenized asset corresponds to a real-world, physical asset. In such cases, physical delivery or logistics occur off-chain, while the blockchain-based token tracks ownership, licensing, or usage rights for that tangible product.

At Step 302, the system 101 is configured for receiving a primary original work from a creator user. This fundamental step involves the content registration module 204 receiving and processing the creative work submitted by the creator. The primary original work may be a digital asset in various forms such as digital art, music composition, literary work, design, or any other creative content that can be represented digitally. For example, a digital artist may submit an original 3D model design for furniture or shoes, or a musician may submit an original music composition. The system 101 may verify the authenticity of the submission and prepare it for tokenization on the blockchain-based distributed ledger.

At Step 304, the system 101 is configured for attaching metadata and licensing parameters to the primary original work. The licensing module 206 may process licensing parameters defined by the creator user, which specify the permitted uses, restrictions, attribution requirements, and conditions for creating derivative works. The metadata may include information about the work such as creation date, title, description, medium, dimensions, and other relevant attributes. For instance, the creator may specify that the work can be used for commercial purposes with proper attribution, or that derivative works are permitted under certain conditions. These licensing parameters are essential for governing how the work can be used and modified by others within the platform ecosystem.

At Step 306, the system 101 is configured for generating a StartToken on the blockchain-based distributed ledger. The token generation module 205 creates a unique digital token that represents the primary original work. This StartToken contains the StartToken metadata, and a first spinoff permission parameter set by the creator user. The StartToken serves as the digital representation of the original work on the blockchain, establishing verifiable ownership and provenance. The StartToken may be implemented as a non-fungible token with unique properties that distinguish it from other tokens on the blockchain. For example, a StartToken for a furniture design might include detailed specifications, dimensions, materials list, and rendering files, all cryptographically secured on the blockchain.

At Step 308, the system 101 is configured to determine whether spinoffs are allowed based on the first spinoff permission parameter. This decision point evaluates whether the creator has permitted derivative works to be created based on their original work. If the first spinoff permission parameter indicates that spinoffs are not allowed (No path), the process may proceed directly to marketplace transactions at Step 322, bypassing the spinoff creation workflow. If spinoffs are allowed (Yes path), the process continues to Step 310, enabling the collaborative evolution of the creative work. This permission parameter gives creators control over how their work can be built upon by others, balancing protection of intellectual property with opportunities for collaboration.

At Step 310, the system 101 is configured to receive a spinoff request from an evolver user. When spinoffs are permitted, the collaboration management module 207 may receive requests from evolver users who wish to create derivative works based on the StartToken. These requests may include details about the proposed modifications, creative direction, intended use, and potential value additions to the original work. For example, an industrial designer might request to create a derivative of a furniture design by adapting it for outdoor use with weather-resistant materials, or a music producer might request to remix an original composition with additional instrumentation and effects.

At Step 312, the system 101 is configured for validating the spinoff request. The validation module 208 performs a multi-tiered approval process to ensure that the spinoff request complies with the constraints defined in the StartToken metadata and licensing parameters. This validation may involve manual approval by the creator user through a smart contract interface, automated validation based on predefined rules, or a combination of both approaches. The system may check various factors such as the evolver user's reputation, the nature of the proposed modifications, and compliance with licensing terms. This step ensures that all derivative works align with the creator's intentions and maintain the integrity of the original work.

At Step 314, the system 101 is configured for generating an evaluation license for the evolver user. After validating the spinoff request, the licensing module 206 issues a temporary license that grants the evolver user access to the primary original work for the purpose of creating a derivative work. This evaluation license may have limitations such as time restrictions, usage boundaries, or prohibitions on further distribution during the development phase. The license is recorded on the blockchain-based distributed ledger, ensuring transparent tracking of access permissions. This temporary access enables the evolver to work with the original content while maintaining appropriate controls over the intellectual property.

At Step 316, the system 101 is configured for receiving a derivative work from the evolver user. The collaboration management module 207 receives the completed derivative work that the evolver user has created based on the primary original work. This derivative work represents the evolver's creative contribution and modifications to the original content. For example, an evolver might submit a modified furniture design with additional features, different dimensions, or alternative materials, while maintaining core elements of the original design. The derivative work submission may include the modified content along with documentation describing the changes and added value.

At Step 318, the system 101 is configured for validating compliance of the derivative work. The validation module 208 verifies that the submitted derivative work complies with the constraints defined in the StartToken metadata and the terms of the evaluation license. This compliance check ensures that the derivative work respects the boundaries established by the original creator while adding meaningful value. The validation process may involve technical analysis of the content, comparison with the original work, and verification of licensing compliance. This step maintains the integrity of the creative ecosystem by ensuring that derivative works build upon, rather than exploit, the original creations.

At Step 320, the system 101 is configured for generating a SpinoffToken on the blockchain-based distributed ledger. After successful validation of the derivative work, the token generation module 205 creates a SpinoffToken that represents the derivative work. This SpinoffToken contains SpinoffToken metadata and a second spinoff permission parameter indicating whether further derivatives of this work are permitted. The SpinoffToken is cryptographically linked to the StartToken through a multi-branch tree structure, establishing a verifiable parent-child relationship in the hierarchical data structure. This relationship is crucial for tracking the lineage of creative works and enabling fair royalty distribution to all contributors in the creation chain.

At Step 322, the system 101 is configured to facilitate marketplace transactions. The marketplace module 209 enables the purchase and sale of the StartToken, SpinoffToken, or EndToken through a smart contract-based marketplace. These transactions may include various types such as fixed-price sales, auctions, or bundle offerings. The smart contracts define royalty parameters that govern how revenue is distributed among contributors. For example, when a buyer purchases a SpinoffToken representing a modified furniture design, the transaction is executed through smart contracts that automatically handle the financial settlement and record the ownership transfer on the blockchain.

At Step 324, the system 101 is configured for executing royalty distributions. The payment distribution module 211 processes royalty payments when a transaction event occurs. These royalty distributions include a principal royalty to the creator user of the original work and spinoff royalties to each contributing evolver user. The distributions follow the multi-branch tree structure maintained by the royalty management module 210, ensuring that all contributors receive their fair share based on their position in the creation hierarchy. For instance, when a derivative furniture design sells, the original designer might receive 10% as principal royalty, while the evolver who modified the design receives 5% as spinoff royalty, with payments automatically distributed through the blockchain-based system.

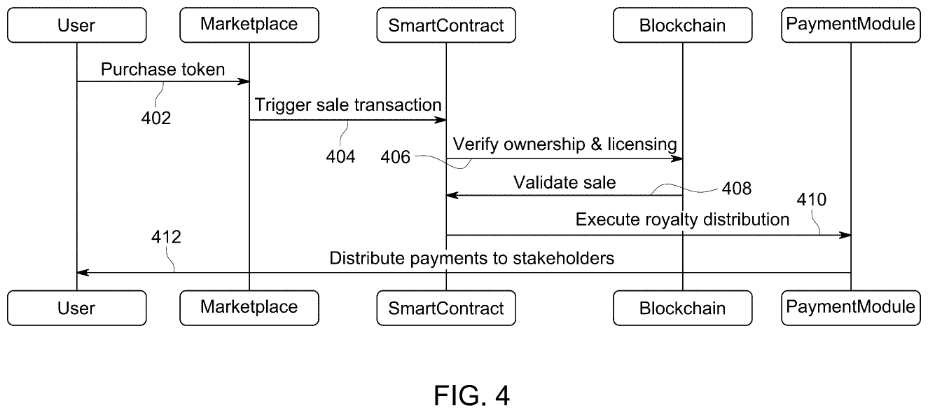

Referring to FIG. 4, a sequence diagram 400 illustrating the transaction and royalty distribution process in the decentralized co-creation system is provided, in accordance with an embodiment of the present subject matter. The sequence diagram 400 depicts the interactions between various entities including User, Marketplace, Smart Contract, Blockchain, and Payment Module during a token purchase and royalty distribution process.

At Step 402, a User initiates a purchase transaction for a token, which may be a StartToken, SpinoffToken, or EndToken. This step represents the beginning of the transaction process, where a buyer expresses intent to acquire a creative work represented by a token on the blockchain-based distributed ledger. The User may be interacting with the system 101 through a user device 104, accessing the marketplace interface to browse available tokens. For example, a buyer interested in acquiring a 3D furniture design represented by a SpinoffToken would select the token and initiate the purchase process by submitting a purchase request through the smart contract-based marketplace.

At Step 404, the Marketplace triggers a sale transaction by interacting with the Smart Contract. The marketplace module 209 facilitates transactions for the purchase and sale of the token through the smart contract-based marketplace, wherein the smart contract defines a set of royalty parameters. The marketplace module 209 processes the purchase request and initiates the execution of the smart contract that governs the token transfer and associated royalty distributions. For instance, when a buyer purchases a SpinoffToken representing a modified architectural design, the marketplace module 209 would trigger the smart contract to execute the transaction according to predefined rules and parameters.

At Step 406, the Smart Contract verifies ownership and licensing on the Blockchain. This critical validation step ensures that the seller has legitimate ownership of the token being sold and that the transaction complies with the set of licensing parameters that define usage rights for the primary original work or derivative work. The smart contract interacts with the license registry on the blockchain-based distributed ledger to retrieve and verify the current ownership records and licensing terms. For example, the system may verify that the SpinoffToken being sold has not violated any constraints defined in the StartToken metadata, such as commercial usage restrictions or attribution requirements.

At Step 408, the Blockchain validates the sale by confirming the transaction details and ensuring compliance with blockchain protocols. This validation includes verifying that the transaction meets all requirements for execution, such as sufficient funds from the buyer, proper authorization, and compliance with the constraints defined in the token metadata. Upon successful validation, the blockchain-based distributed ledger records the transaction, creating an immutable record of the ownership transfer. This step ensures the integrity and transparency of the transaction, providing a verifiable proof of the new ownership state.

At Step 410, the Smart Contract executes royalty distribution by instructing the PaymentModule to process payments according to the defined royalty parameters. The royalty management module 210 implements a recursive royalty distribution system that maintains the multi-branch tree structure tracking relationships and contributions among the tokens. This calculation determines the principal royalty for the creator user and spinoff royalties for each contributing evolver user. For instance, if a token represents a collaborative music composition with multiple contributors, the system would calculate appropriate royalties for the original composer as well as for arrangers, performers, and other contributors who created derivative works.

At Step 412, the Payment Module distributes payments to stakeholders based on their positions in the multi-branch tree structure. The payment distribution module 211 executes royalty distributions upon occurrence of a transaction event, wherein the royalty distributions include a principal royalty to the creator user and spinoff royalties to each contributing evolver user. For example, if a SpinoffToken representing a modified clothing design is sold for 1000 units of cryptocurrency, the payment distribution might allocate 100 units to the original creator user as principal royalty, 50 units to the immediate evolver user who created the SpinoffToken, and potentially smaller amounts to other evolver users in the creation chain who contributed to earlier derivatives. Each stakeholder receives their share automatically through the blockchain-based distributed ledger without requiring manual intervention, thanks to the smart contract automation.

The sequence diagram 400 illustrates the seamless execution of transactions and royalty distributions within the decentralized co-creation system. This automated process ensures fair compensation for all contributors while maintaining transparency and efficiency in financial settlements. The recursive royalty distribution system represents a significant advancement over traditional models, where tracking and distributing royalties for derivative works often involves complex, manual processes prone to errors and disputes. The cryptographically linked multi-branch tree structure enables the system to maintain an accurate record of all parent-child relationships and ensures that royalty obligations are properly fulfilled for every transaction event.

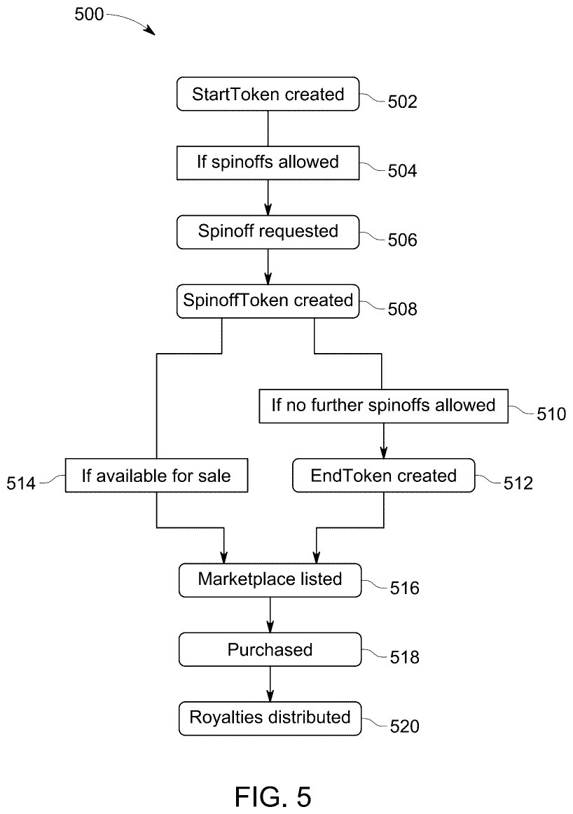

Referring to FIG. 5, a flowchart 500 illustrating the token creation and royalty distribution lifecycle in the decentralized co-creation system is provided, in accordance with an embodiment of the present subject matter. The flowchart 500 depicts the progression from initial token creation through spinoff development, marketplace transactions, and royalty distribution, highlighting the decision points and state transitions in the token lifecycle.

At Step 502, a StartToken is created on the blockchain-based distributed ledger. This step represents the outcome of the token generation module 205 generating a StartToken corresponding to a primary original work submitted by a creator user. The StartToken contains StartToken metadata and a first spinoff permission parameter set by the creator user. For example, an architectural designer might create a StartToken representing a residential house design, with metadata detailing the specifications, dimensions, structural elements, and aesthetic features of the design, along with licensing parameters defining how the design may be used or modified.

At Step 504, the system evaluates whether spinoffs are allowed based on the first spinoff permission parameter. This decision determines whether derivative works can be created based on the StartToken. If spinoffs are not allowed, the process may proceed directly to the marketplace listing stage. If spinoffs are allowed, the process continues to Step 506, enabling collaborative evolution of the creative work. For instance, the architectural designer might set the spinoff permission parameter to allow other designers to create variations of the original house design for different climates or with alternative features.

At Step 506, a spinoff is requested by an evolver user. When spinoffs are permitted, the collaboration management module 207 receives a spinoff request from an evolver user who wishes to create a derivative work based on the StartToken. For example, an evolver user might request to create a modified version of the house design that incorporates sustainable energy features, such as solar panels and rainwater harvesting systems, while maintaining the core architectural elements of the original design.

At Step 508, a SpinoffToken is created on the blockchain-based distributed ledger. After successful validation of the spinoff request and the resulting derivative work, the token generation module 205 generates a SpinoffToken representing the derivative work. The SpinoffToken comprises SpinoffToken metadata and a second spinoff permission parameter indicating whether further Spinoffs are permitted. The SpinoffToken inherits applicable constraints from the set of licensing parameters of the StartToken. For instance, if the original house design specified that commercial usage requires attribution, this constraint would be inherited by the SpinoffToken representing the sustainable energy modification.

At Step 510, the system evaluates whether further spinoffs are allowed based on the second spinoff permission parameter. This decision determines whether additional derivative works can be created based on the SpinoffToken. If the second spinoff permission parameter prohibits further spinoffs, the process continues to Step 512 for EndToken creation. For example, the evolver who created the sustainable energy modification might set the second spinoff permission parameter to prohibit further derivatives, considering their design to be a final adaptation ready for implementation.

At Step 512, an EndToken is created on the blockchain-based distributed ledger. The EndToken represents a finalized creative work ready for distribution and sale. The EndToken is created automatically if the first spinoff permission parameter or the second spinoff permission parameter prohibits further Spinoffs. For example, when the sustainable energy house design is finalized and no further modifications are permitted, an EndToken would be created to represent this completed design ready for sale to builders or homeowners.

At Step 514, the system evaluates whether the token is available for sale. This decision point determines whether the token (StartToken, SpinoffToken, or EndToken) is ready to be listed on the marketplace. Various factors may influence this decision, such as the creator's readiness to sell, completion of quality checks, or fulfillment of legal requirements. For instance, the architectural designer might need to ensure that all technical specifications and building code compliance documents are complete before making the house design available for purchase.

At Step 516, the token is listed on the marketplace. The marketplace module 209 facilitates this listing, making the token available for purchase through the smart contract-based marketplace. The listing includes details such as pricing, quantity available, and sale conditions. For example, the sustainable energy house design might be listed for sale with a price of 5 Ethereum, along with details about the design features, dimensions, and documentation included.

At Step 518, the token is purchased by a buyer. This represents a successful transaction where ownership of the token transfers to the buyer through the smart contract-based marketplace. For instance, a construction company might purchase the sustainable energy house design with the intention of building multiple homes based on this design in an eco-friendly housing development.

At Step 520, royalties are distributed to all contributors. The payment distribution module 211 executes royalty distributions upon occurrence of the transaction event. The hierarchical data structure forms a node in the multi-branch tree structure for tracking contribution relationships for royalty distribution. The recursive royalty distribution system calculates royalty allocations based on the set of royalty parameters in the smart contract. For example, from the 5 Ethereum sale price of the sustainable energy house design, the original architectural designer might receive 0.5 Ethereum (10%) as principal royalty, and the evolver who added sustainable energy features might receive 0.75 Ethereum (15%) as spinoff royalty.

The recursive royalty distribution system enforces maximum royalty caps to prevent excessive fee accumulation. This ensures that the total royalty obligations do not become unsustainably high as works evolve through multiple generations of derivatives. For instance, if the system has a maximum royalty cap of 30%, the combined royalties for all contributors could not exceed 1.5 Ethereum on the 5 Ethereum sale, regardless of how many contributors were involved in the creation chain.

The recursive royalty distribution system also prevents royalty dilution through mathematical constraints in deeply nested derivative chains. This ensures that early contributors in a long chain of derivatives still receive meaningful compensation for their fundamental contributions. For example, if the original house design inspired five generations of derivatives, the system would ensure that the original designer still receives a meaningful royalty rather than having their share diluted to insignificance.

The spinoff royalties are calculated recursively through the parent-child relationships in the multi-branch tree structure. This calculation follows the hierarchical connections between tokens, ensuring that each contributor receives appropriate compensation based on their position in the creation chain. For instance, if the sustainable energy house design was further modified by another evolver to add smart home technology before being finalized as an EndToken, the royalty distribution for a sale might allocate 0.5 Ethereum (10%) to the original designer, 0.4 Ethereum (8%) to the sustainable energy modifier, and 0.6 Ethereum (12%) to the smart home technology contributor.

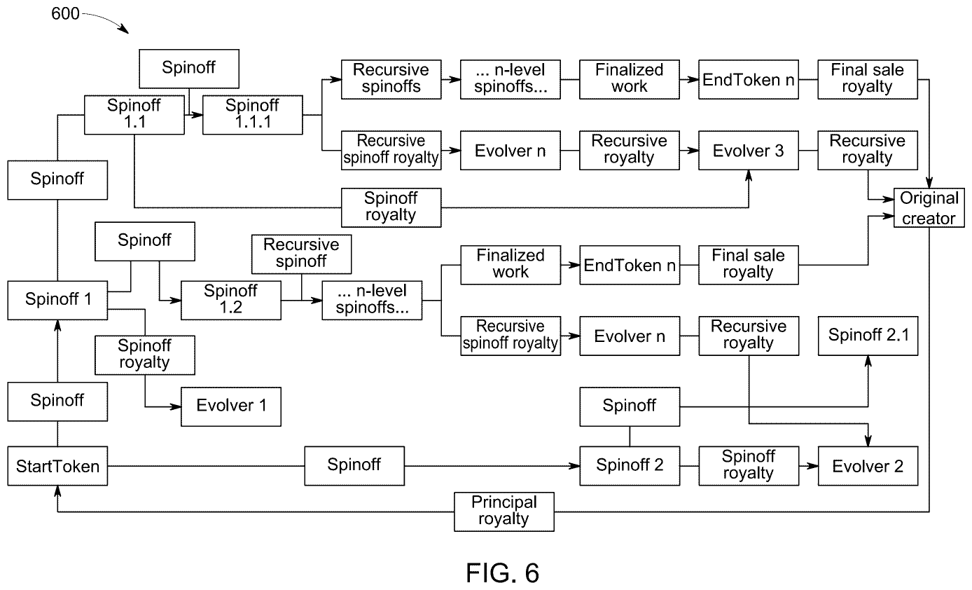

Referring to FIG. 6, a diagram 600 illustrating a Branching Recursive Royalty Network (BRRN) for multi-tier royalty distribution is provided, in accordance with an embodiment of the present subject matter. The diagram 600 depicts the hierarchical flow of tokens and royalties through a complex multi-branch tree structure, demonstrating how the system tracks relationships between creative works and distributes compensation when sales occur.

The flow begins with the StartToken. The StartToken represents the primary original work created by the Original Creator. For example, the StartToken might represent an original fashion design template with complete pattern files, material specifications, and production guidelines. This StartToken contains comprehensive metadata including a unique blockchain identifier, programmable constraints regarding permissible modifications, full provenance data establishing original authorship, and specified usage rights.

From the StartToken, the flow branches into multiple spinoff paths. The first branch leads to Spinoff 1, a first-generation derivative of the original work. Spinoff 1 might represent a variation of the fashion design adapted for winter wear with added insulation layers and weather-resistant materials. When Spinoff 1 is created, a Spinoff Royalty relationship is established with Evolver 1, the creator of this derivative work. This relationship ensures that whenever Spinoff 1 or its derivatives are sold, Evolver 1 receives appropriate compensation.

The flow continues with Spinoff 1 branching into two second-generation derivatives: Spinoff 1.1 and Spinoff 1.2. Spinoff 1.1 might represent a luxury version of the winter fashion design with premium materials and embellishments, while Spinoff 1.2 could be a simplified, cost-effective version maintaining the core functional elements. These branches illustrate how the system supports different evolutionary paths from the same parent work.

From Spinoff 1.1, the flow progresses to Spinoff 1.1.1, a third-generation derivative. This might be a specialized version of the luxury winter design adapted for extreme cold conditions with additional technical features. The diagram shows this branch continuing through “ . . . n-level Spinoffs . . . ” indicating that the system supports an arbitrary number of generations in the derivative chain. This extensibility allows creative works to evolve continuously while maintaining the integrity of royalty relationships.

Some branches in the flow culminate in a “Finalized Work” state, which leads to the creation of an EndToken. The EndToken represents a creative work that has reached its final form and is ready for distribution and sale, with no further derivatives permitted. For example, an EndToken might represent a production-ready fashion design with complete manufacturing specifications, pricing information, and marketing assets. When an EndToken is sold, a Final Sale Royalty flows to the Original Creator, ensuring that the fundamental contribution of the primary work is always recognized and compensated.

In parallel with the first branch, the StartToken also flows to Spinoff 2, representing a different first-generation derivative path. Spinoff 2 might be an adaptation of the original fashion design for summer wear, using lightweight materials and modified patterns for warmer weather. This branch establishes a Spinoff Royalty relationship with Evolver 2, the creator of this variant. The flow shows Spinoff 2 further evolving into Spinoff 2.1, perhaps a specialized active-wear adaptation of the summer design.

Throughout the diagram, various royalty flows are illustrated. The Principal Royalty flows directly from any token sale to the Original Creator, shown by the line connecting the bottom of the diagram to the Original Creator node. This represents the foundational compensation that acknowledges the contribution of the primary original work to all derivatives, regardless of their position in the hierarchy.

Spinoff Royalty flows connect each derivative work to its immediate creator. For example, when Spinoff 1 sells, a royalty flows to Evolver 1; when Spinoff 2 sells, a royalty flows to Evolver 2; and when Spinoff 2.1 sells, a royalty flows to Evolver 2. These connections ensure that direct contributors to each work receive appropriate compensation when their specific creations are sold.

Recursive Spinoff Royalty and Recursive Royalty flows represent the system's ability to distribute compensation through multiple levels of the hierarchy. These flows ensure that contributors at every level receive their share when distant derivatives of their work are sold. For instance, the diagram shows how royalties from n-level spinoffs flow back through Evolver n nodes and eventually reach earlier contributors like Evolver 3.

The BRRN processes this complex network of relationships to calculate and distribute royalties efficiently. When a sale occurs at any node in the network, the system traces all relevant connections to identify stakeholders entitled to compensation. For example, if an EndToken n is sold for 1000 units of cryptocurrency, the system might allocate 70 units (7%) as the Final Sale Royalty to the Original Creator, 50 units (5%) to the immediate creator of the EndToken, and the remaining royalty amount distributed proportionally to intermediate contributors based on their position in the hierarchy and the value they added.

The FIG. 6 effectively illustrates the comprehensive nature of the BRRN, showing how it maintains a complete record of creative evolution through multiple generations while ensuring fair compensation to all contributors. This architecture supports a vibrant ecosystem of collaborative creation where both original works and valuable adaptations are properly recognized and rewarded.

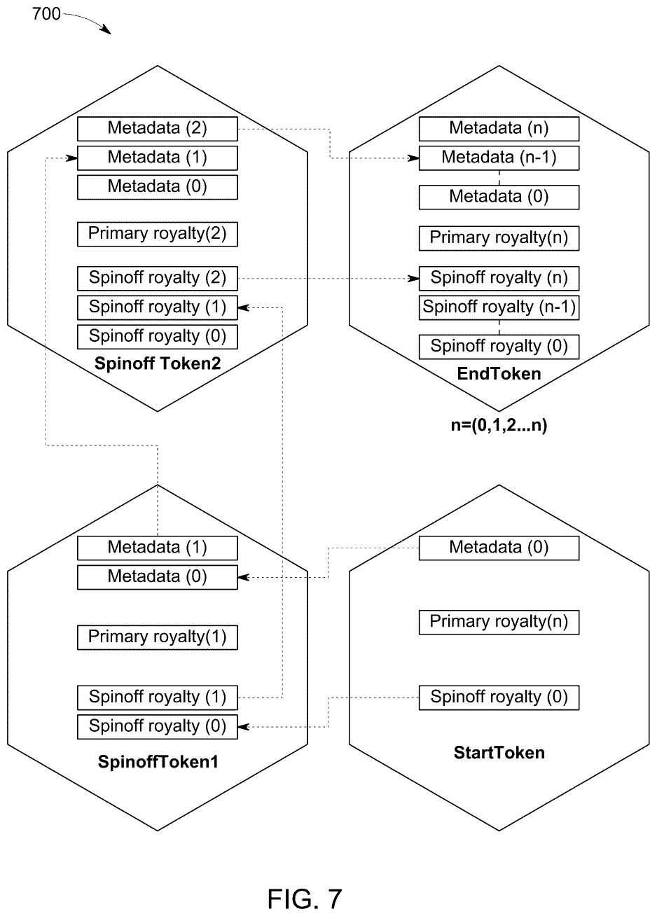

Referring to FIG. 7, a diagram 700 illustrating the token metadata structure and royalty relationships in the Branching Recursive Royalty Network (BRRN) is provided, in accordance with an embodiment of the present subject matter. The diagram 700 depicts the detailed internal structure of tokens at different levels of the hierarchy and shows how metadata and royalty parameters propagate through the network.

The diagram 700 shows a progression from a StartToken, through SpinoffToken1 and SpinoffToken2, to an EndToken. This progression represents the evolution of creative works from the original creation through successive derivative works to a finalized product. The hexagonal representation of each token emphasizes their unique structure and distinct metadata composition.

The StartToken contains Metadata (0), representing the original metadata associated with the primary original work. This metadata may comprise a unique identifier on the blockchain-based distributed ledger that distinguishes this token from all others on the network. For example, a footwear designer might create a StartToken for an original athletic shoe design with a unique identifier hash “0x7f2c8d94e3b8a1c9” on the blockchain. The StartToken metadata also includes programmable constraints defining what types of modifications are permitted when creating derivative works. For instance, the shoe design might specify that derivatives must retain the original sole structure and lacing system while allowing modifications to materials, colorways, and decorative elements.

The StartToken further contains provenance data that maintains verifiable authorship and ownership records of the original creator. This establishes the indisputable origin of the creative work and tracks any ownership transfers that may occur. For the shoe design example, the provenance data would record that “Designer Chris” created the work on Mar. 15, 2025, and holds the original authorship rights. The metadata also includes usage rights specifications that define permitted interactions with the primary original work, such as whether commercial use is allowed, what attribution is required, or whether public display is permitted. The shoe design might specify that derivatives require attribution in the form “Based on ‘FlexStep’ by Designer Chris” and that commercial manufacturing requires licensing beyond the standard royalty payments.

The StartToken includes Primary Royalty(0), which defines the percentage or fixed amount that the original creator receives from any sale of this token or its derivatives. For example, Designer Chris might set Primary Royalty(0) at 8% of the sale price of any token in the derivative chain. The StartToken also contains Spinoff Royalty(0), which would typically be empty or zero for the StartToken since it has no parent from which to inherit spinoff royalty obligations.

Moving up the hierarchy, SpinoffToken1 builds upon the structure of the StartToken. It contains Metadata (0) inherited from the StartToken, ensuring that the original work's parameters are preserved. Additionally, it contains Metadata (1), which represents the new metadata added by the first evolver user. This might include descriptions of modifications made, new constraints added, and additional usage specifications. For example, if Designer Eric creates a performance running variant of Designer Chris's original athletic shoe, Metadata (1) would document the lightweight materials substituted, additional ankle support features, specialized traction pattern for racing surfaces, and cushioning systems optimized for competitive running. The unique identifier for this SpinoffToken1 might be “0x3e5a7b9c2d1f8e4a” on the blockchain.

SpinoffToken1 includes Primary Royalty (1), which specifies the royalty due to the creator of this first derivative work. For example, Designer Eric might set Primary Royalty (1) at 7% of the sale price when this specific running shoe design is sold. SpinoffToken1 also maintains Spinoff Royalty (0) from the original work, ensuring that Designer Chris receives their 8% from all sales in the derivative chain. Additionally, it adds Spinoff Royalty (1), which defines how royalties flow to this token when further derivatives are created based upon it. Designer Eric might set Spinoff Royalty (1) at 5%, meaning they receive this percentage when someone creates a derivative of their running shoe design. This layered royalty structure ensures that both the original creator and the first evolver receive appropriate compensation when their work is built upon or sold.

Further up the hierarchy, SpinoffToken2 demonstrates how the metadata and royalty structure expand with additional derivative layers. It contains Metadata (0) from the StartToken, Metadata (1) from SpinoffToken1, and adds Metadata (2) representing the contributions of the second evolver. For instance, if Designer Sarah creates a trail running version of Eric's performance running shoe, Metadata (2) would document the reinforced toe cap added, water-resistant upper materials incorporated, enhanced grip outsole for off-road terrain, and protective rock plate inserted between the midsole and outsole. This SpinoffToken2 might have the unique identifier “0x9d4c1e6f3a8b2d7c” on the blockchain.

SpinoffToken2 includes Primary Royalty (2) set by Designer Sarah at 6.5% for direct sales of this trail running shoe design. It maintains the royalty obligations to previous contributors through Spinoff Royalty (0) for Designer Chris at 8% and Spinoff Royalty (1) for Designer Eric at 5%. It adds Spinoff Royalty (2), which Designer Sarah sets at 4%, defining royalties due to her when further derivatives are created. This expanding structure allows the system to track and honor all contributions as the creative work evolves through multiple generations.

At the top right of the diagram, the EndToken represents a finalized creative work ready for distribution and sale. It contains the cumulative metadata from all previous tokens: Metadata (0) from the StartToken, Metadata (n−1) from the penultimate derivative, and Metadata (n) added by the final evolver. For example, Designer Tom might create an EndToken representing a final winter trail running shoe with unique identifier “0x2b8e4f6a9c1d3b5e” on the blockchain, adding insulated lining, snow-shedding materials, and reflective elements for low-light visibility. The notation n=(0, 1, 2 . . . n) indicates that an EndToken may be derived from any level of the hierarchy, from the StartToken directly (n=0) to any arbitrary depth of derivatives.

The EndToken maintains the complete royalty structure accumulated through the derivative chain: Primary Royalty(n) for Designer Tom at 6%, Spinoff Royalty (0) for Designer Chris at 8%, Spinoff Royalty(n−1) for Designer Sarah at 4%, and Spinoff Royalty(n) which would typically be zero since an EndToken prohibits further derivatives. This comprehensive royalty structure ensures that when the EndToken is sold, all contributors throughout the derivative chain receive fair compensation based on their specific contributions. For instance, if this final winter trail running shoe design sells for 1000 cryptocurrency units, Designer Chris would receive 80 units, Designer Eric would receive 50 units, Designer Sarah would receive 40 units, and Designer Tom would receive 60 units, with the remaining 770 units going to the seller.

The dotted lines connecting the tokens represent the hierarchical parent-child relationships maintained by the BRRN. These relationships are crucial for the royalty management module 210 to track the complete proneness of each creative work and ensure proper royalty distribution when sales occur. For example, when the winter trail running shoe EndToken is sold, the BRRN would trace these relationships to identify all contributors entitled to royalties and calculate their respective shares based on the stored royalty parameters.

The BRRN receives this hierarchical structure from the blockchain-based distributed ledger, where all token relationships and metadata are permanently recorded. It processes this metadata to generate the multi-branch tree structure representing royalty distribution paths. For instance, when calculating royalties for the sale of the EndToken, the system would follow the dotted lines back through all parent tokens to identify Designer Chris, Designer Eric, Designer Sarah, and Designer Tom as entitled to compensation.

The BRRN records this multi-branch tree structure on the blockchain-based distributed ledger for efficient retrieval, ensuring that the complete royalty distribution framework is transparent and verifiable by all participants. When a transaction occurs, the BRRN utilizes this structure to calculate and distribute royalties to multiple stakeholders at each level of the hierarchy. By representing this complex network of relationships in a structured, hierarchical format as shown in the diagram, the system can efficiently implement royalty calculations while minimizing computational overhead.

The diagram 700 effectively illustrates how the BRRN implements a comprehensive tracking system for creative evolution, where each derivative work builds upon previous contributions while maintaining clear records of authorship, ownership, and compensation rights. This structure enables the system to honor all creative contributions regardless of their position in the derivative chain, fostering a fair and sustainable ecosystem for collaborative creation.

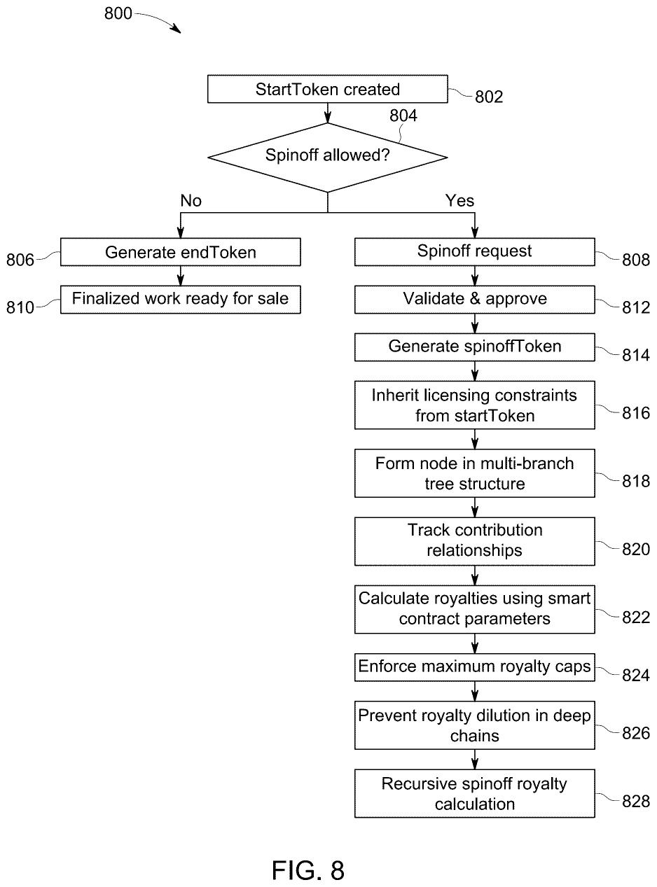

Referring to FIG. 8, a flowchart 800 illustrating the token creation and royalty distribution process implemented by the Branching Recursive Royalty Network (BRRN) is provided, in accordance with an embodiment of the present subject matter. The flowchart 800 depicts the decision points and processing steps that occur from initial token creation through spinoff development and royalty calculation.

At Step 802, a StartToken is created on the blockchain-based distributed ledger. This step represents the outcome of the token generation module 205 generating a StartToken corresponding to a primary original work submitted by a creator user. The StartToken contains comprehensive metadata including a unique identifier on the blockchain-based distributed ledger, metadata defining programmable constraints, provenance data maintaining verifiable authorship and ownership records of the original creator, and usage rights specifications. For example, an industrial designer might create a StartToken for an innovative chair design, with the metadata specifying manufacturing tolerances, material requirements, and structural specifications.

At Step 804, the system evaluates whether spinoffs are allowed based on the first spinoff permission parameter set by the creator user. This decision determines the path forward for the token. If spinoffs are not allowed (No path), the process proceeds to Step 806 where an EndToken is generated. If spinoffs are allowed (Yes path), the process continues to Step 808 to enable derivative works. For instance, the industrial designer might specify that spinoffs are allowed for the chair design, permitting other designers to create variations such as different material applications or specialized versions for particular environments.

At Step 806, the system generates an EndToken on the blockchain-based distributed ledger if spinoffs are not permitted. The EndToken represents a finalized creative work that cannot be further modified through the platform's spinoff mechanism. For example, if the industrial designer decides that their chair design is complete and should not be modified, an EndToken would be generated to represent this finalized design.

At Step 810, the finalized work represented by the EndToken is ready for sale through the marketplace module 209. The EndToken contains all necessary metadata to facilitate transactions, including licensing parameters and royalty specifications. For example, the finalized chair design could be listed for sale to furniture manufacturers who wish to produce the design commercially.

Returning to the spinoff path, at Step 808, the system receives a spinoff request from an evolver user who wishes to create a derivative work based on the StartToken. For example, another designer might request to create an outdoor version of the original chair design, adapting it with weather-resistant materials and structural modifications for outdoor use.

At Step 812, the validation module 208 validates and approves the spinoff request, ensuring that it complies with the constraints and requirements specified in the StartToken metadata. This validation may involve verifying that the proposed modifications respect the core design elements that the original creator designated as immutable, while appropriately building upon elements permitted to be changed. For instance, the system might verify that the outdoor chair adaptation maintains the ergonomic features and weight-bearing specifications of the original design.

At Step 814, upon successful validation, the token generation module 205 generates a SpinoffToken representing the derivative work. The SpinoffToken contains its own unique identifier, additional metadata specific to the modifications made, and a second spinoff permission parameter indicating whether further derivatives are permitted. For example, the SpinoffToken for the outdoor chair would include specifications for the weather-resistant materials, modified structural elements, and any new features added by the evolver.

At Step 816, the SpinoffToken inherits applicable constraints from the set of licensing parameters of the StartToken. This inheritance ensures that the derivative work respects the fundamental limitations and requirements established by the original creator. For instance, if the original chair design specified that all derivatives must maintain certain safety features or structural integrity standards, these constraints would be inherited by the outdoor chair SpinoffToken.

At Step 818, the newly created SpinoffToken forms a node in the multi-branch tree structure maintained by the BRRN. This step integrates the derivative work into the hierarchical network of related creative works, establishing its position in relation to its parent (the StartToken) and potentially to future derivatives. For example, the outdoor chair design becomes a branch in the chair design family tree, connected to the original design and potentially to future adaptations such as a folding outdoor chair or a children's outdoor chair.

At Step 820, the system tracks contribution relationships within the multi-branch tree structure. This tracking ensures that the provenance of each creative element is properly documented, enabling appropriate attribution and compensation for all contributors. For instance, the system would record that the original industrial designer contributed the foundational chair design, while the evolver contributed the weather-resistant adaptations and outdoor-specific features.

At Step 822, the royalty management module 210 calculates royalties using the smart contract parameters defined in the royalty settings of each token. These calculations determine how revenue will be distributed when sales occur, based on the contributions of each participant in the creation chain. For example, when the outdoor chair design sells, the royalty management module might calculate that the original designer should receive 8% of the sale price as principal royalty, while the evolver receives 6% as primary royalty for their specific contribution.

At Step 824, the system enforces maximum royalty caps to prevent excessive fee accumulation as works evolve through multiple generations of derivatives. This enforcement ensures that the total royalty obligations remain sustainable and do not render derivative works economically nonviable. For instance, if the maximum royalty cap is set at 25%, the system would ensure that the combined royalties for all contributors could not exceed this threshold, even in a deep derivative chain.

At Step 826, the system implements measures to prevent royalty dilution in deep derivative chains. This protection ensures that early contributors in a long chain of derivatives still receive meaningful compensation for their fundamental contributions. For example, if the original chair design inspired five generations of derivatives, the system would ensure that the original designer still receives a meaningful royalty rather than having their share diluted to insignificance.

At Step 828, the system performs recursive spinoff royalty calculations through the parent-child relationships in the multi-branch tree structure. These calculations distribute royalties to all contributors based on their position in the hierarchy and the value they added. For instance, if a folding outdoor chair (a third-generation derivative) sells for 1000 cryptocurrency units, the recursive calculation might allocate 80 units to the original designer, 50 units to the outdoor adaptation designer, and 60 units to the folding mechanism designer, with the remaining amount going to the seller.

The flowchart 800 illustrates how the BRRN implements a structured approach to token creation and royalty distribution, ensuring that all creative contributions are properly tracked, valued, and compensated. This systematic process fosters a sustainable ecosystem for collaborative creation by providing clear rules and fair compensation mechanisms for all participants. By implementing sophisticated royalty calculations with appropriate caps and anti-dilution measures, the system balances the interests of original creators with those of innovative evolvers who build upon existing works.

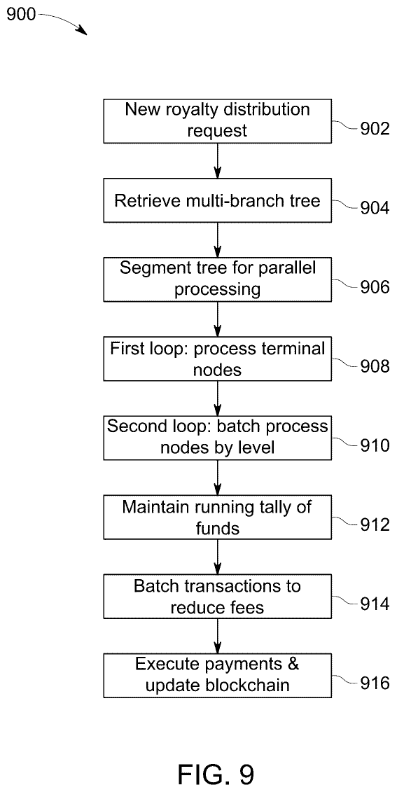

Referring to FIG. 9, a flowchart 900 illustrating the loop-based execution model for optimizing blockchain transaction costs in royalty distribution is provided, in accordance with an embodiment of the present subject matter. The flowchart 900 depicts the sequence of operations performed by the royalty management module 210 when processing royalty distributions through the multi-branch tree structure.

At Step 902, the system receives a new royalty distribution request. This request is triggered when the marketplace module 209 reports a sale event, such as the purchase of a SpinoffToken or EndToken through the smart contract-based marketplace. The request includes transaction data such as the token ID, sale amount, buyer and seller information, and the timestamp of the transaction. For example, when a buyer purchases a specialized outdoor furniture design represented by a SpinoffToken for 2000 cryptocurrency units, the marketplace module 209 would send this transaction data to the royalty management module 210 to initiate the royalty distribution process.

At Step 904, the royalty management module 210 retrieves the multi-branch tree structure from the blockchain-based distributed ledger. This structure contains the complete hierarchy of parent-child relationships for the token involved in the transaction, mapping out all the contributors entitled to royalties. For instance, for the outdoor furniture design, the system might retrieve a tree structure showing that the design evolved from an original indoor furniture design created by Designer A, was first adapted for outdoor use by Designer B, and was then specialized for extreme weather conditions by Designer C, with each contributor having specific royalty parameters defined in their respective tokens.

At Step 906, the system segments the tree for parallel processing to optimize computational efficiency. This segmentation divides the multi-branch tree structure into manageable portions based on depth and breadth metrics, assigning unique identifiers and processing priorities to each segment. For example, the furniture design's royalty tree might be segmented into three parts: the terminal node (Designer C's specialized adaptation), the intermediate node (Designer B's outdoor adaptation), and the root node (Designer A's original design), with each segment prepared for efficient processing.

At Step 908, the system executes the first loop of the loop-based execution model, which processes terminal nodes in the multi-branch tree structure. This loop begins at the endpoint of each branch and works backward toward the root. For the furniture example, the first loop would start by processing Designer C's node, which represents the terminal point in the creation chain. This approach differs from traditional recursive function calls, which can lead to stack overflows and excessive gas consumption on blockchain platforms when processing deep hierarchies.

At Step 910, the system executes the second loop, which batch processes nodes at each level of the tree hierarchy. Instead of processing each node individually and making separate function calls (which would be costly on the blockchain), this loop groups nodes at the same hierarchical level and processes them together. For instance, if there were multiple intermediate adaptations at the same level as Designer B's outdoor furniture design (such as an office variant, a children's variant, etc.), the second loop would process all these nodes together in a single batch operation, significantly reducing computational overhead.

At Step 912, the iterative loops maintain a running tally of remaining funds to be distributed. This running tally keeps track of how much of the sale amount has been allocated and how much remains to be distributed as the system traverses the royalty tree. For the furniture design example, if the sale amount is 2000 cryptocurrency units, the system might first allocate 200 units (10%) to Designer C, then track that 1800 units remain to be distributed to other contributors in the tree.

At Step 914, the system batches transactions to reduce blockchain fees. Rather than executing a separate blockchain transaction for each royalty payment, which would incur multiple transaction fees, the system groups payments into optimized batches. For example, instead of creating three separate transactions to pay Designers A, B, and C, the system might batch these payments into a single multi-recipient transaction, significantly reducing the overall gas costs on the blockchain.

At Step 916, the system executes the payments and updates the blockchain-based distributed ledger. The payment distribution module 211 processes the batched payment transactions, transferring the appropriate royalty amounts to each contributor based on their position in the multi-branch tree structure. The blockchain is then updated with records of these payments, ensuring transparency and immutability of the royalty distribution. For the furniture design example, the final distribution might allocate 200 units (10%) to Designer C for the specialized adaptation, 160 units (8%) to Designer B for the outdoor adaptation, and 140 units (7%) to Designer A for the original design, with the remaining 1500 units going to the seller.

The loop-based execution model illustrated in FIG. 9 represents a significant optimization over traditional recursive approaches to processing hierarchical royalty structures. By using iterative loops instead of recursive function calls, the system prevents smart contract stack overflows that can occur when processing deep hierarchies on blockchain platforms. The batch processing approach minimizes the number of separate blockchain transactions required, substantially reducing gas costs and making the royalty distribution process more economically efficient.

This optimization is particularly valuable in creative ecosystems with complex derivative relationships. For example, in design fields where works commonly evolve through multiple generations of adaptations and improvements, the royalty trees can become quite deep and broad. The loop-based execution model ensures that even in these complex scenarios, royalty distributions remain computationally feasible and economically viable, supporting the sustainable growth of collaborative creation networks on the blockchain.

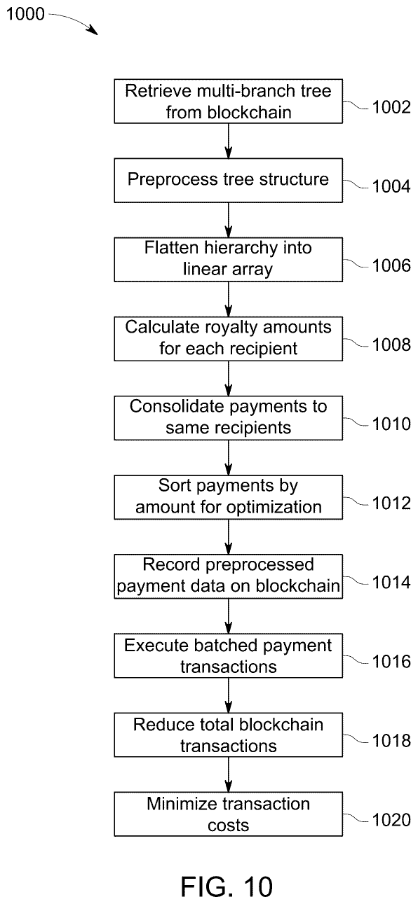

Referring to FIG. 10, a flowchart 1000 illustrating the transaction cost optimization process implemented by the royalty management module is provided, in accordance with an embodiment of the present subject matter. The flowchart 1000 depicts the sequence of operations performed to efficiently process royalty payments while minimizing blockchain transaction costs.

At Step 1002, the royalty management module 210 retrieves the multi-branch tree structure from the blockchain-based distributed ledger. This structure contains the complete hierarchy of parent-child relationships between tokens involved in a transaction, identifying all stakeholders entitled to royalty payments. For example, when a furniture manufacturing company purchases a specialized ergonomic office chair design represented by an EndToken, the system retrieves the entire creation lineage, showing that the design evolved from an original chair concept by Designer A, was adapted for office use by Designer B, enhanced with ergonomic features by Designer C, and finalized with specialized materials by Designer D.

At Step 1004, the system preprocesses the tree structure to optimize subsequent operations. This preprocessing involves analyzing the structure for optimization opportunities, identifying redundancies, and preparing the data for efficient transformation. For the ergonomic chair example, preprocessing might involve identifying that Designer B contributed to multiple nodes in the tree (perhaps creating both the office adaptation and contributing to the ergonomic enhancements), setting the stage for later consolidation of their royalty payments.

At Step 1006, the system flattens the nested hierarchy into a linear array of payment recipients. This transformation converts the complex, multi-level tree structure into a straightforward list of all entities entitled to receive royalties. For instance, the ergonomic chair's royalty tree would be flattened from a multi-level structure into a linear array containing [Designer A, Designer B, Designer C, Designer D], with each entry including their respective contribution types, positions in the original hierarchy, and royalty parameters.

At Step 1008, the system calculates royalty amounts for each recipient based on predetermined percentages and their position in the multi-branch tree structure. These calculations determine the exact payment each contributor will receive from the transaction. For example, if the ergonomic chair design sells for 5000 cryptocurrency units, the calculations might determine that Designer A should receive 400 units (8%) as the original creator, Designer B should receive 350 units (7%) for the office adaptation, Designer C should receive 300 units (6%) for the ergonomic enhancements, and Designer D should receive 250 units (5%) for the material specifications, with the remaining 3700 units going to the seller.

At Step 1010, the system consolidates multiple payments to the same recipient. This consolidation combines separate royalty entitlements for a single contributor into a unified payment, reducing the number of individual transactions needed. For instance, if Designer B contributed to both the office adaptation and the ergonomic enhancements, they might be entitled to multiple royalty streams. Rather than processing these as separate payments, the system would combine them into a single payment of 500 units (350 for the office adaptation plus 150 for the ergonomic contribution).

At Step 1012, the system sorts payments by amount for optimization. This sorting arranges the payments in a sequence that enables efficient transaction batching on the blockchain. For example, the payments might be sorted from largest to smallest: [Designer B (500 units), Designer A (400 units), Designer C (150 units), Designer D (250 units)]. This ordering can be strategically determined based on blockchain-specific optimization parameters that minimize gas costs for the particular blockchain network being used.

At Step 1014, the system records preprocessed payment data on the blockchain-based distributed ledger. This recording serves as a transparent, immutable record of the calculated royalty allocations before execution. For the ergonomic chair example, the system would record on the blockchain that from the 5000 unit sale, Designer A is allocated 400 units, Designer B is allocated 500 units (consolidated from multiple contributions), Designer C is allocated 150 units, and Designer D is allocated 250 units, with appropriate reference data linking these allocations to the original sale transaction.

At Step 1016, the system executes batched payment transactions using the payment distribution module 211. Rather than creating a separate blockchain transaction for each payment, which would incur multiple transaction fees, the system groups payments into optimized batches. For instance, instead of executing four separate transactions to pay Designers A, B, C, and D, the system might batch these into a single multi-recipient transaction, or perhaps two transactions with two recipients each, depending on which approach minimizes overall gas costs on the specific blockchain being used.

At Step 1018, the system reduces the total number of blockchain transactions required for the complete royalty distribution. This reduction is achieved through the preprocessing, consolidation, and batching steps performed earlier. For example, without optimization, the ergonomic chair sale might have required six separate transactions (one to the seller, one each to Designers A, C, and D, and two to Designer B for their different contributions). With the optimization process, this might be reduced to just two transactions: one to the seller and one batched payment to all designers.

At Step 1020, the system minimizes overall transaction costs on the blockchain-based distributed ledger. This minimization is the culmination of all previous optimization steps, resulting in significant gas cost savings. For example, on a blockchain where each transaction costs approximately 0.01 units in gas fees, reducing the number of transactions from six to two would save 0.04 units in transaction costs, a 66% reduction. Over thousands of transactions, these savings become substantial, ensuring the economic viability of the royalty distribution system even for complex creative ecosystems with many contributors.

The transaction cost optimization process illustrated in FIG. 10 addresses one of the key challenges in implementing royalty distribution systems on blockchain platforms: the potentially prohibitive cost of executing numerous small transactions. By intelligently preprocessing payment data, consolidating payments, and executing optimized batched transactions, the system achieves the same end result—fair compensation to all contributors—while significantly reducing the operational costs. This optimization is particularly valuable in creative ecosystems with numerous contributors and frequent transactions, ensuring that transaction costs don't erode the value being distributed to creators.

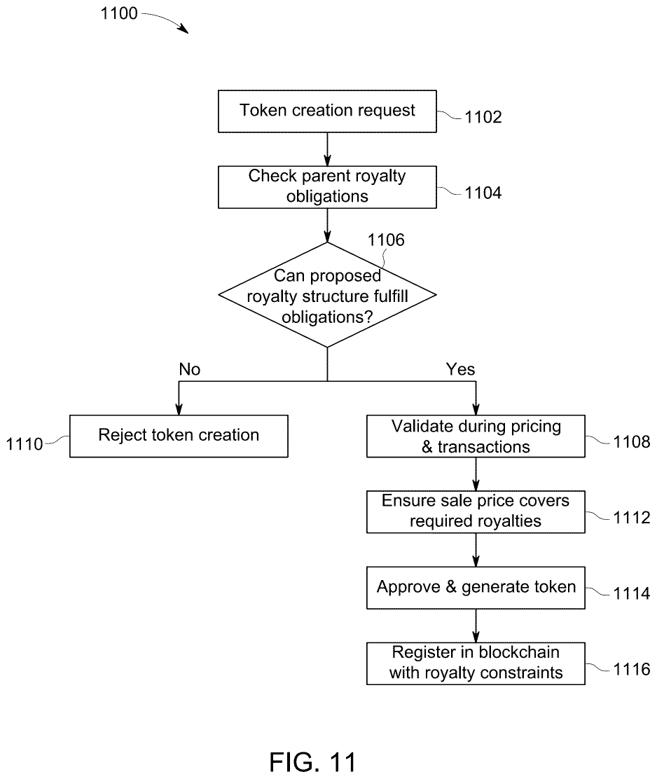

Referring to FIG. 11, a flowchart 1100 illustrating the capped royalty validation mechanism implemented by the royalty management module is provided, in accordance with an embodiment of the present subject matter. The flowchart 1100 depicts the decision-making process that ensures all royalty structures remain economically viable throughout the token lifecycle.

At Step 1102, the system receives a token creation request. This request may come from a creator user seeking to create a StartToken for an original work, or from an evolver user wanting to create a SpinoffToken based on an existing token. For example, a fashion designer might request to create a SpinoffToken for a streetwear adaptation of a formal clothing design, specifying their proposed royalty parameters for this derivative work.

Step 1104, the royalty management module 210 checks parent royalty obligations by receiving royalty allocation data based on the set of royalty parameters from each of the StartToken, the SpinoffToken, and the EndToken in the multi-branch tree structure. This step involves retrieving the royalty parameters from all ancestor tokens in the lineage of the proposed new token. For instance, if the streetwear adaptation is derived from a formal clothing design, which was itself derived from a basic pattern template, the system would retrieve royalty parameters from both the formal clothing design token and the pattern template token.

The system analyzes these royalty parameters, which include:
SP0=Sales Price of this token (the proposed token's intended sale price)
Rp0%=Primary royalty percentage of this token (the percentage the creator of this specific token will receive from direct sales)
Rp0min=Minimum Primary Royalty of this token (the minimum amount the creator will receive regardless of sale price)
Rs0%=Spinoff royalty percentage of this token (the percentage this token's creator will receive from sales of future derivatives)
Rs0min=Minimum Spinoff Royalty of this token (the minimum amount for spinoff royalties)
Rs−1%=Spinoff royalty percentage of inspiration token (the percentage the parent token's creator will receive)
Rs−1min=Minimum Spinoff Royalty of inspiration token (the minimum amount for the parent token's creator)
Rfp=Platform fee royalty percentage (the platform's commission)

At Step 1106, the system evaluates whether the proposed royalty structure can fulfill all parent obligations in the multi-branch tree structure. This critical decision point determines whether the token creation can proceed. The system processes the royalty obligations recursively, ensuring that at every node in the multi-branch tree structure, the greater of the percentage-based royalty or minimum royalty value is used.

For example, if the streetwear adaptation is proposed with a minimum sale price of 500 cryptocurrency units, with a 6% primary royalty (Rp0%=6%) and a minimum royalty of 20 units (Rp0min=20), the system would check whether this structure can accommodate the parent obligations. If the formal clothing design token requires a 5% spinoff royalty (Rs−1%=5%) with a minimum of 30 units (Rs−1min=30), and the platform fee is 2% (Rfp=2%), the validation would check: SP0≥Max(Rp0%*SP0, Rp0min)+Max(Rs−1%*SP0, Rs−1min)+Rfp*SP0 500≥Max(6%*500, 20)+Max(5%*500, 30)+2%*500 500≥Max(30, 20)+Max(25, 30)+10500≥30+30+10500≥70

In this example, the validation passes because the minimum sale price (500) exceeds the required minimum to cover all royalty obligations (70). However, if the parent token had higher royalty requirements, or if there were multiple levels of parent tokens each with their own royalty requirements, the validation might fail.

If the proposed structure cannot fulfill all obligations (No path), the process proceeds to Step 1110, where the token creation is rejected. This rejection prevents the creation of tokens with unsustainable economics that could not fulfill their royalty obligations when sold. The system would notify the requesting user of the specific constraints that caused the rejection, allowing them to reformulate their proposal with more viable parameters.

If the royalty structure can fulfill all obligations (Yes path), the process continues to Step 1108, where the system validates during pricing and transactions. This ongoing validation ensures that as the token enters the marketplace and participates in transactions, all pricing remains viable. For example, if the streetwear design token is listed for sale, the system validates that the listing price is sufficient to cover all royalty obligations.

At Step 1112, the system ensures the sale price covers the required royalties. This step extends the validation to dynamic pricing scenarios such as auctions or offers, where prices might fluctuate. For instance, if a buyer submits an offer of 400 units for the streetwear design, the system will validate whether this price is sufficient to cover all royalty obligations before allowing the offer to be processed.

The system also implements a validation check for minimum spinoff royalty parameters. When setting the minimum spinoff royalty for a new token (Rs0 min), the system verifies that this value is at least equal to the minimum spinoff royalty of the parent token (Rs−1min). This ensures that as derivative works evolve, they cannot reduce the minimum royalty floor below what parent works have established. For example, if the formal clothing design token has set a minimum spinoff royalty of 30 units, the streetwear adaptation cannot set its minimum spinoff royalty below 30 units.

At Step 1114, the system approves and generates the token upon successful validation. This generation creates the requested token with its validated royalty parameters on the blockchain-based distributed ledger. For the streetwear example, the SpinoffToken would be created with the proposed parameters, establishing it as a valid derivative of the formal clothing design with economically sustainable royalty structures.

At Step 1116, the system registers the token in the blockchain with royalty constraints. This registration includes not only the token itself but also the validated royalty parameters and constraints that govern its economic behavior. These constraints become part of the immutable record on the blockchain, ensuring that all future transactions involving this token will respect the established royalty obligations.

The capped royalty validation mechanism illustrated in FIG. 11 ensures the long-term economic viability of the creative ecosystem by preventing several potential issues:
i. It prevents the creation of tokens that could not be sold at realistic prices due to excessive accumulated royalty obligations.
ii. It ensures that all creators in a derivative chain receive fair compensation in line with their established royalty parameters.
iii. It maintains reasonable economics even in deep derivative chains by enforcing validation at each level of token creation.
iv. It provides transparency to all participants about the economic constraints and opportunities associated with each token.

By implementing these validation mechanisms, the system creates a sustainable economic framework that can support complex collaborative creation while ensuring fair compensation to all contributors. This approach strikes a balance between rewarding original creators and making derivative works economically viable, fostering a healthy ecosystem of creative evolution.

In one embodiment, the system 101 may further comprise a royalty simulation module for predictive royalty analysis. The royalty simulation module may be implemented as part of the Other Modules 221 and may provide advanced simulation capabilities to evaluate proposed royalty structures before they are implemented in actual tokens. This proactive analysis helps creators and evolvers make informed decisions about royalty parameters by visualizing potential outcomes under various scenarios.

The royalty simulation module may receive from the collaboration management module 207, a proposed royalty structure for a new SpinoffToken. This proposed structure includes parameters such as percentage-based royalties, minimum royalty values, and other economic terms that would govern the token's behavior in the marketplace. For example, when a furniture designer proposes to create a SpinoffToken for an outdoor adaptation of an existing chair design, they might suggest a royalty structure with a 6.5% principal royalty, 4.5% spinoff royalty, and minimum royalty floors of 25 and 20 cryptocurrency units respectively. The collaboration management module 207 would forward these proposed parameters to the royalty simulation module for analysis.

The royalty simulation module may process the proposed royalty structure through a comprehensive simulation pipeline. The simulation begins by simulating the addition of the new SpinoffToken to the existing multi-branch tree structure. This simulation creates a virtual representation of how the token would fit into the existing hierarchy of creative works, establishing its relationships with parent and potentially future child tokens. For the outdoor chair example, the simulation would place this token as a child of the original chair design and as a potential parent for future derivatives such as specialized outdoor chairs for different environments or use cases.

The royalty simulation module may calculate the royalty distributions for various transaction price scenarios. This calculation explores how royalties would be distributed across the multi-branch tree structure under different sales prices, from minimum viable pricing to premium positioning. For instance, the simulation might analyze distribution outcomes if the outdoor chair design sells at price points of 300, 500, 750, and 1000 cryptocurrency units, showing how the absolute royalty amounts would scale and which stakeholders would benefit under each scenario. This analysis helps creators understand the economic implications of their pricing strategies and how they affect compensation for all contributors.

The royalty simulation module may analyze the impact on transaction costs for multi-branch tree structure depths and branching factors. This analysis examines how the proposed royalty structure would affect blockchain transaction costs when the token is sold or when derivatives of the token are sold. For example, the simulation might reveal that if the outdoor chair design becomes the parent of numerous specialized variants (high branching factor), the gas costs for distributing royalties could become significant due to the number of separate transactions required. Similarly, if the token becomes part of a deep chain of derivatives (high depth), the recursive royalty calculations could potentially approach system limitations.

The royalty simulation module may identify potential bottlenecks or inefficiencies such as excessive transaction costs, deep recursion risks, or unbalanced royalty allocations in the royalty distribution. These potential issues are flagged for creator attention before they manifest in actual marketplace transactions. For the outdoor chair example, the simulation might identify that the combined royalty percentages across all stakeholders are approaching the maximum sustainable level, potentially limiting the economic viability of future derivatives. It might also identify that the proposed minimum royalty floors could make the token unviable at certain lower price points that might be necessary for market entry.

The royalty simulation module may generate a transaction efficiency report and optimization recommendations based on the simulation results. This comprehensive report details the findings of the simulation, highlighting both strengths and potential issues with the proposed royalty structure. The report might include colorized visualizations of royalty flows, comparative analyses against similar successful tokens, and projected economic outcomes under various market scenarios. For the outdoor chair design, the report might show that while the proposed structure works well at higher price points, it could benefit from adjustments to minimum royalty floors to enhance viability across a broader price range.

The royalty simulation module may output the report and recommendations to the creator user and the one or more evolver users for review before finalizing the SpinoffToken creation. This output provides actionable intelligence that helps creators make informed decisions about their royalty structures. The recommendations might include specific parameter adjustments, such as suggesting a reduction in the minimum royalty floor from 25 to 18 cryptocurrency units to enhance market viability at lower price points, or proposing a slightly lower spinoff royalty percentage to better accommodate future derivatives while maintaining fair compensation for the current creator.

By providing this predictive analysis capability, the royalty simulation module helps creators design economically sustainable royalty structures that balance fair compensation with market viability. The module's ability to identify potential issues before they manifest in actual marketplace transactions helps prevent the creation of tokens with problematic economics that could lead to disputes, market rejection, or ecosystem inefficiencies. This proactive approach to royalty structure design contributes to the overall health and sustainability of the creative ecosystem by ensuring that all participants can make fully informed economic decisions.

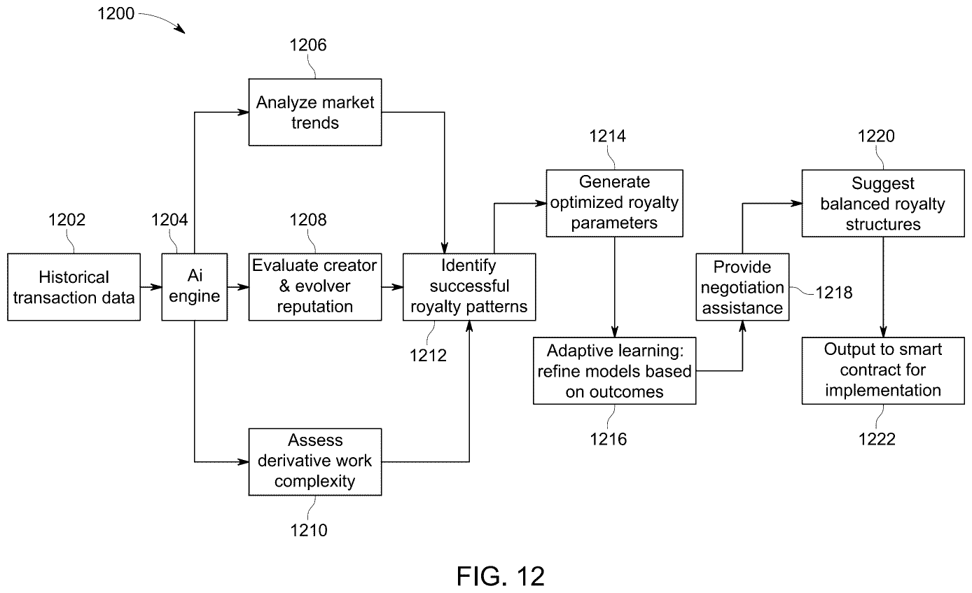

Referring to FIG. 12, a flowchart 1200 illustrating the AI-driven royalty recommendation system is provided, in accordance with an embodiment of the present subject matter. The flowchart 1200 depicts the sequence of processes that the AI-driven royalty recommendation module employs to generate optimal royalty structures for collaborative creative works.

At Step 1202, the system receives historical transaction data from the blockchain-based distributed ledger. This comprehensive dataset provides the foundation for AI-driven analysis, including sales prices, royalty distributions, token popularity, and market performance of various creative works. For example, the system might analyze thousands of previous transactions involving furniture design tokens, examining which royalty structures led to high sales volumes, fair compensation for all contributors, and sustained market interest.

At Step 1204, the AI engine processes the input data using sophisticated machine learning models. These models may include neural networks, random forests, gradient boosting algorithms, or other advanced techniques suited for pattern recognition and predictive analytics. For instance, a deep learning model might identify correlations between specific royalty parameters and market outcomes, while a regression model might quantify the relationship between creator reputation and optimal royalty percentages.

At Step 1206, the system analyzes market trends specific to the creative category of the work being tokenized. This analysis examines factors such as price movements, demand fluctuations, seasonal patterns, and emerging preferences within particular creative domains. For example, in analyzing architectural design tokens, the system might detect that designs with sustainable features are commanding premium prices and supporting higher royalty percentages, while also identifying optimal royalty structures for different architectural styles or applications.

At Step 1208, the system evaluates creator and evolver reputation metrics. These metrics may include factors such as previous sales volume, average price points, buyer feedback, marketplace ranking, and social influence within the creative community. For instance, when a renowned furniture designer with a history of successful high-value sales collaborates with an emerging designer known for innovative material applications, the system would analyze how their respective reputations should influence the royalty distribution to ensure fair compensation aligned with market expectations.

At Step 1210, the system assesses derivative work complexity to determine the value added by each contributor. This assessment may include analyzing the technical sophistication, creative innovation, manufacturing complexity, and market differentiation of the derivative work compared to its parent. For example, if an evolver transforms a basic chair design into a complex ergonomic office chair with advanced adjustability features, material innovations, and enhanced aesthetics, the system would quantify this substantial value addition and recommend appropriate royalty parameters that recognize the significant transformation.

At Step 1212, the system identifies successful royalty patterns by analyzing historical data to determine which royalty structures have demonstrated the best outcomes across multiple dimensions. These patterns are categorized by creative domain, price segment, complexity level, and contributor profiles to provide context-specific recommendations. For furniture designs, the system might determine that successful high-end pieces typically allocate 7-9% to original creators and 5-8% to significant evolvers, while more affordable mass-market pieces operate with tighter royalty structures of 4-6% for originators and 3-5% for evolvers.

At Step 1214, the system generates optimized royalty parameters based on the comprehensive analysis of all input factors. These parameters include percentage-based royalties (Rp0%, Rs0%, etc.) and minimum royalty values (Rp0 min, Rs0 min, etc.) customized for the specific token being created. For example, for a premium ergonomic office chair design evolved from a standard chair template, the system might recommend a 7.5% principal royalty for the evolver, a 6% spinoff royalty for the original template creator, with appropriate minimum royalty floors that ensure fair compensation even at promotional price points.

At Step 1216, the system implements an adaptive learning mechanism that continuously refines its recommendation algorithms based on observed outcomes. This feedback loop analyzes the performance of tokens created with recommended royalty structures, identifies correlations between royalty parameters and market success, and adjusts its models accordingly. For instance, if the system observes that furniture designs with more balanced royalty distributions between original creators and evolvers tend to generate more derivative works and higher overall ecosystem revenue, it would gradually adjust its recommendations to favor such balanced structures.

At Step 1218, the system provides negotiation assistance to participants in the token creation process. This assistance analyzes proposed royalty structures from both creator users and evolver users, identifies potential areas of conflict or misalignment, and facilitates constructive negotiation. For the ergonomic chair example, if the original template creator proposes an 8% spinoff royalty while the evolver believes 5% is fair given their substantial enhancements, the negotiation assistance feature would present data on comparable designs, market norms, and the value added by each party to help bridge the gap.

At Step 1220, the system suggests balanced royalty structures that aim to maximize value for all participants while ensuring economic viability. These suggestions are presented as options rather than mandates, empowering the creators to make informed decisions. For instance, the system might present three different royalty structure options for the ergonomic chair: a standard structure (7% principal/6% spinoff), a higher volume-oriented structure (5% principal/4% spinoff with lower minimum values), and a premium structure (9% principal/7% spinoff with higher minimums), each with projected outcomes under different market scenarios.

At Step 1222, the system outputs the recommendations and negotiation options to the collaboration management module 207 for smart contract implementation. These outputs include the complete set of royalty parameters, supporting data and rationales, and implementation-ready specifications that can be directly incorporated into the smart contract governing the token. For the ergonomic chair example, once the creator and evolver agree on a royalty structure from the provided options, these parameters would be encoded into the smart contract, establishing the immutable royalty distribution framework for all future sales of the design.

The AI-driven royalty recommendation system illustrated in FIG. 12 represents a significant advancement in supporting fair and sustainable creative ecosystems. By leveraging machine learning, market intelligence, and adaptive algorithms, the system helps overcome the inherent difficulties in determining equitable compensation structures for collaborative creative work. This approach reduces friction in creative partnerships, minimizes disputes over value distribution, and promotes more productive collaboration by ensuring that all contributors receive appropriate recognition and compensation for their contributions. The system's ability to continuously learn from market outcomes and adapt its recommendations ensures that it remains relevant as market conditions, creative practices, and user preferences evolve over time.

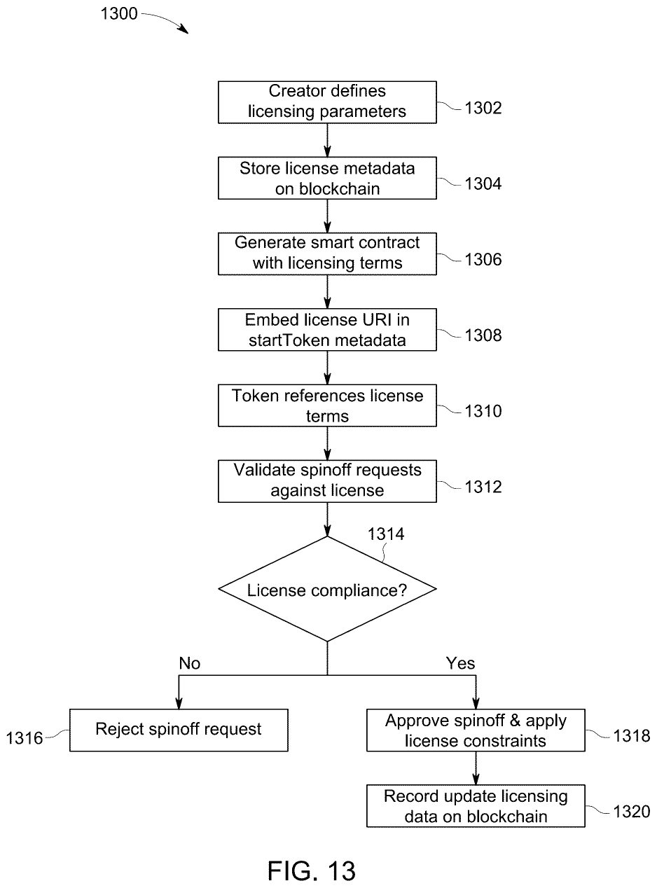

Referring to FIG. 13, a flowchart 1300 illustrating the dynamic licensing system implemented by the licensing module is provided, in accordance with an embodiment of the present subject matter. The flowchart 1300 depicts the sequence of operations involved in creating, storing, and enforcing license terms for creative works on the blockchain-based distributed ledger.

At Step 1302, the creator user defines licensing parameters for the StartToken. These parameters establish the legal and operational framework that governs how the primary original work may be used, modified, and commercialized. For example, an architectural designer creating a StartToken for a residential building design might specify that the design can be used for single-family residential construction only, requires attribution in the form “Original design by [Creator Name],” permits modifications to adapt for local building codes and site conditions, but prohibits changing key structural or aesthetic elements identified in an accompanying specification document. The designer might also specify conditions for derivative works, such as requiring approval for major adaptations or establishing threshold criteria for what constitutes a permissible modification.

At Step 1304, the licensing module 206 stores license metadata on the blockchain-based distributed ledger. This metadata includes structured data fields that capture the essential elements of the licensing parameters in a format that can be efficiently queried and processed by smart contracts. For the architectural design example, this metadata might include fields such as “CommercialUsePermitted: false,” “AttributionRequired: true,” “AttributionFormat: Original design by [Creator Name],” “ModificationsAllowed: true,” and “ApprovalRequired: true for major adaptations as defined in Section 3.2 of the full license.”

At Step 1306, the licensing module 206 generates a smart contract with licensing terms encoded in its logic. This contract implements the permissions, restrictions, and requirements defined by the creator in a machine-executable format. The smart contract includes functions that can be called to verify compliance with various license aspects and trigger appropriate responses when license terms are invoked or potentially violated. For the architectural design, the smart contract might include functions to verify that a proposed spinoff maintains required structural elements, enforce attribution requirements when the design is used, and implement the approval workflow for major adaptations.

At Step 1308, the licensing module 206 embeds a Universal Resource Identifier (URI) in the StartToken metadata. This URI points to the complete license file stored on a decentralized storage network, ensuring that the full legal text of the license remains accessible even if specific platforms or services become unavailable. For example, the URI “ipfs://QmXyZ123 . . . abc” might point to the complete license document for the architectural design stored on the InterPlanetary File System (IPFS), containing all terms, conditions, definitions, and legal provisions in human-readable format.

At Step 1310, the StartToken references the license terms through this embedded URI and associated metadata fields. This referencing establishes the immutable connection between the creative work and its licensing terms, ensuring that all interactions with the token occur within the established legal framework. The token's metadata structure includes explicit references to license attributes, making key terms immediately visible to potential users of the work. For the architectural design, when potential users view the token in a marketplace or other interface, they would immediately see core license attributes such as “Single-family residential use only” and “Modifications permitted with approval for major changes.”

At Step 1312, the validation module 208 validates spinoff requests against the license terms. When an evolver user submits a request to create a derivative work based on the StartToken, the system automatically checks this request against the permissions and restrictions defined in the license. For example, if a landscape architect requests to create a SpinoffToken that adapts the residential design for a sloped terrain and adds extensive outdoor living spaces, the validation module would verify that these modifications fall within the permitted categories defined in the license and that the proper attribution is included.

At Step 1314, the system determines whether the spinoff request complies with the license terms. This decision point evaluates the complete set of licensing constraints against the specific proposal. For the architectural design example, the system would check whether the proposed modifications preserve the required structural and aesthetic elements, whether they remain within the single-family residential use category, and whether they trigger the requirement for creator approval based on the extent of the changes.

If the spinoff request does not comply with the license terms (No path), the process proceeds to Step 1316, where the system rejects the spinoff request. This rejection prevents the creation of derivative works that would violate the original creator's specified terms. The system provides a detailed explanation of which license provisions were not satisfied, allowing the evolver to potentially modify their proposal to bring it into compliance. For example, if the landscape architect's proposal included converting the design to a multi-family dwelling, the rejection would cite the “single-family residential use only” restriction.

If the spinoff request complies with the license terms (Yes path), the process continues to Step 1318, where the system approves the spinoff and applies the license constraints to the new derivative work. This approval enables the creation of the SpinoffToken while ensuring that appropriate restrictions and requirements carry forward. For the architectural example, the landscape architect's SpinoffToken would inherit the attribution requirements, use limitations, and other applicable constraints from the original design's license.

At Step 1320, the system records updated licensing data on the blockchain-based distributed ledger. This recording creates an immutable record of the licensing relationship between the original work and the derivative, establishing the provenance chain that tracks how creative works evolve while maintaining appropriate controls and attributions. For the architectural design example, the blockchain would now contain records showing that the landscape architect's sloped terrain adaptation is a legitimate derivative of the original design, created in compliance with the original license terms, and carrying forward specified obligations such as attribution requirements.

The dynamic licensing system illustrated in FIG. 13 provides several significant advantages over traditional licensing approaches. By encoding license terms in smart contracts and storing them on the blockchain, it creates an unambiguous, tamper-resistant record of the permissions and restrictions associated with creative works. This clarity reduces disputes and simplifies enforcement while providing flexibility for creators to define precisely how their work can be used and evolved. The system automates many aspects of license compliance and verification, reducing administrative burdens and enabling more efficient collaboration. Perhaps most importantly, it ensures that license terms remain permanently associated with creative works as they evolve through multiple generations of derivatives, maintaining appropriate attribution and control while fostering creative innovation.

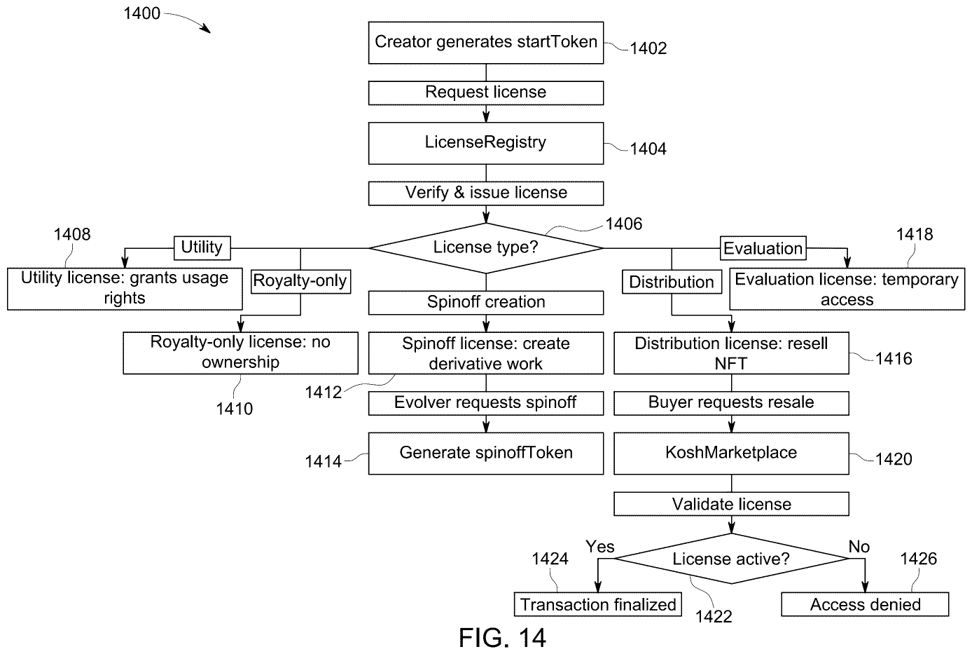

Referring to FIG. 14, a flowchart 1400 illustrating the license type management system implemented by the licensing module is provided, in accordance with an embodiment of the present subject matter. The flowchart 1400 depicts the different types of licenses that can be generated and their respective functions within the decentralized co-creation ecosystem.

At Step 1402, a creator user generates a StartToken representing their primary original work on the blockchain-based distributed ledger. This initial creation establishes the foundation for all subsequent licensing operations. For example, a furniture designer might create a StartToken for an innovative modular sofa design, including detailed 3D models, material specifications, assembly instructions, and visual renderings.

Following the StartToken creation, the system initiates a request for a license to the license registry. This request contains the licensing parameters defined by the creator user, which specify how the primary original work may be used, modified, and commercialized. The furniture designer might specify parameters such as permitted commercial manufacturing subject to quality standards, required attribution in both physical products and marketing materials, and specific allowances for customization and modular adaptation while protecting core design elements.

At Step 1404, the licensing module 206 processes the request through the license registry on the blockchain-based distributed ledger. The license registry serves as the central repository for all licensing information, managing the creation, validation, and enforcement of licenses throughout the ecosystem. The registry processes the licensing parameters provided by the creator, generating machine-readable license terms encoded in smart contract format. For the furniture design, these terms would include specific conditions for manufacturing permissions, detailed attribution requirements, and precise definitions of what modifications are permitted without additional approval.

At Step 1406, the system determines the appropriate license type based on the creator's specifications and the intended use case. This decision point routes the licensing process to one of five distinct license types, each serving a specific function within the ecosystem. The type of license issued determines what rights and restrictions will apply to users interacting with the creative work.

If the license type is “Utility” (leftmost path), the process proceeds to Step 1408, where a Utility License is generated that grants usage rights to the licensee. This license type permits the use of the creative work for specified purposes while maintaining certain restrictions. For the furniture design example, a Utility License might grant a manufacturer the right to produce and sell the modular sofa commercially, subject to meeting specified quality standards, paying agreed royalties, and including proper attribution to the original designer.

If the license type is “Royalty-Only” (second path from left), the process continues to Step 1410, where a Royalty-Only License is created. This specialized license allows the licensee to receive royalty payments without conferring ownership of the underlying creative work. For instance, if the furniture designer transfers royalty rights to an investor or partner, this license would enable that party to receive financial benefits from sales of the design without obtaining control over the design itself or the ability to modify it.

If the license type is “Spinoff Creation” (middle path), the process moves to Step 1412, where a Spinoff License is generated that permits the creation of derivative works. This license specifically enables evolvers to build upon existing creations while establishing the terms for such derivatives. For the furniture design, a Spinoff License might permit an interior designer to create a specialized version of the modular sofa with additional features for outdoor use, while requiring that certain core elements of the original design remain intact and establishing royalty obligations to the original creator.

At Step 1414, an evolver user who has obtained a Spinoff License requests to create a SpinoffToken based on the original work. This request initiates the practical implementation of the derivative work permissions granted by the license. For example, the interior designer might submit a formal request to create an outdoor version of the modular sofa, including preliminary designs showing the proposed weather-resistant materials and structural adaptations.

At Step 1414, upon validation of the spinoff request against the license terms, the system generates a SpinoffToken representing the derivative work. This token is cryptographically linked to the original StartToken, establishing the parent-child relationship that forms the basis for royalty distribution and attribution. The SpinoffToken for the outdoor sofa would include its own metadata and specifications while maintaining the connection to the original design, ensuring that the original creator receives appropriate attribution and compensation when the derivative work is sold.

If the license type is “Distribution” (second path from right), the process proceeds to Step 1416, where a Distribution License is created that specifically enables the resale of the NFT representing the creative work. This license type is particularly important for integrating with external marketplaces and e-commerce platforms. For the furniture design, a Distribution License might permit a specialized furniture marketplace to list and sell tokens representing both the original modular sofa and its derivatives, establishing the terms for such sales including platform fees and royalty distributions.

At Step 1420, a buyer interacts with the marketplace module 209 to request the resale of a token they wish to purchase. This interaction triggers the licensing verification process to ensure that the transaction complies with all established terms. For example, a retail furniture company might request to purchase the rights to produce the outdoor sofa design through the marketplace, initiating verification that this transaction is permitted under the applicable licenses.

At Step 1422, the system validates whether the license required for the transaction is active. This crucial decision point determines whether the proposed transaction can proceed based on the current status of the relevant license. For the furniture design example, the system would verify that the Distribution License permitting the sale is still valid and has not been revoked or expired.

If the license is active (Yes path), the process continues to Step 1424, where the transaction is finalized. This finalization includes updating ownership records on the blockchain, executing royalty distributions according to the established parameters, and transferring any associated rights defined in the license. For the furniture design, this would complete the sale to the retail furniture company, trigger royalty payments to both the original designer and the indoor-to-outdoor adapter, and grant the buyer the rights specified in their purchased license.

If the license is not active (No path), the process moves to Step 1426, where access is denied and the transaction cannot proceed. This enforcement mechanism ensures that license terms are respected throughout the ecosystem. For example, if the Distribution License for the furniture design had been revoked due to quality control issues or a breach of terms, any attempted purchases would be automatically rejected with an appropriate explanation of why the transaction cannot be completed.

If the license type is “Evaluation” (rightmost path), the process proceeds to Step 1418, where an Evaluation License is generated that grants temporary access to the creative work. This license type is specifically designed to support the derivative work creation process by allowing potential evolvers to examine and evaluate the original work before committing to creating a derivative. For the furniture design, an Evaluation License might grant a potential evolver temporary access to the complete design files, including detailed specifications and 3D models, to assess whether and how they might create a valuable derivative work.

The license type management system illustrated in FIG. 14 provides a comprehensive framework for controlling how creative works are used, modified, and commercialized within the decentralized co-creation ecosystem. By offering multiple specialized license types, each with specific functions and protections, the system enables creators to precisely define how their work can be used while ensuring appropriate compensation and attribution. The integration of license verification at critical decision points throughout the workflow ensures that all interactions with creative works respect the terms established by their creators, fostering a balanced ecosystem that protects creator rights while enabling collaborative evolution of creative works.

In one embodiment, the validation module 208 may perform validation comprising at least one of manual validation requiring explicit approval by the creator user through a smart contract interface, or automated validation based on predefined licensing parameters stored in the StartToken metadata. This dual validation approach provides flexibility while maintaining creator control over derivative works.

The manual validation option gives creator users direct control over derivative works based on their creations. When an evolver user submits a spinoff request, the validation module 208 may generate a notification to the creator user through the smart contract interface, allowing them to review the proposed derivative and make an informed decision. For example, if an industrial designer creates a StartToken for an innovative chair design, they might opt for manual validation to personally review each proposed adaptation. When a furniture manufacturer submits a request to create a SpinoffToken for a version with different materials and production techniques, the creator would receive a detailed notification showing the proposed changes and would have the opportunity to approve or reject the spinoff through a simple interface interaction.

The automated validation option streamlines the approval process by evaluating spinoff requests against predefined parameters without requiring direct creator intervention. Creators can establish clear rules during the initial token creation, specifying what types of modifications are automatically permitted and what constraints must be respected. For instance, the industrial designer might set automated validation parameters for their chair design specifying that material substitutions are automatically approved if structural integrity is maintained, while modifications to key aesthetic elements require manual review. When the furniture manufacturer submits their spinoff request, the validation module would automatically evaluate the proposal against these predefined criteria and immediately approve compatible changes while flagging others for manual review.

The licensing module 206 may further support multi-stage approval for derivative works, enabling more complex licensing modifications after initial creation. This capability recognizes that as creative works evolve and markets change, licensing terms may need to adapt while respecting the interests of all contributors. The multi-stage approval process begins when the licensing module 206 receives, from an evolver user of the one or more evolver users, a request to modify an existing license for a specific use case. For example, a furniture manufacturer who created a SpinoffToken for a specialized outdoor version of the chair might request a license modification to permit sublicensing to regional manufacturers rather than requiring direct production.

The licensing module 206 processes the request by analyzing the proposed modifications against the original license terms. This analysis involves a comprehensive comparison of the existing license with the requested changes, identifying all substantive modifications and evaluating their implications. For the furniture example, the system would analyze how the proposed sublicensing permission differs from the original direct manufacturing requirement, considering factors such as quality control, attribution, and revenue implications.

The licensing module 206 identifies all stakeholders in the multi-branch tree structure affected by the license change. This identification ensures that everyone with a legitimate interest in the licensing terms has an opportunity to participate in the decision. For the chair design, affected stakeholders might include the original designer, the evolver who created the outdoor adaptation, and potentially other evolvers who have created derivatives based on either the original design or the outdoor adaptation.

The licensing module 206 generates a ballot for decentralized approval voting. This ballot presents the proposed changes in clear, accessible language, providing sufficient detail for stakeholders to make informed decisions while highlighting key modifications. The ballot for the furniture example might include specific language about the proposed sublicensing permission, explanations of how quality control would be maintained, assurances regarding attribution requirements, and details about royalty calculations for sublicensed productions.

The licensing module 206 determines the required approval threshold based on the significance of the proposed modifications. More substantial changes that could significantly impact stakeholders' rights or compensation require higher approval thresholds. For the furniture design, a change to permit sublicensing might be deemed moderately significant, requiring approval from two-thirds of stakeholders weighted by their position in the derivative chain, with the original creator having the largest voting weight.

The licensing module 206 distributes the ballot to all affected stakeholders through the collaboration management module 207 for voting. This distribution ensures that every stakeholder has an opportunity to review the proposed changes and register their approval or disapproval. The collaboration management module 207 might notify stakeholders through their registered communication channels, provide a secure voting interface, and track voting progress throughout the approval period.

The licensing module 206 updates the license in the license registry on the blockchain-based distributed ledger only upon receiving the required threshold of stakeholder approvals. This final step ensures that license modifications occur only when there is sufficient consensus among affected parties. For the furniture design, if the two-thirds approval threshold is reached, the license would be updated to include the sublicensing permission, with this change permanently recorded on the blockchain. The updated license would then govern all future transactions and derivative works, ensuring that regional manufacturers could legally produce the design under specified conditions while maintaining appropriate royalty flows to all contributors.

By implementing both flexible validation options and a robust multi-stage approval process, the system balances creator control with efficient operations and collaborative decision-making. This approach ensures that licensing terms can adapt to changing needs and opportunities while protecting the interests of all stakeholders in the creative ecosystem. The immutable recording of approvals and license modifications on the blockchain provides transparency and accountability throughout the process, fostering trust among participants even as complex licensing relationships evolve over time.

In one embodiment, the system 101 may further comprise a royalty stream management module for enabling transferable royalty rights. The royalty stream management module may provide a sophisticated mechanism for managing the economic rights associated with creative works, enabling creators and token owners to monetize future royalty streams. This module represents a significant innovation in the tokenization of creative assets by separating ownership of royalty rights from ownership of the underlying creative work.

The royalty stream management module may automatically process the transfer of associated rights and royalty streams upon a transaction event involving the StartToken, SpinoffToken, or EndToken. When a token changes ownership, the module initiates a comprehensive workflow to ensure proper transfer of economic rights while preserving appropriate creator protections. For example, when a furniture manufacturing company purchases a token representing an ergonomic chair design from its current owner, the royalty stream management module would automatically process the transfer of specific royalty entitlements to the new owner while maintaining other rights with the original creator.

The royalty stream management module may verify the transaction on the blockchain-based distributed ledger, ensuring the legitimacy and finality of the ownership transfer. The module may calculate the expected value of future royalty distributions based on historical transaction data and market projections, providing an economic framework for valuing royalty streams. For instance, for the ergonomic chair design, the module might analyze past sales data, current market trends, and growth projections to estimate that the design could generate approximately 5,000 cryptocurrency units in royalties over the next three years, providing critical information for pricing the token appropriately.

The royalty stream management module may record the buyer as the new owner in the token metadata while preserving the creator user's ownership of the underlying primary original work and perpetual royalty rights. This dual ownership structure is fundamental to the system's approach to creative works, distinguishing between ownership of the token (which confers certain economic rights) and authorship of the underlying work (which confers other inalienable rights). For the chair design example, the furniture manufacturing company would be recorded as the new token owner with rights to commercialize the design and receive certain royalties, while the original designer maintains authorship rights and continues to receive principal royalties from all future sales.

The royalty stream management module may maintain structured royalty distributions where the creator user continues receiving principal royalties from all transaction events involving the token, and the current owner inherits spinoff royalties from derivative works. This structured approach ensures that original creators maintain a permanent economic connection to their work while token owners can still benefit from derivatives and adaptations. For example, if another designer creates a specialized gaming version of the ergonomic chair as a SpinoffToken, the original designer would receive their established principal royalty percentage from sales of this derivative, while the furniture manufacturing company that now owns the original token would receive the spinoff royalties that were previously flowing to the former token owner.

The royalty stream management module may update the token metadata on the blockchain-based distributed ledger to reflect the ownership change while ensuring the integrity of the multi-branch tree structure. This update maintains the complete historical record of ownership and royalty relationships while accurately reflecting current entitlements. For the chair design, the blockchain record would show the original designer as the creator, the previous owner's period of ownership, and the furniture manufacturing company as the current owner, with all royalty parameters and relationships preserved throughout these transitions.

The royalty stream management module may ensure that royalty distributions and rights follow the token transfer, automatically recording new entitlements without requiring separate manual approvals. When the token ownership changes, the smart contracts governing royalty distributions automatically redirect appropriate royalty streams to the new owner without requiring additional confirmation steps. For the furniture company purchasing the chair design token, this means they would immediately begin receiving spinoff royalties from any existing derivative works as soon as the transaction is confirmed on the blockchain.

The royalty stream management module may output confirmation of the ownership transfer transaction to the buyer and seller, and provide confirmation to the royalty holder. This confirmation includes detailed information about the transferred rights, ongoing obligations, and expected royalty flows. The furniture manufacturing company would receive confirmation specifying exactly which rights they have acquired (commercialization, spinoff royalties, etc.), while the original designer would receive confirmation that their principal royalty rights remain intact despite the ownership change.

The royalty stream management module enables the royalty holder to transfer, sell, or collateralize future royalty earnings while maintaining the original creator user's ownership of the underlying primary original work. This capability creates new financial opportunities for both creators and token owners. For example, the furniture manufacturing company that purchased the chair design token might later decide to collateralize the expected future spinoff royalties to secure financing for a new production facility, using the projected royalty stream as security for the loan while retaining ownership of the token itself.

In one embodiment, the token generation module 205 may support multiple types of token creation, providing flexibility to represent different creative scenarios and ownership structures. This multi-token approach allows the system to accommodate various stages in the creative lifecycle, from original works to finalized products.

The token generation module 205 may receive, from the creator user, a request to create a specific type of token along with the corresponding creative work. This request includes both the digital representation of the creative work and metadata indicating which token type is desired. For example, an automotive designer might submit a revolutionary new vehicle concept with a request to create a StartToken that will allow other designers to create specialized variants for different market segments.

The token generation module 205 may process the request based on the specified token type, applying different validation and configuration processes depending on the token category. For a StartToken, the token generation module 205 verifies original authorship and establishes root permissions in the multi-branch tree structure. This verification might include originality checks, creator identification verification, and establishment of fundamental parameters governing how the work can be used and modified. For the automotive design example, the system would verify that the design represents original work by the submitting designer, establish this designer as the root node in the royalty tree, and encode the designer's specified permissions regarding what aspects of the vehicle can be modified in derivative works.

For a SpinoffToken, the token generation module 205 validates the parent-child relationship and inherits applicable constraints from the set of licensing parameters. This validation ensures that the derivative work properly acknowledges its foundation while respecting the limitations established by the original creator. For instance, if an automotive engineer later submitted a request to create a SpinoffToken for an electric variant of the original vehicle design, the system would verify that this adaptation maintains the required core design elements specified by the original designer while properly establishing the parent-child relationship for royalty and attribution purposes.

For a SpinoffToken with no derivative capabilities, the token generation module 205 creates a derivative work that disallows further Spinoffs while maintaining the parent-child relationship in the multi-branch tree structure. This option allows evolvers to create adaptations that are considered final from a derivative perspective. If a manufacturing engineer created a production-ready version of the electric vehicle variant, they might specify no further derivatives, creating a SpinoffToken that serves as an endpoint in that particular branch of the creative tree.

For an EndToken, the token generation module 205 creates an exclusive token with no derivative capabilities. This token type represents a finalized creative work ready for distribution and sale, with no provision for further modification through the platform's spinoff mechanism. A vehicle manufacturer might request an EndToken for a final production version of the vehicle design, indicating that this specific version is complete and not subject to further platform-based derivatives.

The token generation module 205 may generate the requested token type with appropriate metadata and smart contract properties specific to its function. Each token type has distinct properties encoded in both its metadata and the associated smart contract logic. The StartToken for the vehicle design would include metadata identifying it as an original work with specific derivative permissions, while the SpinoffToken for the electric variant would include metadata establishing its relationship to the original design and any additional constraints added by the adapter.

The token generation module 205 may register the newly created token in the multi-branch tree structure with the appropriate hierarchical position, thereby establishing its role in future royalty distributions. This registration places the token in the correct position within the creative lineage, ensuring proper attribution and compensation flows. The automotive design tokens would be registered in a hierarchical structure showing the original concept at the root, the electric variant as a child of the original concept, the production-ready adaptation as a child of the electric variant, and the final production version appropriately positioned in this lineage, with royalty distribution pathways defined according to this hierarchy.

In one embodiment, the SpinoffToken creation may include a parent validation process that ensures all derivative works properly respect the constraints and requirements established by their parent works. This validation process is essential for maintaining the integrity of creative lineages and ensuring that original creators' wishes regarding derivatives are respected.

The parent validation process may receive from an evolver user of the one or more evolver users, a SpinoffToken creation request referencing a specific parent token. This request includes details about the proposed derivative work and explicitly identifies which existing token will serve as its foundation. For example, a fashion designer might submit a request to create a children's version of an existing adult clothing design, specifying the token ID of the original design as the parent token.

The parent validation process may retrieve, from the blockchain-based distributed ledger, the metadata and constraints of the parent token. This retrieval provides the complete set of parameters that will govern what modifications are permitted and what obligations must be carried forward to the derivative work. For the clothing design example, the system would retrieve the original designer's specifications about which elements must be preserved (perhaps the signature collar design and pocket configuration), which elements can be modified (perhaps materials and proportions), and what attribution and royalty requirements apply.

The parent validation process may process the request through a validation workflow that verifies compliance with the parent token's derivative work restrictions. This verification ensures that the proposed derivative respects all limitations established by the original creator. The system would check that the children's clothing adaptation maintains the required signature elements while only modifying aspects that are permitted to be changed.

The parent validation process may confirm that the evolver user holds a valid evaluation license for the parent token. This confirmation ensures that the evolver has legitimate access to the detailed information needed to create a proper derivative work. For the clothing example, the system would verify that the fashion designer has been granted an evaluation license by the original designer, giving them appropriate access to detailed pattern files, material specifications, and construction techniques.

The parent validation process may check that proposed royalty distributions satisfy maximum royalty caps. This check ensures that the economic structure of the derivative work remains viable and complies with system parameters. If the children's clothing designer proposes royalty parameters that, when combined with the original designer's entitlements, would exceed the maximum allowable royalty percentage, the validation would flag this issue for resolution before proceeding.

The parent validation process may validate that required approvals have been obtained from the creator user of the parent token. If the parent token specifies that derivatives require explicit approval, the system verifies that this approval has been granted before allowing the SpinoffToken creation to proceed. For example, if the original clothing designer requires manual approval of all derivatives, the system would confirm that they have reviewed and approved the children's clothing adaptation.

The parent validation process may generate a validation report detailing compliance or identifying specific violations. This report provides clear feedback to the evolver, highlighting any issues that must be addressed before the derivative work can be tokenized. The report for the children's clothing might confirm compliance with material modification rules and attribution requirements while flagging an issue with the proposed royalty structure exceeding caps, allowing the evolver to adjust this parameter before resubmitting.

The parent validation process may proceed with SpinoffToken creation only upon successful validation, ensuring all parent-imposed constraints are respected in the at least one derivative work. Only when all validation checks have passed is the new SpinoffToken minted on the blockchain. Once the children's clothing designer resolves any identified issues, the SpinoffToken representing their adaptation would be created, properly linked to the parent token, with all required constraints and obligations intact.

This comprehensive parent validation process ensures that derivative works remain faithful to original creators' intentions while enabling creative evolution within established parameters. By enforcing these validations at the token creation stage, the system maintains the integrity of creative lineages and provides confidence to all participants that their rights and requirements will be respected throughout the creative ecosystem.

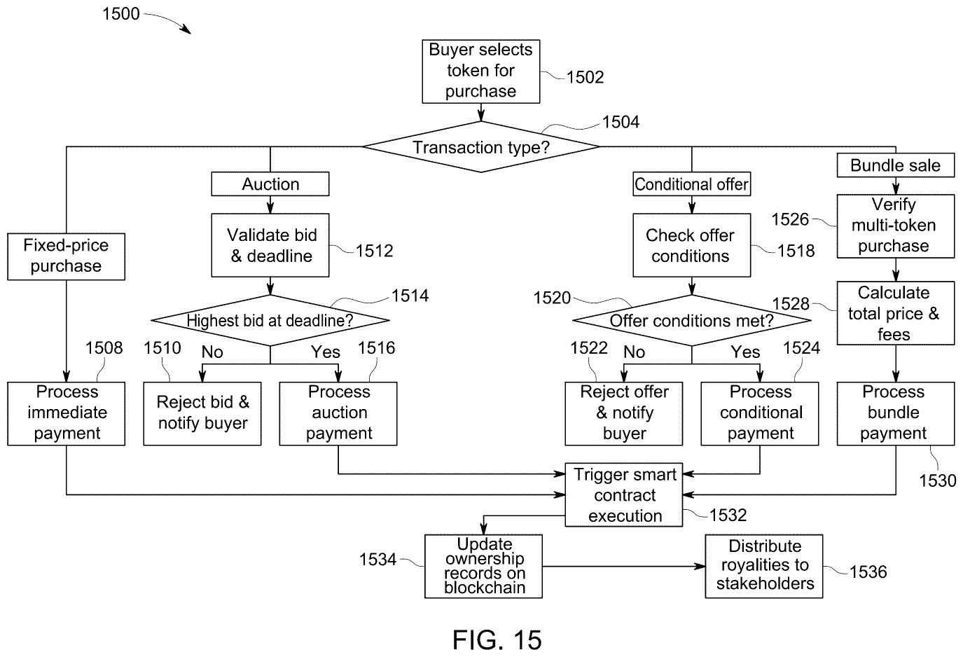

Referring to FIG. 15, a flowchart 1500 illustrating the marketplace transaction processing system is provided, in accordance with an embodiment of the present subject matter. The flowchart 1500 depicts the different transaction types supported by the marketplace module and the processing paths for each type.

At Step 1502, a buyer selects a token for purchase through the marketplace interface. This selection initiates the transaction process, connecting a potential buyer with a listed creative work. For example, an interior design firm might select a token representing an innovative furniture design that they wish to acquire for a client project. The buyer would review the token's details, including images, specifications, licensing terms, and pricing information, before deciding to proceed with the purchase.

At Step 1504, the system determines the transaction type based on how the token is listed in the marketplace. This decision point routes the transaction through one of four different processing paths, each optimized for a specific transaction model. The marketplace module 209 supports multiple transaction types to accommodate different seller preferences and market dynamics. For the furniture design, the token might be listed as a fixed-price item, be available for auction, accept conditional offers, or be part of a bundle of coordinated pieces.

If the transaction type is “Fixed-Price Purchase” (leftmost path), the process proceeds directly to Step 1508, where the system processes an immediate payment. This straightforward transaction type executes at the listed price without negotiation or competitive bidding. For instance, if the furniture design is listed at a fixed price of 500 cryptocurrency units, the interior design firm would submit payment for this exact amount, and the transaction would proceed immediately upon payment verification.

If the transaction type is “Auction” (second path from left), the process continues to Step 1512, where the system validates the bid and deadline. Auctions involve competitive bidding over a specified time period, with the token ultimately selling to the highest bidder when the auction concludes. For example, if the furniture design is listed as an auction item with a minimum bid of 300 cryptocurrency units and a seven-day auction period, the system would verify that each incoming bid exceeds both the minimum bid and the current highest bid, while tracking the auction deadline.

At Step 1514, when the auction deadline arrives, the system determines whether the current bid is the highest at the deadline. This critical decision point identifies the winning bidder based on auction rules. If the interior design firm placed a bid of 550 cryptocurrency units and no higher bids were received before the deadline, their bid would be evaluated as the winner.

If the bid is not the highest at the deadline (No path), the process moves to Step 1510, where the system rejects the bid and notifies the buyer. This notification informs non-winning bidders that their bids were unsuccessful. The interior design firm would receive a notification that their bid was not successful if another buyer had placed a higher bid before the deadline.

If the bid is the highest at the deadline (Yes path), the process continues to Step 1516, where the system processes the auction payment. This step finalizes the transaction with the winning bidder at their bid price. If the interior design firm's bid of 550 cryptocurrency units was the highest when the auction closed, the system would process their payment and proceed with the token transfer.

If the transaction type is “Conditional Offer” (third path from left), the process proceeds to Step 1518, where the system checks the offer conditions. Conditional offers allow buyers to propose purchases subject to specific terms or contingencies that must be satisfied before the transaction completes. For example, the interior design firm might submit an offer of 480 cryptocurrency units for the furniture design, conditional upon receiving manufacturing specifications within three days and with an offer expiration date of one week.

At Step 1520, the system determines whether the offer conditions have been met. This evaluation checks all specified conditions against current status. For the conditional offer example, the system would verify whether the seller had provided the required manufacturing specifications within the three-day window.

If the offer conditions are not met (No path), the process moves to Step 1522, where the system rejects the offer and notifies the buyer. This rejection occurs either when specified conditions fail or when the offer expires without acceptance. If the seller failed to provide the manufacturing specifications within three days, or if the seller did not accept the offer within the one-week validity period, the interior design firm would be notified that their conditional offer was unsuccessful.

If the offer conditions are met (Yes path), the process continues to Step 1524, where the system processes the conditional payment. This processing occurs only after all conditions have been satisfied. If the seller provided the required specifications and accepted the offer within the specified timeframes, the system would process the interior design firm's payment of 480 cryptocurrency units and proceed with the token transfer.

If the transaction type is “Bundle Sale” (rightmost path), the process proceeds to Step 1526, where the system verifies the multi-token purchase. Bundle sales allow buyers to purchase multiple related tokens as a single transaction, often with special pricing or conditions. For instance, the furniture designer might offer a bundle containing tokens for a complete living room set, including sofa, chairs, coffee table, and side tables, designed to work together aesthetically.

At Step 1528, the system calculates the total price and fees for the bundle. This calculation might include bundle discounts or special terms that apply when tokens are purchased together. For the furniture bundle example, the system might calculate a total price of 1,200 cryptocurrency units for the complete set, representing a 20% discount compared to purchasing each piece individually, along with appropriate platform fees.

At Step 1530, the system processes the bundle payment. This processing handles the financial transaction for all tokens in the bundle simultaneously. For the furniture bundle, the interior design firm's payment of 1,200 cryptocurrency units would be processed as a single transaction despite involving multiple tokens.

Regardless of which transaction path is followed, all successful transactions converge at Step 1532, where the system triggers smart contract execution. The smart contract contains the complete logic for the token transfer, including ownership change, royalty distributions, and any specific terms associated with the transaction type. The smart contract for the furniture design purchase would include provisions for transferring ownership to the interior design firm while ensuring that royalties flow to the original designer and any other contributors according to the established parameters.

At Step 1534, the system updates ownership records on the blockchain. This update creates an immutable record of the new ownership state, maintaining the complete provenance history of the token. The blockchain record would now show the interior design firm as the current owner of the furniture design token, while preserving the history of previous ownership and creation information.

At Step 1536, the system distributes royalties to stakeholders according to the multi-branch tree structure. This distribution ensures that all contributors receive appropriate compensation based on their position in the creation hierarchy. For the furniture design example, if the original designer established an 8% principal royalty, they would receive 40 cryptocurrency units from the 500-unit sale. If the design was an adaptation of an earlier work, the creator of that foundation might receive a 5% spinoff royalty amounting to 25 units. These distributions would be executed automatically according to the royalty parameters encoded in the token's smart contract.

The marketplace transaction processing system illustrated in FIG. 15 demonstrates the flexibility and comprehensiveness of the marketplace module 209. By supporting multiple transaction types, each with specific workflows and validations, the system accommodates diverse trading preferences and use cases. The convergence of all transaction paths into a standardized smart contract execution, ownership update, and royalty distribution process ensures consistency and reliability regardless of how a token is purchased. This approach maximizes market liquidity by giving sellers flexible listing options while maintaining the integrity of ownership records and ensuring fair compensation to all contributors in the creative ecosystem.

The marketplace module 209 implements a decentralized marketplace that receives listings including pricing information, quantity available, and sale conditions. When a creator or token owner wishes to sell their token, they submit a comprehensive listing that specifies not only the price but also any relevant terms. For example, a furniture designer might list their innovative chair design token with a fixed price of 500 cryptocurrency units, a quantity of 1 (as it's a unique token), and conditions specifying that the buyer receives manufacturing rights subject to specific quality standards and attribution requirements.

The marketplace module 209 processes the listings by validating ownership of the listed StartToken, SpinoffToken, or EndToken on the blockchain-based distributed ledger. This validation ensures that only legitimate token owners can create listings, preventing fraudulent sales. For the furniture design example, the system would verify that the current listing creator is indeed the recorded owner of the token on the blockchain before proceeding with the listing creation.

The marketplace module 209 verifies compliance with the set of licensing parameters associated with the token. This verification ensures that the proposed sale adheres to any restrictions or requirements established by the original creator or previous contributors. For instance, if the furniture design's license specifies that it can only be sold to professional manufacturers with verifiable production capabilities, the marketplace module would verify that these restrictions are properly reflected in the listing terms.

The marketplace module 209 calculates platform fees and royalty distributions that will apply when the token is sold. These calculations provide transparency to both sellers and buyers regarding the economics of the transaction. For the 500-unit furniture design listing, the system might calculate that an 8% principal royalty (40 units) will go to the original designer, a 5% spinoff royalty (25 units) will go to the creator of an underlying design component, and a 2% platform fee (10 units) will be charged, leaving 425 units for the seller.

The marketplace module 209 generates smart contracts that govern the transaction events. These contracts encode all terms, conditions, and financial flows in executable blockchain code. The smart contract for the furniture design would include functions to verify buyer eligibility, transfer ownership, distribute royalties according to the established percentages, and enforce any post-sale conditions specified in the listing.

The marketplace module 209 publishes the validated listings to a marketplace interface where potential buyers can discover and evaluate available tokens. This interface typically includes visual representations, descriptions, historical data, licensing information, and pricing details. The furniture design listing might appear in the marketplace with high-quality renderings, detailed specifications, licensing terms, pricing information, and transaction options (such as “Buy Now” or “Make Offer”).

The marketplace module 209 executes transaction events when a buyer submits a purchase request. This execution activates the smart contract, initiating the ownership transfer process and financial settlements. When an interior design firm decides to purchase the furniture design token at the listed price of 500 units, their purchase submission would trigger the execution of all associated smart contract functions.

The transaction execution triggers automatic royalty distribution through the royalty management module 210 according to the multi-branch tree structure. This distribution ensures that all contributors in the creation hierarchy receive their appropriate share without requiring manual intervention. For the furniture design, the original designer would automatically receive their 40-unit royalty, the contributor of an underlying component would receive their 25-unit royalty, and the platform would receive its 10-unit fee, with these distributions occurring simultaneously with the ownership transfer to the buyer.

The marketplace module 209 further supports multiple transaction types to accommodate diverse trading preferences and market dynamics. The module receives different types of transaction requests from marketplace participants, including fixed-price purchases, time-limited auction listings, conditional offers with expiration dates, and bundle sales of multiple related tokens. For example, a creator with a collection of coordinated furniture designs might choose to list individual pieces at fixed prices, offer the complete set as a discounted bundle, run an auction for a limited-edition piece, and accept conditional offers on pieces still in development.

The marketplace module 209 processes each transaction type using specialized smart contract logic that enforces the specific rules and conditions of the transaction type. Each transaction model has unique requirements and workflows that must be properly implemented to ensure fair and predictable outcomes. For a time-limited auction of a special furniture design, the smart contract would manage the bidding process, enforce minimum bid increments, track the auction deadline, and automatically determine the winning bidder when the auction concludes.

The marketplace module 209 manages bid validation for auctions, ensuring that bids meet minimum requirements and are properly recorded. For a furniture design auction with a reserve price of 300 units and minimum increments of 20 units, the system would validate that each new bid exceeds both the reserve price and the current highest bid by at least the minimum increment, rejecting any bids that fail to meet these criteria.

The marketplace module 209 handles expiration of time-sensitive offers, automatically processing or canceling transactions based on temporal conditions. For a conditional offer on a furniture design that expires in 72 hours, the system would track this deadline and automatically cancel the offer if it remains unaccepted when the deadline passes, notifying both the potential buyer and the seller of this outcome.

The marketplace module 209 coordinates bundle transfers when multiple tokens are involved, ensuring atomic execution where either all token transfers succeed or none do. For a furniture collection bundle including four different design tokens, the system would ensure that the buyer receives all four tokens or none, preventing partial transfers that could result in incomplete sets.

The marketplace module 209 executes the transactions upon fulfillment of all required conditions. Only when all prerequisites have been satisfied does the ownership transfer and financial settlement occur. For a conditional offer on a furniture design contingent upon the seller providing additional technical specifications, the transaction would execute only after verification that these specifications had been delivered as required.

The marketplace module 209 updates ownership records on the blockchain-based distributed ledger while triggering appropriate royalty distribution events. These updates create a permanent, immutable record of the transaction and ensure proper compensation to all stakeholders. When the furniture design token transfers to its new owner, the blockchain record is updated to reflect this change, while simultaneously distributing royalties to the original designer, any contributors to underlying components, and other entitled parties according to the established royalty structure.

By supporting this comprehensive range of transaction types and implementing sophisticated processing logic for each, the marketplace module 209 creates a flexible, efficient trading environment that accommodates diverse user needs while maintaining the integrity of ownership records and ensuring fair compensation throughout the creative ecosystem.

In one embodiment, the system 101 may further comprise an external platform integration module that extends the reach of the decentralized co-creation ecosystem beyond the native marketplace. This module enables seamless integration with third-party e-commerce platforms, expanding distribution channels while maintaining proper royalty attribution and payments.

The external platform integration module may receive distribution requests from third-party entities wishing to sell tokens by integrating with external e-commerce platforms. These requests represent opportunities to extend the reach of tokenized creative works to established marketplaces with existing customer bases. For example, a specialized furniture retailer might submit a distribution request to sell a collection of designer chair tokens on their established e-commerce platform where they already have a loyal customer base interested in high-end furniture designs.

The external platform integration module may process the distribution requests by validating the identity and security credentials of the requesting distributor. This validation ensures that only legitimate, authorized businesses can participate in the external distribution network. For the furniture retailer example, the system would verify the company's business registration, digital identity, and security protocols to confirm they meet the platform's requirements for external distributors.

The external platform integration module may generate API keys for secure communication between the blockchain-based system and the external platform. These keys enable authenticated, encrypted data exchange while protecting sensitive information. The furniture retailer would receive a unique set of API credentials that allow their e-commerce system to securely communicate with the blockchain platform, querying token data and reporting sales transactions.

The external platform integration module may establish webhook endpoints for event notifications, creating real-time communication channels for important updates and status changes. These webhooks allow the external platform to receive instant notifications about relevant events. The furniture retailer's system might be configured with webhooks that notify them immediately when new designer chair tokens become available, when licensing terms change, or when token ownership transfers occur.

The external platform integration module may configure royalty enforcement mechanisms for external sales to ensure that all transactions properly compensate creators regardless of where sales occur. These mechanisms extend the platform's royalty infrastructure to external marketplaces. For the furniture design tokens sold on the retailer's site, the system would establish protocols ensuring that when a customer purchases a design through their platform, appropriate royalties are automatically calculated and distributed to the original designer and any contributors.

The external platform integration module may create a secure bridge between the blockchain-based distributed ledger and the external platform using cryptographic verification. This bridge ensures the integrity and authenticity of cross-platform transactions through cryptographic proofs. When the furniture retailer's platform reports a sale of a chair design token, the secure bridge would verify the transaction using cryptographic signatures, confirming that the reported sale matches the actual transaction before triggering royalty distributions.

The external platform integration module may monitor external transaction events to ensure that all royalty obligations are properly fulfilled. This monitoring provides oversight of external sales activities to prevent royalty avoidance. For example, if the furniture retailer sells multiple chair design tokens, the monitoring system would track these sales, verify that appropriate royalties are being calculated, and confirm that payments are being correctly distributed to all entitled parties in the royalty chain.

The external platform integration module may trigger the royalty distribution system when sales occur on connected platforms, ensuring consistent compensation regardless of the sales channel. This triggering extends the platform's automated royalty distribution to external marketplaces. When a customer purchases a chair design token through the furniture retailer's website, the system would detect this transaction and automatically initiate the same royalty distribution process that would occur for a sale on the native marketplace, ensuring all contributors receive their entitled compensation.

In one embodiment, the external platform integration module may include an on-chain transaction monitoring system that provides comprehensive tracking of token-related activities across multiple blockchain networks. This system ensures that royalty obligations are fulfilled regardless of where transactions occur.

The on-chain transaction monitoring system may receive transaction data from multiple blockchain networks and external marketplaces. This data collection creates a comprehensive view of all potential token transactions across the digital ecosystem. For example, the system might monitor Ethereum, Polygon, and several other blockchain networks for transactions related to furniture design tokens, while also receiving sales reports from integrated e-commerce platforms through their API connections.

The on-chain transaction monitoring system may process the transaction data by filtering for activities related to tokens in the system's registry. This filtering identifies relevant transactions from the vast stream of blockchain data. From millions of daily blockchain transactions, the system would specifically identify those involving registered furniture design tokens, discarding unrelated transactions to focus on those requiring royalty processing.

The on-chain transaction monitoring system may verify the authenticity of reported sales using cryptographic proofs and blockchain validation. This verification prevents fraudulent reporting of transactions and ensures accurate royalty calculations. When the furniture retailer reports a sale of a chair design token for 500 cryptocurrency units, the system would verify this transaction against blockchain records, confirming that an actual transfer occurred at the reported price before calculating royalty distributions.

The on-chain transaction monitoring system may match external transactions with the corresponding tokens in the multi-branch tree structure. This matching ensures that sales are properly associated with the correct creative lineage for royalty calculations. For a transaction involving a specific ergonomic office chair design, the system would link this sale to the token's position in the royalty tree, identifying it as a derivative of an original chair concept with specific royalty obligations to both the derivative creator and the original designer.

The on-chain transaction monitoring system may identify royalty payment obligations triggered by external sales. This identification determines which stakeholders are entitled to compensation from each transaction. For the chair design sale, the system might determine that the ergonomic adaptation creator is entitled to 7% (35 units), the original designer is entitled to 5% (25 units), and a contributor to a specific component is entitled to 2% (10 units) based on their respective positions in the royalty tree.

The on-chain transaction monitoring system may generate royalty distribution instructions based on the identified transactions. These instructions specify exactly how sales revenue should be allocated among entitled parties. For the chair design example, the system would generate instructions to distribute the 70 units of total royalties among the three contributors according to their entitled percentages, with specific payment amounts directed to each contributor's wallet address.

The on-chain transaction monitoring system may forward the instructions to the payment distribution module 211, ensuring that the creator user and the one or more evolver users receive appropriate compensation regardless of where their tokens are sold. This forwarding connects external transaction monitoring to the platform's payment execution system. The payment distribution module would receive the instructions for the 70 units of royalties from the chair design sale and execute the transfers to the three entitled contributors, completing the royalty distribution process for the external sale.

In one embodiment, the external platform integration module may implement a cross-platform licensing enforcement mechanism that ensures licensing compliance across all integrated platforms. This mechanism extends the platform's licensing infrastructure to external marketplaces and usage environments.

The cross-platform licensing enforcement mechanism may publish, to connected external platforms, machine-readable licensing parameters associated with each token in the system. These parameters enable external systems to understand and enforce license terms. For furniture design tokens, the system might publish standardized, machine-readable representations of licensing terms specifying attribution requirements, permitted uses, manufacturing restrictions, and royalty obligations that external platforms can automatically interpret and enforce.

The cross-platform licensing enforcement mechanism may receive usage data from external platforms regarding how tokens are being utilized. This data collection provides visibility into how creative works are being used beyond the native platform. The furniture retailer's e-commerce system might report data showing that a specific chair design token has been sold to a manufacturer who is producing physical chairs based on the design, including production volumes, sales prices, and distribution channels.

The cross-platform licensing enforcement mechanism may analyze the usage data to detect potential licensing violations. This analysis identifies activities that may conflict with established licensing terms. If the furniture retailer's reports indicate that a manufacturer has produced the chair design without including the required designer attribution on the physical product or marketing materials, the system would flag this as a potential licensing violation for further investigation.

The cross-platform licensing enforcement mechanism may identify unauthorized derivative works that may infringe on creators' rights. This identification protects creators from unauthorized adaptations of their work. The system might detect that a different manufacturer has created a close variant of the chair design without obtaining proper permission or establishing the necessary token relationship, flagging this activity for review and potential enforcement actions.

The cross-platform licensing enforcement mechanism may verify proper attribution compliance across external platforms and physical products. This verification ensures that creators receive appropriate credit for their work regardless of distribution channel. For physical chairs produced using the design token, the system might verify that proper attribution appears on product labels, packaging, website listings, and marketing materials as specified in the licensing terms.

The cross-platform licensing enforcement mechanism may ensure royalty distributions are being properly triggered for external uses. This verification confirms that all revenue-generating activities appropriately compensate creators. If a furniture manufacturer reports producing 100 units of a chair based on a purchased design token, the system would verify that royalty calculations have been correctly applied to these manufacturing activities and that resulting payments have been properly distributed to entitled creators.

The cross-platform licensing enforcement mechanism may generate compliance reports for token creators and owners. These reports provide transparency into how creative works are being used across the ecosystem. A furniture designer might receive a monthly report showing all manufacturing activities related to their design tokens, including production volumes, sales figures, attribution implementations, and royalty distributions, helping them monitor compliance with their licensing terms.

The cross-platform licensing enforcement mechanism may initiate automated enforcement actions for detected violations. These actions provide consequences for license breaches while minimizing the need for manual intervention. If a manufacturer is found to be producing a chair design without proper attribution, the system might automatically issue a formal notice of violation, impose penalty fees through the smart contract, or in severe cases, revoke the manufacturing license until the violation is remedied.

By implementing these comprehensive integration, monitoring, and enforcement mechanisms, the system enables tokenized creative works to extend beyond the native platform while maintaining the integrity of licensing terms and royalty distributions. This expansion increases market opportunities for creators while ensuring they maintain control over their work and receive appropriate compensation regardless of where their creations are used or sold.

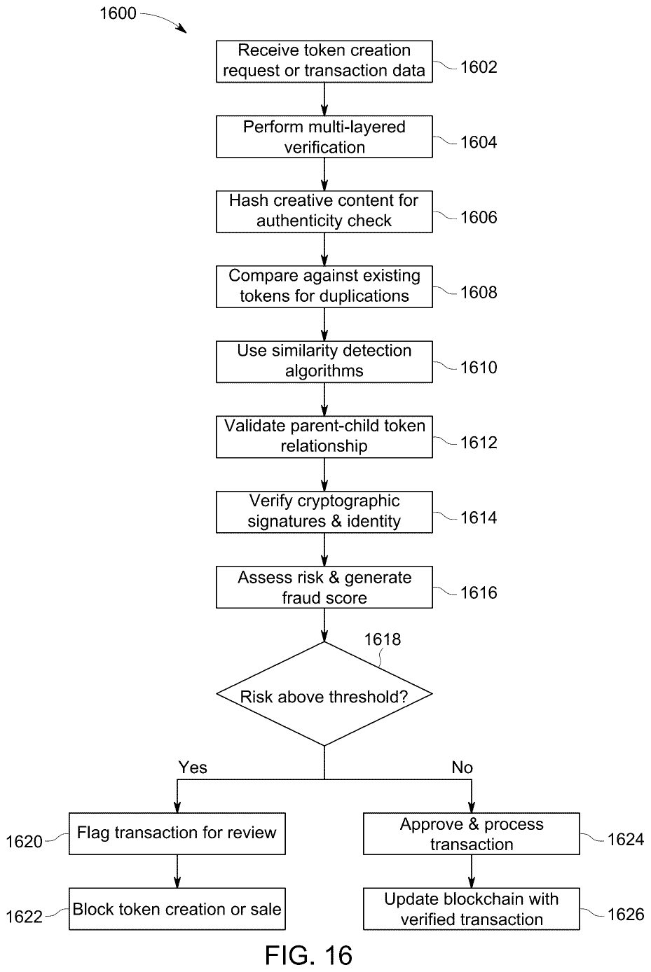

Referring to FIG. 16, a flowchart 1600 illustrating the fraud prevention system implemented by the fraud prevention module is provided, in accordance with an embodiment of the present subject matter. The flowchart 1600 depicts the comprehensive verification process applied to token creation requests and transactions to maintain the integrity of the creative ecosystem.

At Step 1602, the fraud prevention module receives token creation requests and transaction data from the token generation module 205 and the marketplace module 209. These inputs represent the activities that require verification to prevent fraudulent behavior on the platform. For example, when a furniture designer submits a request to create a StartToken for a new chair design, or when a buyer attempts to purchase an existing furniture design token, these activities are routed to the fraud prevention module for security screening before proceeding.

At Step 1604, the system performs multi-layered verification on the received data. This comprehensive approach applies multiple verification techniques in sequence to detect various types of potential fraud. For the furniture design token creation request, the multi-layered verification might include verifying the designer's identity credentials, checking their platform reputation and history, analyzing the submitted design files for authenticity markers, and examining metadata for inconsistencies that might indicate fraudulent submission.

At Step 1606, the system hashes the creative content for authenticity checking. This cryptographic process creates a unique digital fingerprint of the creative work that can be used to detect duplications and verify integrity. For the furniture design, the system would generate cryptographic hashes of the 3D model files, technical specifications, material lists, and other creative elements, creating a unique identifier that can be used to detect if the same content has been previously submitted or is later duplicated by others.

At Step 1608, the system compares the submission against existing tokens to detect potential duplications. This comparison helps prevent plagiarism and unauthorized copying of creative works. The furniture design would be compared against the database of existing furniture design tokens to ensure it is not a copy or slight modification of someone else's work. This might involve comparing both the hash values and the actual content characteristics to detect both exact duplicates and derivative works that haven't been properly authorized.

At Step 1610, the system applies similarity detection algorithms to identify less obvious cases of unauthorized copying. These algorithms can detect conceptual similarities even when surface details differ. Beyond simple hash matching, the system might analyze the structural elements, proportions, distinctive features, and functional characteristics of the furniture design to identify if it bears suspicious similarity to existing designs, even if colors, materials, or minor details have been changed to disguise copying.

At Step 1612, the system validates parent-child token relationships to ensure proper lineage representation. This validation verifies that derivative works properly acknowledge their foundations. If the furniture design is claimed to be a spinoff of an existing design, the system would verify that the appropriate parent token is correctly referenced, that the evolver has the necessary permissions to create a derivative, and that the parent-child relationship is accurately represented in the token metadata.

At Step 1614, the system verifies cryptographic signatures and identity credentials to confirm authorship claims. This verification ensures that users are who they claim to be and have the authority to submit the content. The system would verify that the digital signatures associated with the furniture design submission match the claimed creator's cryptographic identity, and that this identity has been verified through established authentication protocols, potentially including multi-factor authentication and external identity verification services.

At Step 1616, the system assesses risk and generates a fraud score based on all verification results. This scoring provides a quantitative measure of the likelihood that a submission or transaction is fraudulent. The furniture design token creation request might receive a composite risk score based on factors such as the designer's account age and history, similarity scores to existing designs, complexity and originality of the submitted work, consistency of metadata, verification strength of identity credentials, and patterns of behavior compared to known fraud indicators.

At Step 1618, the system determines whether the risk score exceeds the defined security threshold. This critical decision point determines whether the activity can proceed or requires intervention. If the furniture design submission receives a risk score of 42 out of 100, and the system's threshold for automatic approval is 50, the submission would pass this check and be considered low-risk.

If the risk score is above the threshold (Yes path), the process continues to Step 1620, where the system flags the transaction for manual review. This conservative approach prevents potentially fraudulent activities while allowing legitimate edge cases to be evaluated by human judgment. If the furniture design had instead received a risk score of 65, exceeding the threshold, it would be flagged for manual review by platform security staff who would examine the specific risk factors in detail before making a determination.

At Step 1622, if the manual review confirms fraud concerns, the system blocks the token creation or sale to prevent malicious activity. This blocking function serves as the final line of defense against fraud. If the security team determines that the furniture design is indeed an unauthorized copy of another designer's work with only superficial changes, they would block the token creation request, and the system would prevent the token from being minted on the blockchain.

If the risk score is below the threshold (No path), or if manual review clears a flagged transaction, the process proceeds to Step 1624, where the system approves and processes the transaction. This approval allows legitimate activities to proceed with minimal friction. The furniture design submission with the low-risk score of 42 would be automatically approved at this stage, or a submission initially flagged but cleared on review would also proceed to this step.

At Step 1626, the system updates the blockchain with the verified transaction, creating an immutable record of the approved activity. This update represents the successful completion of the fraud prevention process. The furniture design token would be officially minted on the blockchain with its verified metadata, creator information, and any parent-child relationships properly established, becoming part of the permanent record of creative works on the platform.

The fraud prevention module illustrated in FIG. 16 provides a comprehensive security framework that protects the integrity of the creative ecosystem while minimizing friction for legitimate users. By implementing multiple layers of verification and risk assessment, the system can identify and prevent various fraud scenarios including unauthorized copying, identity misrepresentation, and improper derivative relationships. This protection is essential for maintaining trust in the platform, ensuring fair attribution and compensation for creators, and preserving the value of tokenized creative works.

The fraud prevention module receives token creation requests from the token generation module 205 when users attempt to mint new tokens representing creative works. These requests contain the complete data package required to create a token, including creative content, metadata, licensing parameters, and creator identification. For example, when a jewelry designer submits a request to create a StartToken for an innovative bracelet design, the token generation module would forward this request to the fraud prevention module before proceeding with token creation. The submission might include 3D model files of the bracelet, material specifications, manufacturing guidelines, creator identity credentials, and proposed licensing parameters.

The fraud prevention module also receives transaction data from the marketplace module 209 when users attempt to buy, sell, or transfer tokens. These transaction requests include details such as the tokens involved, transaction terms, and participant identities. When a gallery owner attempts to purchase a digital art token representing a sculpture design, the marketplace module would send the transaction details to the fraud prevention module for verification before executing the transfer. These details might include the token identifier, proposed purchase price, buyer and seller wallet addresses, and transaction timestamp.

The fraud prevention module processes the data through a multi-layered verification system designed to detect various types of potential fraud. This layered approach provides defense in depth, applying multiple complementary verification techniques to identify suspicious activities. For the jewelry design submission, the system might first verify the designer's identity through cryptographic signature validation, then check their account history and reputation, followed by content analysis of the design files, and finally pattern recognition to identify any anomalous submission characteristics that might indicate fraud.

The fraud prevention module performs cryptographic hashing of creative content to detect unauthorized duplications. This process creates a unique digital fingerprint that can identify exact copies regardless of filename or metadata changes. The jewelry design files would be processed through secure hashing algorithms like SHA-256 to generate a unique hash value for each component. These hash values would be compared against the database of existing token hashes to detect if identical content has been previously submitted, perhaps under a different creator name or with modified metadata.

The fraud prevention module compares visual and textual elements against existing tokens using similarity detection algorithms. These algorithms can identify conceptual copying even when exact hashes don't match. For the jewelry design, the system might apply computer vision algorithms to analyze the bracelet's form, pattern, clasp mechanism, and distinctive elements, comparing these characteristics against the database of existing jewelry designs to detect substantial similarity that might indicate plagiarism, even if some superficial details were altered.

The fraud prevention module validates that linked assets properly reference their parent tokens through cryptographic signatures. This validation ensures accurate representation of derivative relationships. If the jewelry design is claimed to be a spinoff of an existing design (perhaps adapting a necklace design into a matching bracelet), the system would verify that the parent token is correctly identified, that the cryptographic signatures establish a valid relationship, and that the derivative work complies with the licensing terms of the parent token.

The fraud prevention module verifies the authenticity of the creator user and the one or more evolver users' identities using robust authentication mechanisms. This verification prevents impersonation and ensures accountability. The system would validate that the jewelry designer's digital signature matches their registered identity, potentially cross-referencing external verification systems or requiring multi-factor authentication for high-value submissions. For evolvers creating derivative works, the system would similarly verify their identities and their relationship to the original creators.

The fraud prevention module generates a risk assessment score for each token and transaction based on multiple weighted factors. This scoring provides a quantitative measure of fraud likelihood to inform decision-making. The jewelry design submission might receive a composite score based on factors such as the designer's account age and history (newer accounts with no history might score higher risk), similarity to existing designs (higher similarity increases risk score), complexity of the submitted work (overly simple designs might indicate higher risk), consistency of metadata, strength of identity verification, and patterns of behavior compared to known fraud indicators.

The fraud prevention module outputs the assessment results to the respective modules, enabling appropriate action based on risk level. These outputs include both the risk score and detailed findings from each verification stage. For the jewelry design with a low-risk score of 25 out of 100, the module would return an approval to the token generation module, allowing the token creation to proceed. However, for a suspicious sculpture transaction with a high-risk score of 78, the module would return a rejection to the marketplace module with details about the specific risk factors identified, such as suspicious timing, unusual pricing, or identity inconsistencies.

The fraud prevention module blocks transactions or token creations that fail to meet security thresholds, preventing potentially fraudulent activities before they enter the ecosystem. This blocking function serves as a critical safeguard against various types of fraud. If the jewelry design had instead received a high risk score of 85 due to substantial similarity to an existing design and inconsistencies in the creator's identity verification, the system would block the token creation request and notify both the user and platform administrators of the specific concerns identified during verification.

By implementing this comprehensive fraud prevention system, the platform protects the integrity of the creative ecosystem, ensures fair attribution and compensation for legitimate creators, and builds user trust in the authenticity and uniqueness of tokenized creative works. The multi-layered approach provides defense against various fraud scenarios while minimizing false positives that might impede legitimate creative activity.

In one embodiment, the system 101 may implement a recursive calculation optimization system that significantly improves the efficiency of royalty distribution calculations. This optimization system addresses the computational challenges associated with processing complex royalty distributions across multi-branch tree structures, particularly in blockchain environments where computational resources directly translate to transaction costs.

The recursive calculation optimization system may receive a request from the royalty management module 210 to calculate royalty distributions for the multi-branch tree structure. This request initiates the optimization process for a specific royalty calculation scenario. For example, when a furniture design token with a complex lineage of derivative works is sold, the royalty management module might request calculation of royalty distributions across a tree with dozens of contributors at multiple levels.

The recursive calculation optimization system may process the request by converting the recursive royalty distribution algorithm into an equivalent iterative implementation. This conversion transforms a naturally recursive problem into a form that avoids the performance and resource limitations of recursive function calls. Rather than using function recursion to traverse the royalty tree of the furniture design, which could lead to stack overflows with deeply nested derivatives, the system would implement an equivalent iterative approach using loops and explicit stack management.

The recursive calculation optimization system may restructure the multi-branch tree structure into a flattened array representation with explicit parent-child relationships. This restructuring transforms the complex hierarchical data into a format more amenable to efficient processing. The furniture design's royalty tree might be converted from a nested object structure to a flattened array where each entry contains its own identifier and explicit references to its parent nodes, making relationship traversal more direct and efficient.

The recursive calculation optimization system may implement a breadth-first traversal algorithm that processes nodes level by level rather than depth-first. This approach provides more predictable resource utilization and better optimization opportunities. For the furniture design example, the system would process all contributors at the same hierarchical level together-first processing the original designer, then all first-generation derivative creators, then all second-generation derivative creators, and so on-rather than following each branch to its maximum depth before processing siblings.

The recursive calculation optimization system may utilize temporary computational resources for intermediate calculation results to avoid redundant processing. This caching strategy prevents duplicate calculations when multiple paths in the royalty tree reference the same node. In the furniture design's royalty distribution, if multiple branches refer to a common component (perhaps a specific leg design used in multiple derivatives), the system would calculate the royalty allocation for this component once and reuse the result wherever needed.

The recursive calculation optimization system may execute the optimized calculation algorithm to determine royalty amounts for all participants in the multi-branch tree structure. This execution applies the optimized approach to produce accurate royalty distributions. For the furniture design sale, the system would process the flattened array using breadth-first traversal and intermediate result caching to efficiently calculate each contributor's royalty entitlement based on their position in the hierarchy and the established royalty parameters.

The recursive calculation optimization system may return the calculated royalty distribution to the payment distribution module 211, achieving the same mathematical result as recursive calculation while consuming significantly less computational resources and transaction costs on the blockchain-based distributed ledger. The final output would be mathematically identical to what would be produced by a traditional recursive calculation but obtained with greatly reduced computational overhead. For the furniture design example, this might reduce gas costs from potentially thousands of computation units to just dozens, making complex royalty distributions economically viable even for lower-value transactions.

In one embodiment, the loop-based execution model for royalty distribution may further include a state segmentation mechanism that handles exceptionally large or complex royalty structures. This mechanism addresses the computational limitations of blockchain environments when processing very large data structures.

The state segmentation mechanism may receive the multi-branch tree structure with multiple branches and levels from the blockchain-based distributed ledger. This reception provides the complete royalty structure for processing. For a comprehensive furniture collection with dozens of pieces, each with multiple generations of derivatives involving many contributors, the complete royalty tree might be too large to process in a single transaction due to blockchain gas limits.

The state segmentation mechanism may process the multi-branch tree structure to divide it into manageable segments based on depth and breadth metrics. This division creates smaller subproblems that can be processed within blockchain resource constraints. The furniture collection's royalty tree might be divided into segments, perhaps processing each major furniture category (seating, tables, storage) as a separate segment, or dividing by generation depth to create manageable processing units.

The state segmentation mechanism may assign each segment a unique identifier and processing priority to maintain organization and efficiency. This assignment enables systematic processing and tracking of segments. Each segment of the furniture collection's royalty tree would receive a unique identifier (e.g., “seating-gen1-2”) and a processing priority based on factors like segment size, dependency relationships, or business rules about payment timing.

The state segmentation mechanism may create a processing schedule that minimizes memory requirements while maintaining logical processing order. This scheduling optimizes resource utilization across the segmented calculation. The schedule might determine that small, independent segments should be processed first to clear memory, or that certain segments with many dependencies should be prioritized to unlock parallel processing opportunities for subsequent segments.

The state segmentation mechanism may establish checkpoints for resuming execution if interrupted, providing resilience against transaction failures. These checkpoints prevent lost work if transactions fail mid-processing. After processing each segment of the furniture collection's royalty distribution, the system would create a verifiable checkpoint on the blockchain, ensuring that if a later segment's processing fails due to gas limits or other issues, the system can resume from the last successful checkpoint rather than starting over.

The state segmentation mechanism may execute royalty calculations for each segment sequentially, recording intermediate results on the blockchain-based distributed ledger. This sequential execution works through the segments in the established order while maintaining transparency of the process. The system would process the “seating” segment first, calculating and recording royalty distributions for all contributors to chair and sofa designs, then proceed to the “tables” segment, and so on, with each completion recorded on the blockchain.

The state segmentation mechanism may merge the segmented calculation results into a final royalty distribution plan, combining the partial results into a coherent whole. After processing all segments of the furniture collection's royalty tree, the system would combine the separate calculations into a unified distribution plan that includes all contributors across all furniture types and derivative generations, ready for execution by the payment distribution module.

This segmentation approach enables processing of arbitrarily large multi-branch tree structures without encountering transaction cost limits or stack depth limitations, making the system scalable to royalty structures of any complexity. Even for collections with hundreds of contributors and deeply nested derivative relationships, the segmentation mechanism ensures that royalty calculations can be completed efficiently and reliably within blockchain constraints.

In one embodiment, the system 101 may implement a proxy pattern smart contract architecture that enhances the flexibility and maintainability of the blockchain-based platform. This architecture is fundamentally important for blockchain applications where deployed code is typically immutable, yet business requirements and technological capabilities continue to evolve.

The proxy pattern smart contract architecture may receive instructions from the system modules to interact with the blockchain-based distributed ledger. These instructions represent the various operations that need to be performed on the blockchain, such as token creation, ownership transfers, or royalty calculations. For example, when the token generation module 205 needs to mint a new furniture design token, it would send an instruction to the proxy architecture specifying the token parameters, creator information, and required metadata.

The proxy pattern smart contract architecture may process the instructions through a layered contract structure that separates contract logic from storage through a proxy-implementation pattern. This separation creates a modular system where functionality can be updated without disturbing stored data. For the furniture design token creation, the instruction would first be received by a proxy contract that acts as a stable entry point. This proxy does not contain the actual token creation logic but instead knows where to find the current implementation contract that does.

The proxy pattern smart contract architecture may maintain a central address registry for locating the latest implementation of each contract. This registry serves as a reference point for finding the most current version of each functional component. The address registry might store entries mapping functional roles like “TokenGenerator” or “RoyaltyCalculator” to the blockchain addresses where their current implementations reside. When processing the furniture design token creation, the proxy would check this registry to find the current address of the token generation implementation.

The proxy pattern smart contract architecture may delegate calls to the current implementation while preserving state and maintaining persistent storage. This delegation pattern allows logic to be updated while data remains in consistent locations. Rather than executing the token creation logic itself, the proxy would use a delegatecall function (in Ethereum-based systems) to execute the logic in the current implementation contract while operating on the proxy's own storage. This means the furniture design token data gets stored in the proxy's persistent storage area even though the creation logic might reside in a separate, replaceable contract.

The proxy pattern smart contract architecture may enable atomic upgrades of contract logic without migrating stored data. This capability allows the system to evolve without disruptive data migration processes. If the token creation logic needs to be enhanced-perhaps to add support for new metadata fields or improved validation rules-administrators could deploy a new implementation contract with the updated logic and update the address registry to point to this new implementation. The next furniture design token creation would automatically use the new logic while working with the same storage structure as previous operations.

The proxy pattern smart contract architecture may execute the delegated calls on the appropriate implementation contracts after resolving their current addresses. This execution applies the current business logic to the operation while maintaining data consistency. When creating the furniture design token, the proxy would execute the token creation function in the current implementation contract, applying the latest validation rules, metadata processing logic, and integration with other system components while storing the resulting token data in the stable storage structure.

The proxy pattern smart contract architecture may return operation results to the calling modules, completing the interaction cycle with consistent interfaces. These results include both success confirmations and any output data required by the calling module. After creating the furniture design token, the architecture would return confirmation of the successful minting along with the token's unique identifier and blockchain location to the token generation module, allowing it to proceed with any subsequent operations that depend on the token creation.

This architecture enables system evolution and bug fixes without disrupting existing token ownership or royalty structures. By maintaining stable storage locations while allowing logic to be updated, the system can improve over time without requiring token migrations or disrupting established economic relationships. For example, if a bug is discovered in the royalty calculation logic that affects furniture design tokens, the implementation contract could be updated to fix the bug without requiring any changes to existing tokens or their ownership records. Future royalty calculations would automatically use the corrected logic while maintaining all established royalty relationships.

In one embodiment, the royalty management module 210 may implement a hierarchical caching system for efficient royalty calculations. This caching system significantly reduces computational costs by reusing calculation patterns for similar transactions, which is particularly valuable in blockchain environments where computation directly translates to financial costs.

The hierarchical caching system may receive a request to calculate royalty distributions for a specific transaction event. This request initiates the royalty calculation process for a particular sale or transfer. For example, when a buyer purchases a furniture design token representing an ergonomic office chair for 500 cryptocurrency units, the marketplace module would request a royalty calculation to determine how this revenue should be distributed among all contributors.

The hierarchical caching system may retrieve, from an off-chain cache, pre-computed royalty distribution templates for common transaction scenarios. This retrieval checks whether the current transaction matches patterns that have been previously processed and stored. The system might check whether this specific furniture design token or tokens with similar royalty structures have been sold before, and whether calculation templates exist that match its royalty distribution pattern.

The hierarchical caching system may process the royalty calculation request by determining if the current transaction matches a cached scenario. This matching process compares transaction characteristics to identify reusable calculation patterns. For the office chair token, the system might identify that this token belongs to a category of “third-generation derivatives in the furniture design family with three levels of contributors and standard royalty rates,” for which a calculation template already exists.

The hierarchical caching system may apply transaction-specific parameters to the template if a match exists, customizing the pre-computed pattern to the current transaction. This application creates accurate results from generalized templates. For the office chair sale, the system would apply the specific sale amount of 500 units to the template, along with the specific contributor addresses and their individual royalty percentages, producing a customized distribution plan without performing the full calculation from scratch.

The hierarchical caching system may calculate royalties from scratch only for novel transaction patterns that haven't been previously encountered. This approach ensures accurate results for unique scenarios while maximizing caching benefits for common patterns. If the office chair token had an unusual royalty structure not matching any existing template—perhaps involving conditional royalties or special distribution rules—the system would perform a full calculation, traversing the entire royalty tree and computing each contributor's share according to the specific rules of this token.

The hierarchical caching system may store the results of new calculations in the cache for future use, continuously expanding the system's optimization capabilities. This storage creates new templates that can benefit future transactions. After calculating royalties for the unique office chair token, the system would store the calculation pattern as a new template in the off-chain cache, potentially benefiting future sales of similar tokens and gradually building a comprehensive library of calculation templates.

The hierarchical caching system may generate the final royalty distribution plan based on either the cached template or new calculation. This generation produces actionable distribution instructions regardless of the calculation method used. For the office chair token, the system would produce a distribution plan specifying exactly how the 500 units should be divided perhaps 40 units (8%) to the original furniture designer, 35 units (7%) to the ergonomic adaptation creator, and 25 units (5%) to the office chair specialist, with the remaining 400 units going to the seller.

The hierarchical caching system may output the plan to the payment distribution module 211 for execution, completing the royalty calculation process. This output provides the necessary instructions for executing the actual payments. The payment distribution module would receive the finalized plan for the office chair sale, with precise instructions for transferring the specified amounts to each contributor's wallet address, ready for execution on the blockchain.

This hierarchical caching approach significantly reduces on-chain computation for frequently occurring royalty distribution patterns. By performing complex calculations off-chain and reusing patterns where possible, the system minimizes the gas costs associated with royalty distributions. For the furniture design ecosystem with many similar tokens and regular sales, this might reduce computation costs by 80-90% compared to calculating each distribution from scratch on-chain, making even complex royalty structures economically viable for lower-value transactions.

In one embodiment, the token generation module 205 may implement an efficient metadata storage system that addresses the challenge of storing comprehensive token information within the constraints of blockchain environments. This system optimizes the balance between on-chain security and off-chain storage efficiency.

The efficient metadata storage system may receive token creation requests containing detailed metadata about the primary original work or the at least one derivative work. These requests include the comprehensive information that defines a creative work. For example, a furniture designer might submit a token creation request for a modular sofa design that includes 3D models, material specifications, assembly instructions, high-resolution renderings, designer biographical information, detailed descriptions, usage guidelines, manufacturing specifications, and extensive licensing terms.

The efficient metadata storage system may process the metadata by separating immutable identifier data from descriptive content. This separation distinguishes between critical identity information and supplementary details. For the sofa design, critical identifier data might include the unique design identifier, creator wallet address, creation timestamp, parent token references (if it's a derivative), and core licensing parameters. Descriptive content would include the 3D models, material specifications, renderings, and detailed textual descriptions.

The efficient metadata storage system may store minimal critical metadata on-chain to establish ownership and relationships. This selective on-chain storage focuses blockchain resources on essential information. The system would store the sofa design's unique identifier, creator address, creation timestamp, royalty parameters, and parent-child relationships directly on the blockchain, ensuring these foundational elements have the highest security and immutability.

The efficient metadata storage system may generate cryptographic references to off-chain storage locations for extended metadata. These references create secure links to more voluminous content stored elsewhere. For the extensive sofa design files, the system might generate a content-addressed hash like “Qm2XhK8 . . . ” that uniquely identifies the collection of design files stored on a distributed storage system. This hash would be small enough to store on-chain while cryptographically guaranteeing the integrity of the referenced content.

The efficient metadata storage system may create verifiable links between the on-chain and off-chain components to maintain data integrity. These links ensure that off-chain content cannot be altered without detection. The on-chain sofa token would include not only the content-addressed hash of the off-chain files but also a cryptographic signature created by the original designer that verifies the relationship between the on-chain token and its off-chain components, preventing unauthorized modifications to the design files.

The efficient metadata storage system may store the extended metadata on a distributed file storage system, leveraging more cost-effective storage solutions for larger data. This storage provides persistence for detailed content without blockchain cost constraints. The complete sofa design package-potentially hundreds of megabytes including high-resolution 3D models and renderings-would be stored on a system like IPFS (InterPlanetary File System) or Arweave, where storage costs are significantly lower than blockchain storage while still providing decentralization benefits.

The efficient metadata storage system may generate the StartToken, the SpinoffToken, or the EndToken with hybrid metadata structures that maintain blockchain-level security for critical properties while minimizing transaction costs. This hybrid approach provides optimal balance between security, accessibility, and cost-efficiency. The completed sofa design token would exist as a hybrid entity-its essential identity, ownership, and relationship data secured immutably on the blockchain, while its rich content is stored cost-effectively off-chain but cryptographically linked to maintain verifiable integrity and provenance.

This metadata storage approach enables comprehensive documentation of creative works without prohibitive blockchain storage costs. For the furniture design ecosystem where detailed technical specifications and visual representations are essential, this hybrid approach might reduce on-chain storage requirements by 99% compared to storing all data on-chain, while still maintaining cryptographic verification of all content and clear ownership records. This efficiency makes it economically viable to tokenize complex creative works with extensive documentation.

In one embodiment, the collaboration management module 207 may implement a staged transaction execution system that addresses the challenge of complex operations that exceed blockchain transaction limits. This system enables large-scale interactions that would otherwise be impossible within single-block constraints.

The staged transaction execution system may receive complex transaction requests that would exceed transaction cost limits if executed as single operations. These requests represent operations too large or complex for a single blockchain transaction. For example, when a furniture manufacturer acquires the rights to a collection of 50 related furniture design tokens with complex royalty structures and licensing terms, this might involve dozens of ownership transfers, licensing updates, and royalty recalculations that collectively exceed the gas limit of a single Ethereum block.

The staged transaction execution system may process the requests by decomposing them into ordered sequences of smaller, atomic operations. This decomposition breaks down large tasks into blockchain-compatible units. The furniture collection acquisition might be decomposed into stages: first transferring ownership of tokens 1-10, then tokens 11-20, and so on, with each stage appropriately sized to fit within blockchain transaction limits while maintaining logical consistency.

The staged transaction execution system may generate unique transaction identifiers to track the overall process across multiple blockchain operations. These identifiers maintain continuity and traceability throughout the staged execution. The furniture collection acquisition might be assigned a master transaction ID like “FCAQ-2025-03-19-001” with each stage referencing this master ID along with a stage-specific identifier (e.g., “FCAQ-2025-03-19-001-S1” for stage one) to maintain clear association between all component transactions.

The staged transaction execution system may create state verification checks between stages to ensure consistency throughout the process. These verification mechanisms prevent execution from proceeding if previous stages did not complete correctly. Before processing stage two of the furniture collection acquisition (tokens 11-20), the system would verify that stage one (tokens 1-10) completed successfully by checking blockchain records for confirmation of all stage one transfers and updates.

The staged transaction execution system may prepare recovery procedures for handling interrupted sequences, providing resilience against failures. These procedures enable the process to resume from the point of interruption rather than restarting entirely. If stage three of the furniture collection acquisition fails due to network congestion or gas price spikes, the recovery procedures would enable administrators or automated systems to resume execution from stage three once conditions improve, without needing to repeat stages one and two.

The staged transaction execution system may execute the decomposed transactions in sequence, verifying the success of each stage before proceeding. This sequential execution maintains process integrity across multiple blockchain operations. The system would submit the stage one transaction for the furniture collection acquisition to the blockchain, wait for confirmation of its successful execution, perform verification checks, and only then proceed to submitting the stage two transaction, continuing this pattern through all stages.

The staged transaction execution system may verify the success of each stage before proceeding to the next, ensuring process continuity and data integrity. This verification prevents cascading errors that could occur if later stages executed without successful completion of prerequisites. After each stage of the furniture collection acquisition, the system would verify that all token transfers in that batch were correctly recorded on the blockchain, that licensing updates were properly applied, and that any necessary royalty recalculations were accurately performed before clearing the next stage for execution.

The staged transaction execution system may consolidate results from all stages into a unified transaction outcome, providing a coherent view of the complete operation. This consolidation treats the multi-stage process as a logical unit for reporting and record-keeping. Once all stages of the furniture collection acquisition complete successfully, the system would generate a consolidated report showing the complete transfer of all 50 tokens, aggregate royalty implications, and unified licensing status, presenting this as a single logical transaction despite its execution across multiple blockchain operations.

This staged execution approach enables transaction cost-intensive operations to be completed across multiple blocks without compromising transaction integrity. By breaking complex operations into manageable stages while maintaining logical consistency, the system overcomes blockchain transaction limits that would otherwise prevent large-scale operations. For the furniture design ecosystem where bulk acquisitions, collection management, and complex licensing operations are common, this staged approach might make possible operations that are 10-20 times larger than blockchain single-transaction limits would typically allow, significantly enhancing the platform's capability to handle enterprise-scale activities.

Although implementations for the system and the method for generating passwords in real-time based on biometric factors have been described in language specific to structural features and methods, it must be understood that the claims are not limited to the specific features or methods described. Rather, the specific features and methods are disclosed as examples of implementations for the system and method for decentralized co-creation and royalty distribution on a blockchain-based distributed ledger.

1. A system for decentralized co-creation and royalty distribution on a blockchain-based distributed ledger, the system comprising:
a processor; and
a memory coupled to the processor, wherein the processor is configured to execute instructions stored in the memory for:
receiving, by a content registration module, a primary original work from a creator user;
generating, by a token generation module, a StartToken on the blockchain-based distributed ledger, wherein the StartToken corresponds to the received primary original work, wherein the StartToken comprises StartToken metadata and a first spinoff permission parameter, set by the creator user, indicating whether derivative works for the primary original work are permitted;
registering, by a licensing module, at least one license associated with the StartToken in a license registry on the blockchain-based distributed ledger, wherein the at least one license comprises a set of licensing parameters that define usage rights for the primary original work;
receiving, by a collaboration management module, one or more spinoff requests from one or more evolver users to create at least one derivative work based on the StartToken, when the first spinoff permission parameter allows Spinoffs;
validating, by a validation module, the one or more spinoff requests through a multi-tiered approval mechanism based on the StartToken metadata;
generating, by the licensing module, upon validation of a spinoff request, an evaluation license for an evolver user, wherein the evaluation license grants the evolver user temporary access to the primary original work;
receiving, by the collaboration management module, at least one derivative work from the evolver user based on the primary original work;
validating, by the validation module, the at least one derivative work based on compliance with constraints defined in the StartToken metadata;
generating, by the token generation module, upon successful validation of the derivative work, at least one SpinoffToken on the blockchain-based distributed ledger representing the derivative work, wherein the SpinoffToken comprises SpinoffToken metadata and a second spinoff permission parameter indicating whether further Spinoffs are permitted, and wherein the SpinoffToken is cryptographically linked to the StartToken through a multi-branch tree structure, wherein the multi-branch tree structure comprises parent-child relationship in a hierarchical data structure;
generating, by the licensing module, a spinoff creation license for the evolver user associated with the SpinoffToken;
receiving, by the collaboration management module, a request to create an EndToken based on at least one of the StartToken or the SpinoffToken;
generating, by the token generation module, the EndToken on the blockchain-based distributed ledger;
facilitating, by a marketplace module, transactions for the purchase and sale of at least one of the StartToken, the SpinoffToken, or the EndToken through a smart contract-based marketplace, wherein the smart contract defines a set of royalty parameters;
implementing, by a royalty management module, a recursive royalty distribution system that maintains the multi-branch tree structure tracking relationships and contributions among the tokens; and
executing, by a payment distribution module, royalty distributions upon occurrence of a transaction event, wherein the royalty distributions include a principal royalty to the creator user and spinoff royalties to each contributing evolver user.

2. The system of claim 1, wherein:
the EndToken represents a finalized creative work ready for distribution and sale, wherein said creative work comprise of at least one of (i) a digital asset, or (ii) a real-world physical asset;
the EndToken is created automatically if the first spinoff permission parameter or the second spinoff permission parameter prohibits the further Spinoffs;
the SpinoffToken inherits applicable constraints from the set of licensing parameters of the StartToken;
the hierarchical data structure forms a node in the multi-branch tree structure for tracking contribution relationships for royalty distribution;
the recursive royalty distribution system:
(i) calculates royalty allocations based on the set of royalty parameters in the smart contract,
(ii) enforces maximum royalty caps to prevent excessive fee accumulation, and
(iii) prevents royalty dilution through mathematical constraints in deeply nested derivative chains; and
wherein the spinoff royalties are calculated recursively through the parent-child relationships in the multi-branch tree structure.

3. The system of claim 1, wherein the system further comprises a secured assets access module, wherein the StartToken, SpinoffToken, or EndToken includes a reference to one or more secured digital assets uploaded by the creator user or evolver user and stored on a decentralized assets storage system; and wherein the secured assets access module is configured for:
a) granting temporary access to the evolver user upon approval of a spinoff request, wherein access is facilitated through the decentralized file storage system; and
b) granting access to a buyer upon completion of a purchase transaction, wherein secured access is facilitated through the decentralized file storage system.

4. The system of claim 1, wherein the royalty management module implements a Branching Recursive Royalty Network (BRRN) for multi-tier royalty distribution, wherein the BRRN:
receives, from the blockchain-based distributed ledger, a hierarchical structure of parent-child relationships between the StartToken, the SpinoffToken, and the EndToken, wherein each of the StartToken, the SpinoffToken, and the EndToken includes the StartToken metadata, the SpinoffToken metadata, and EndToken metadata, wherein the each of the metadata comprises:
(i) a unique identifier on the blockchain-based distributed ledger,
(ii) metadata defining programmable constraints,
(iii) provenance data maintaining verifiable authorship and ownership records, and
(iv) usage rights specifications defining permitted interactions with the primary original work and the at least one derivative work;
processes the metadata to generate the multi-branch tree structure representing royalty distribution paths;
records the multi-branch tree structure on the blockchain-based distributed ledger for efficient retrieval; and
utilizes the multi-branch tree structure to calculate and distribute royalties to multiple stakeholders at each level of the hierarchy using an iterative, loop-based execution model designed to optimize blockchain transaction costs.

5. The system of claim 4, wherein the royalty management module executes a loop-based execution model for optimizing blockchain transaction costs, wherein the loop-based execution model:
receives transaction data from the marketplace module when a sale event occurs;
retrieves the multi-branch tree structure from the blockchain-based distributed ledger;
processes the multi-branch tree structure using iterative loops instead of recursive function calls, wherein processing the multi-branch tree structure using iterative loops comprises:
(i) a first loop iterates through each level of the multi-branch tree structure from a terminal node to a root node,
(ii) a second loop processes all nodes at each level in batches to avoid deep recursion, and
(iii) the iterative loops maintain a running tally of remaining funds to be distributed; and
outputs a series of discrete payment transactions to the payment distribution module for execution to the creator user and the one or more evolver users based on respective positions in the multi-branch tree structure, thereby preventing smart contract stack overflows and minimizing transaction costs on the blockchain-based distributed ledger.

6. The system of claim 4, wherein the royalty management module further optimizes transaction costs by:
receiving, from the blockchain-based distributed ledger, the multi-branch tree structure;
preprocessing the multi-branch tree structure by:
(i) flattening the nested hierarchy into a linear array of payment recipients, wherein the payment recipients comprise the creator user and the one or more evolver users who contributed to the creation of the StartToken, the SpinoffToken, or the EndToken,
(ii) calculating each recipient's royalty amount based on predetermined percentages and position in the multi-branch tree structure,
(iii) consolidating multiple payments to the same recipient, and
(iv) sorting recipients by payment amount to optimize transaction batching;
recording the preprocessed payment data on the blockchain-based distributed ledger; and
executing batched payment transactions using the payment distribution module, thereby reducing the total number of blockchain transactions required and minimizing transaction costs on the blockchain-based distributed ledger.

7. The system of claim 1, wherein the royalty management module implements a capped royalty validation mechanism that:
receives royalty allocation data based on the set of royalty parameters from each of the StartToken, the SpinoffToken, and the EndToken in the multi-branch tree structure;
processes the royalty obligations recursively, ensuring that at every node in the multi-branch tree structure, the greater of the percentage-based royalty or minimum royalty value is used;
validates the feasibility of generating a new token by checking whether the proposed royalty structure can fulfill all parent obligations in the multi-branch tree structure;
performs royalty validation during token pricing, transaction events, and offer negotiations to ensure that the final sale price can cover all required royalty distributions; and
outputs a validation result to the token generation module and the marketplace module, preventing the creation or sale of tokens with unsustainable royalty obligations.

8. The system of claim 1, wherein the system further comprises a royalty simulation module for predictive royalty analysis, wherein the royalty simulation module:
receives, from the collaboration management module, a proposed royalty structure for a new SpinoffToken;
processes the proposed royalty structure by:
(i) simulating the addition of the new SpinoffToken to the existing multi-branch tree structure,
(ii) calculating the royalty distributions for various transaction price scenarios,
(iii) analyzing the impact on transaction costs for multi-branch tree structure depths and branching factors, and
(iv) identifying potential bottlenecks or inefficiencies such as excessive transaction costs, deep recursion risks, or unbalanced royalty allocations in the royalty distribution;
generates a transaction efficiency report and optimization recommendations; and
outputs the report and recommendations to the creator user and the one or more evolver user for review before finalizing the SpinoffToken creation.

9. The system of claim 1, further comprising an AI-driven royalty recommendation module that receives input data, wherein the input data comprises historical transaction data of similar tokens from the blockchain-based distributed ledger, creator user reputation metrics, market trend data for specific creative categories, and contribution analysis metrics quantifying the relative value added by each evolver user;
wherein the AI-driven royalty recommendation module processes the input data using a machine learning model to identify patterns in successful royalty structures, evaluate the market influence of the creator user and the one or more evolver users, assess the complexity and uniqueness of the derivative work, and factor in current market conditions and demand;
wherein the AI-driven royalty recommendation module generates recommended royalty parameters, including percentage-based royalties and minimum royalty values, for the StartToken, the SpinoffToken, and the EndToken in the multi-branch tree structure;
wherein the AI-driven royalty recommendation module implements an adaptive learning mechanism that analyzes performance data of tokens with different royalty structures, identifies correlations between royalty structures and market success, detects changing market conditions affecting optimal royalty distributions, and refines recommendation algorithms based on observed outcomes;
wherein the AI-driven royalty recommendation module provides a negotiation assistance feature that processes royalty proposals from both the creator user and the one or more evolver users, calculates the economic impact of different royalty structures on all parties, simulates long-term outcomes of various royalty scenarios, and generates balanced royalty options that maximize value for all participants; and
wherein the AI-driven royalty recommendation module outputs the recommendations and negotiation options to the collaboration management module for presentation to the creator user and the one or more evolver users during smart contract formation.

10. The system of claim 1, wherein the licensing module implements a dynamic licensing system that:
receives, from the creator user, licensing parameters for the StartToken, wherein the licensing parameters define permitted uses of the primary original work, restricted activities, attribution requirements, and conditions for derivative works;
processes the licensing parameters to generate machine-readable license terms encoded in smart contract format, establish verification mechanisms to ensure compliance with license terms, set up automated enforcement triggers, and create license metadata for storage on the blockchain-based distributed ledger;
links the license metadata to the StartToken at the time of generation by embedding a Universal Resource Identifier (URI) in the StartToken metadata, wherein the URI points to the license file stored on a decentralized storage network, the set of licensing parameters define the type of license, and the StartToken metadata references these license attributes;
records the processed licensing parameters in the license registry on the blockchain-based distributed ledger; and
provides the licensing parameters to the validation module for verifying compliance of spinoff requests and the at least one derivative work with the established terms.

11. The system of claim 9, wherein the validation module performs validation comprising at least one of:
(i) manual validation requiring explicit approval by the creator user through a smart contract interface, or
(ii) automated validation based on predefined licensing parameters stored in the StartToken metadata;
wherein the licensing module further supports multi-stage approval for the at least one derivative work by:
receiving, from an evolver user of the one or more evolver users, a request to modify an existing license for a specific use case;
processing the request by analyzing the proposed modifications against the original license terms, identifying all stakeholders in the multi-branch tree structure affected by the license change, generating a ballot for decentralized approval voting, and determining the required approval threshold based on the significance of the proposed modifications;
distributing the ballot to all affected stakeholders through the collaboration management module for voting; and
updating the license in the license registry on the blockchain-based distributed ledger only upon receiving the required threshold of stakeholder approvals, thereby ensuring consensus for any licensing modifications.

12. The system of claim 1, further comprising a royalty stream management module for enabling transferable royalty rights, wherein the royalty stream management module:
automatically processes, the royalty stream management module, the transfer of associated rights and royalty streams upon a transaction event involving the StartToken, the SpinoffToken, or the EndToken;
verifies the transaction on the blockchain-based distributed ledger, calculates the expected value of future royalty distributions based on historical transaction data and market projections, records the buyer as the new owner in the token metadata while preserving the creator user's ownership of the underlying primary original work and perpetual royalty rights;
maintains structured royalty distributions where the creator user continues receiving principal royalties from all transaction events involving the token, and the current owner inherits spinoff royalties from derivative works;
updates the token metadata on the blockchain-based distributed ledger to reflect the ownership change while ensuring the integrity of the multi-branch tree structure;
ensures that royalty distributions and rights follow the token transfer, automatically recording new entitlements without requiring separate manual approvals; and
outputs confirmation of the ownership transfer transaction to the buyer and seller, and provides confirmation to the royalty holder, enabling the royalty holder to transfer, sell, or collateralize future royalty earnings while maintaining the original creator user's ownership of the underlying primary original work.

13. The system of claim 1, wherein the token generation module supports multiple types of token creation including:
receiving, from the creator user, a request to create a specific type of token along with the corresponding creative work;
processing the request based on the specified token type, wherein:
for a StartToken, the token generation module verifies original authorship and establishes root permissions in the multi-branch tree structure,
for a SpinoffToken, the token generation module validates the parent-child relationship and inherits applicable constraints from the set of licensing parameters,
for a SpinoffToken with no derivative capabilities, the token generation module creates a derivative work that disallows the further Spinoffs while maintaining the parent-child relationship in the multi-branch tree structure, and
for an EndToken, the token generation module creates an exclusive token with no derivative capabilities;
generating the requested token type with appropriate metadata and smart contract properties specific to its function; and
registering the newly created token in the multi-branch tree structure with the appropriate hierarchical position, thereby establishing its role in future royalty distributions.

14. The system of claim 13, wherein the SpinoffToken creation includes a parent validation process that:
receives, from an evolver user of the one or more evolver users, a SpinoffToken creation request referencing a specific parent token;
retrieves, from the blockchain-based distributed ledger, the metadata and constraints of the parent token;
processes the request through a validation workflow that verifies compliance with the parent token's derivative work restrictions, confirms the evolver user holds a valid evaluation license for the parent token, checks that proposed royalty distributions satisfy maximum royalty caps, and validates that required approvals have been obtained from the creator user of the parent token;
generates a validation report detailing compliance or identifying specific violations; and
proceeds with SpinoffToken creation only upon successful validation, ensuring all parent-imposed constraints are respected in the at least one derivative work.

15. The system of claim 1, wherein the marketplace module implements a decentralized marketplace that:
receives listings including pricing information, quantity available, and sale conditions;
processes the listings by validating ownership of the listed StartToken, SpinoffToken, or EndToken on the blockchain-based distributed ledger, verifying compliance with the set of licensing parameters, calculating platform fees and royalty distributions, and generating smart contracts that govern the transaction events;
publishes the validated listings to a marketplace interface; and
executes transaction events triggering automatic royalty distribution through the royalty management module according to the multi-branch tree structure, when a buyer submits a purchase request.

16. The system of claim 15, wherein the marketplace module further supports multiple transaction types including:
receiving different types of transaction requests from marketplace participants, wherein the transaction types include fixed-price purchases, time-limited auction listings, conditional offers with expiration dates, and bundle sales of multiple related tokens;
processing each transaction type using specialized smart contract logic that enforces the specific rules and conditions of the transaction type, manages bid validation for auctions, handles expiration of time-sensitive offers, and coordinates bundle transfers when multiple tokens are involved;
executing the transactions upon fulfillment of all required conditions; and
updating ownership records on the blockchain-based distributed ledger while triggering appropriate royalty distribution events.

17. The system of claim 1, further comprising an external platform integration module that:
receives distribution requests from third-party entities wishing to sell tokens by integrating with external e-commerce platforms;
processes the distribution requests by validating the identity and security credentials of the requesting distributor, generating API keys for secure communication, establishing webhook endpoints for event notifications, and configuring royalty enforcement mechanisms for external sales;
creates a secure bridge between the blockchain-based distributed ledger and the external platform using cryptographic verification;
monitors external transaction events to ensure that all royalty obligations are properly fulfilled, triggering the royalty distribution system when sales occur on connected platforms, wherein the external platform integration module includes an on-chain transaction monitoring system configured to:
receive transaction data from multiple blockchain networks and external marketplaces,
process the transaction data by filtering for activities related to tokens in the system's registry, verifying the authenticity of reported sales, matching external transactions with the corresponding tokens in the multi-branch tree structure, and identifying royalty payment obligations triggered by external sales,
generate royalty distribution instructions based on the identified transactions, and
forward the instructions to the payment distribution module, ensuring that the creator user and the one or more evolver users receive appropriate compensation regardless of where their tokens are sold; and
wherein the external platform integration module implements a cross-platform licensing enforcement mechanism configured to:
publish, to connected external platforms, machine-readable licensing parameters associated with each token in the system,
receive usage data from external platforms regarding how tokens are being utilized,
analyze the usage data to detect potential licensing violations, identify unauthorized derivative works, verify proper attribution compliance, and ensure royalty distributions are being properly triggered,
generate compliance reports for token creators and owners, and
initiate automated enforcement actions for detected violations, including license revocation or penalty fee collection through smart contracts.

18. The system of claim 1, further comprising a fraud prevention module that:
receives token creation requests and transaction data from the token generation module and the marketplace module;
processes the data through a multi-layered verification system that performs cryptographic hashing of creative content to detect unauthorized duplications, compares visual and textual elements against existing tokens using similarity detection algorithms, validates that linked assets properly reference their parent tokens through cryptographic signatures, and verifies the authenticity of the creator user and the one or more evolver users' identities;
generates a risk assessment score for each token and transaction; and
outputs the assessment results to the respective modules, blocking transactions or token creations that fail to meet security thresholds.

19. The system of claim 1, wherein the system implements a recursive calculation optimization system that:
receives a request from the royalty management module to calculate royalty distributions for the multi-branch tree structure;
processes the request by converting the recursive royalty distribution algorithm into an equivalent iterative implementation, restructuring the multi-branch tree structure into a flattened array representation with explicit parent-child relationships, implementing a breadth-first traversal algorithm that processes nodes level by level rather than depth-first, and utilizing temporary computational resources for intermediate calculation results to avoid redundant processing;
executes the optimized calculation algorithm to determine royalty amounts for all participants in the multi-branch tree structure; and
returns the calculated royalty distribution to the payment distribution module, achieving the same mathematical result as recursive calculation while consuming significantly less computational resources and transaction costs on the blockchain-based distributed ledger.

20. The system of claim 5, wherein the loop-based execution model for royalty distribution further includes a state segmentation mechanism that:
receives the multi-branch tree structure with multiple branches and levels from the blockchain-based distributed ledger;
processes the multi-branch tree structure to divide it into manageable segments based on depth and breadth metrics, assign each segment a unique identifier and processing priority, create a processing schedule that minimizes memory requirements, and establish checkpoints for resuming execution if interrupted;
executes royalty calculations for each segment sequentially, recording intermediate results on the blockchain-based distributed ledger; and
merges the segmented calculation results into a final royalty distribution plan, thereby enabling processing of arbitrarily large multi-branch tree structures without encountering transaction cost limits or stack depth limitations.

21. The system of claim 1, wherein the system implements a proxy pattern smart contract architecture that:
receives instructions from the system modules to interact with the blockchain-based distributed ledger;
processes the instructions through a layered contract structure that separates contract logic from storage through a proxy-implementation pattern enabling upgradability without modifying persistent data structures, maintains a central address registry for locating the latest implementation of each contract, delegates calls to the current implementation while preserving state and maintaining persistent storage, and enables atomic upgrades of contract logic without migrating stored data;
executes the delegated calls on the appropriate implementation contracts; and
returns operation results to the calling modules, thereby enabling system evolution and bug fixes without disrupting existing token ownership or royalty structures.

22. The system of claim 1, wherein the royalty management module implements a hierarchical caching system for efficient royalty calculations that:
receives a request to calculate royalty distributions for a specific transaction event;
retrieves, from an off-chain cache, pre-computed royalty distribution templates for common transaction scenarios;
processes the royalty calculation request by determining if the current transaction matches a cached scenario, applying transaction-specific parameters to the template if a match exists, calculating royalties from scratch only for novel transaction patterns, and storing the results of new calculations in the cache for future use;
generates the final royalty distribution plan based on either the cached template or new calculation; and
outputs the plan to the payment distribution module, significantly reducing on-chain computation for frequently occurring royalty distribution patterns.

23. The system of claim 1, wherein the token generation module implements an efficient metadata storage system that:
receives token creation requests containing detailed metadata about the primary original work or the at least one derivative work;
processes the metadata by separating immutable identifier data from descriptive content, storing minimal critical metadata on-chain to establish ownership and relationships, generating cryptographic references to off-chain storage locations for extended metadata, and creating verifiable links between the on-chain and off-chain components;
stores the extended metadata on a distributed file storage system; and
generates the StartToken, the SpinoffToken, or the EndToken with hybrid metadata structures that maintain blockchain-level security for critical properties while minimizing transaction costs associated with storing large data sets on-chain.

24. The system of claim 1, wherein the collaboration management module implements a staged transaction execution system that:
receives complex transaction requests that would exceed transaction cost limits if executed as single operations;
processes the requests by decomposing them into ordered sequences of smaller, atomic operations, generating unique transaction identifiers to track the overall process, creating state verification checks between stages to ensure consistency, and preparing recovery procedures for handling interrupted sequences;
executes the decomposed transactions in sequence, verifying the success of each stage before proceeding; and
consolidates results from all stages into a unified transaction outcome, enabling transaction cost-intensive operations to be completed across multiple blocks without compromising transaction integrity.

25. A method for decentralized co-creation and royalty distribution on a blockchain-based distributed ledger, the method comprising steps of:
receiving, by a content registration module, a primary original work from a creator user;
generating, by a token generation module, a StartToken on the blockchain-based distributed ledger, wherein the StartToken corresponds to the received primary original work, wherein the StartToken comprises StartToken metadata and a first spinoff permission parameter, set by the creator user, indicating whether derivative works for the primary original work are permitted;
registering, by a licensing module, at least one license associated with the StartToken in a license registry on the blockchain-based distributed ledger, wherein the at least one license comprises a set of licensing parameters that define usage rights for the primary original work;
receiving, by a collaboration management module, one or more spinoff requests from one or more evolver users to create at least one derivative work based on the StartToken, when the first spinoff permission parameter allows Spinoffs;
validating, by a validation module, the one or more spinoff requests through a multi-tiered approval mechanism based on the StartToken metadata;
generating, by the licensing module, upon validation of a spinoff request, an evaluation license for an evolver user, wherein the evaluation license grants the evolver user temporary access to the primary original work;
receiving, by the collaboration management module, at least one derivative work from the evolver user based on the primary original work;
validating, by the validation module, the at least one derivative work based on compliance with constraints defined in the StartToken metadata;
generating, by the token generation module, upon successful validation of the derivative work, at least one SpinoffToken on the blockchain-based distributed ledger representing the derivative work, wherein the SpinoffToken comprises SpinoffToken metadata and a second spinoff permission parameter indicating whether further Spinoffs are permitted, and wherein the SpinoffToken is cryptographically linked to the StartToken through a multi-branch tree structure, wherein the multi-branch tree structure comprises parent-child relationship in a hierarchical data structure;
generating, by the licensing module, a spinoff creation license for the evolver user associated with the SpinoffToken;
receiving, by the collaboration management module, a request to create an EndToken based on at least one of the StartToken or the SpinoffToken;
generating, by the token generation module, the EndToken on the blockchain-based distributed ledger;
facilitating, by a marketplace module, transactions for the purchase and sale of at least one of the StartToken, the SpinoffToken, or the EndToken through a smart contract-based marketplace, wherein the smart contract defines a set of royalty parameters;
implementing, by a royalty management module, a recursive royalty distribution system that maintains the multi-branch tree structure tracking relationships and contributions among the tokens; and
executing, by a payment distribution module, royalty distributions upon occurrence of a transaction event, wherein the royalty distributions include a principal royalty to the creator user and spinoff royalties to each contributing evolver user.

26. A computer program product for decentralized co-creation and royalty distribution on a blockchain-based distributed ledger, the computer program product comprising a non-transitory computer-readable storage medium having program instructions embodied therewith, the program instructions executable by one or more processors to cause the one or more processors to perform operations comprising:
receiving, by a content registration module, a primary original work from a creator user;
generating, by a token generation module, a StartToken on the blockchain-based distributed ledger, wherein the StartToken corresponds to the received primary original work, wherein the StartToken comprises StartToken metadata and a first spinoff permission parameter, set by the creator user, indicating whether derivative works for the primary original work are permitted;
registering, by a licensing module, at least one license associated with the StartToken in a license registry on the blockchain-based distributed ledger, wherein the at least one license comprises a set of licensing parameters that define usage rights for the primary original work;
receiving, by a collaboration management module, one or more spinoff requests from one or more evolver users to create at least one derivative work based on the StartToken, when the first spinoff permission parameter allows Spinoffs;
validating, by a validation module, the one or more spinoff requests through a multi-tiered approval mechanism based on the StartToken metadata;
generating, by the licensing module, upon validation of a spinoff request, an evaluation license for an evolver user, wherein the evaluation license grants the evolver user temporary access to the primary original work;
receiving, by the collaboration management module, at least one derivative work from the evolver user based on the primary original work;
validating, by the validation module, the at least one derivative work based on compliance with constraints defined in the StartToken metadata;
generating, by the token generation module, upon successful validation of the derivative work, at least one SpinoffToken on the blockchain-based distributed ledger representing the derivative work, wherein the SpinoffToken comprises SpinoffToken metadata and a second spinoff permission parameter indicating whether further Spinoffs are permitted, and wherein the SpinoffToken is cryptographically linked to the StartToken through a multi-branch tree structure, wherein the multi-branch tree structure comprises parent-child relationship in a hierarchical data structure;
generating, by the licensing module, a spinoff creation license for the evolver user associated with the SpinoffToken;
receiving, by the collaboration management module, a request to create an EndToken based on at least one of the StartToken or the SpinoffToken;
generating, by the token generation module, the EndToken on the blockchain-based distributed ledger;
facilitating, by a marketplace module, transactions for the purchase and sale of at least one of the StartToken, the SpinoffToken, or the EndToken through a smart contract-based marketplace, wherein the smart contract defines a set of royalty parameters;
implementing, by a royalty management module, a recursive royalty distribution system that maintains the multi-branch tree structure tracking relationships and contributions among the tokens; and
executing, by a payment distribution module, royalty distributions upon occurrence of a transaction event, wherein the royalty distributions include a principal royalty to the creator user and spinoff royalties to each contributing evolver user.
